(19) United States
(12) Patent Application Publication
(10) Pub. No.: US 2024/0243895 A1
(43) Pub. Date: Jul. 18, 2024

(54) Time Division Duplexing for Reduced Capability Wireless Devices

(71) Applicant: Ofinno, LLC, Reston, VA (US)

(72) Inventors: Nazanin Rastegardoost, McLean, VA (US); Hyoungsuk Jeon, Centreville, VA (US); Esmael Hejazi Dinan, McLean, VA (US); Hua Zhou, Vienna, VA (US); Ali Cagatay Cirik, Chantilly, VA (US); Kai Xu, Great Falls, VA (US); Mohammad Ghadir Khoshkholgh Dashtaki, Reston, VA (US)

(73) Assignee: Ofinno, LLC, Reston, VA (US)

(21) Appl. No.: 18/622,430

(22) Filed: Mar. 29, 2024

Related U.S. Application Data
(63) Continuation of application No. PCT/US2022/044240, filed on Sep. 21, 2022.
(60) Provisional application No. 63/251,014, filed on Sep. 30, 2021.

(51) Int. Cl. H04L 5/14; H04W 72/0457; H04W 72/51

(52) U.S. Cl. CPC H04L 5/1469; H04W 72/0457; H04W 72/51

(57) ABSTRACT

A wireless device may receive one or more messages comprising configuration parameters of a cell. The configuration parameters may indicate a first bandwidth part (BWP) of the cell for wireless devices having reduced capabilities, a first time-division duplex (TDD) pattern for the first BWP, and a second TDD pattern applicable to BWPs of the cell. The wireless device may further select the first TDD pattern based on the wireless device having the reduced capabilities and based on the first BWP being an active BWP of the cell. The wireless device may also determine a format of a symbol based on the first TDD pattern. Based on the format, the wireless device may communicate via the first BWP during the symbol.

### CROSS-REFERENCE TO RELATED APPLICATIONS

This application is a continuation of International Application No. PCT/US2022/044240, filed Sep. 21, 2022, which claims the benefit of U.S. Provisional Application No. 63/251,014, filed Sep. 30, 2021, all of which are hereby incorporated by reference in their entireties.

### BRIEF DESCRIPTION OF THE DRAWINGS

Examples of several of the various embodiments of the present disclosure are described herein with reference to the drawings.

FIG. 1A and FIG. 1B illustrate example mobile communication networks in which embodiments of the present disclosure may be implemented.

FIG. 2A and FIG. 2B respectively illustrate a New Radio (NR) user plane and control plane protocol stack.

FIG. 3 illustrates an example of services provided between protocol layers of the NR user plane protocol stack of FIG. 2A.

FIG. 4A illustrates an example downlink data flow through the NR user plane protocol stack of FIG. 2A.

FIG. 4B illustrates an example format of a MAC subheader in a MAC PDU.

FIG. 5A and FIG. 5B respectively illustrate a mapping between logical channels, transport channels, and physical channels for the downlink and uplink.

FIG. 6 is an example diagram showing RRC state transitions of a UE.

FIG. 7 illustrates an example configuration of an NR frame into which OFDM symbols are grouped.

FIG. 8 illustrates an example configuration of a slot in the time and frequency domain for an NR carrier.

FIG. 9 illustrates an example of bandwidth adaptation using three configured BWPs for an NR carrier.

FIG. 10A illustrates three carrier aggregation configurations with two component carriers.

FIG. 10B illustrates an example of how aggregated cells may be configured into one or more PUCCH groups.

FIG. 11A illustrates an example of an SS/PBCH block structure and location.

FIG. 11B illustrates an example of CSI-RSs that are mapped in the time and frequency domains.

FIG. 12A and FIG. 12B respectively illustrate examples of three downlink and uplink beam management procedures.

FIG. 13A, FIG. 13B, and FIG. 13C respectively illustrate a four-step contention-based random access procedure, a two-step contention-free random access procedure, and another two-step random access procedure.

FIG. 14A illustrates an example of CORESET configurations for a bandwidth part.

FIG. 14B illustrates an example of a CCE-to-REG mapping for DCI transmission on a CORESET and PDCCH processing.

FIG. 15 illustrates an example of a wireless device in communication with a base station.

FIG. 16A, FIG. 16B, FIG. 16C, and FIG. 16D illustrate example structures for uplink and downlink transmission.

FIG. 17A and FIG. 17B and FIG. 17C illustrate example slot formats for one or more slots, according to some embodiments.

FIG. 18 illustrates an example of slot formats of a slot, according to some embodiments.

FIG. 19A illustrates a slot format combination, according to some embodiments.

FIG. 19B illustrates a plurality of slot format combinations of a cell, according to some embodiments.

FIG. 20 illustrates an example scenario for initial BWP configuration in a TDD system, according to some embodiments.

FIG. 21 illustrates an example scenario for initial BWP configuration in a TDD system, according to some embodiments.

FIG. 22 illustrates an example of RedCap and non-RedCap operation in a TDD system, according to some embodiments.

FIG. 23 illustrates an example of RedCap and non-RedCap operation in a TDD system, according to some embodiments.

FIG. 24 illustrates an example of RedCap and non-RedCap operation in a TDD system, according to some embodiments.

FIG. 25A and FIG. 25B illustrate examples of TDD UL/DL configuration, according to some embodiments.

FIG. 26A and FIG. 26B illustrate an example of TDD UL/DL configuration, according to some embodiments.

FIG. 27 illustrates an example of TDD UL/DL configuration, according to some embodiments.

FIG. 28 illustrates an example of TDD UL/DL configuration, according to some embodiments.

FIG. 29 illustrates an example of slot format determination for a UE configured with multiple TDD UL/DL patterns, according to some embodiments.

FIG. 30 illustrates an example of a second TDD UL/DL pattern overriding a first TDD UL/DL pattern, according to some embodiments.

FIG. 31 illustrates an example of TDD UL/DL configuration, according to some embodiments.

### DETAILED DESCRIPTION

In the present disclosure, various embodiments are presented as examples of how the disclosed techniques may be implemented and/or how the disclosed techniques may be practiced in environments and scenarios. It will be apparent to persons skilled in the relevant art that various changes in form and detail can be made therein without departing from the scope. In fact, after reading the description, it will be apparent to one skilled in the relevant art how to implement alternative embodiments. The present embodiments should not be limited by any of the described exemplary embodiments. The embodiments of the present disclosure will be described with reference to the accompanying drawings. Limitations, features, and/or elements from the disclosed example embodiments may be combined to create further embodiments within the scope of the disclosure. Any figures which highlight the functionality and advantages, are presented for example purposes only. The disclosed architecture is sufficiently flexible and configurable, such that it may be utilized in ways other than that shown. For example, the actions listed in any flowchart may be re-ordered or only optionally used in some embodiments.

Embodiments may be configured to operate as needed. The disclosed mechanism may be performed when certain criteria are met, for example, in a wireless device, a base station, a radio environment, a network, a combination of the above, and/or the like. Example criteria may be based, at least in part, on for example, wireless device or network node configurations, traffic load, initial system set up, packet sizes, traffic characteristics, a combination of the above, and/or the like. When the one or more criteria are met, various example embodiments may be applied. Therefore, it may be possible to implement example embodiments that selectively implement disclosed protocols.

A base station may communicate with a mix of wireless devices. Wireless devices and/or base stations may support multiple technologies, and/or multiple releases of the same technology. Wireless devices may have some specific capability(ies) depending on wireless device category and/or capability(ies). When this disclosure refers to a base station communicating with a plurality of wireless devices, this disclosure may refer to a subset of the total wireless devices in a coverage area. This disclosure may refer to, for example, a plurality of wireless devices of a given LTE or 5G release with a given capability and in a given sector of the base station. The plurality of wireless devices in this disclosure may refer to a selected plurality of wireless devices, and/or a subset of total wireless devices in a coverage area which perform according to disclosed methods, and/or the like. There may be a plurality of base stations or a plurality of wireless devices in a coverage area that may not comply with the disclosed methods, for example, those wireless devices or base stations may perform based on older releases of LTE or 5G technology.

In this disclosure, “a” and “an” and similar phrases are to be interpreted as “at least one” and “one or more.” Similarly, any term that ends with the suffix “(s)” is to be interpreted as “at least one” and “one or more.” In this disclosure, the term “may” is to be interpreted as “may, for example.” In other words, the term “may” is indicative that the phrase following the term “may” is an example of one of a multitude of suitable possibilities that may, or may not, be employed by one or more of the various embodiments. The terms “comprises” and “consists of”, as used herein, enumerate one or more components of the element being described. The term “comprises” is interchangeable with “includes” and does not exclude unenumerated components from being included in the element being described. By contrast, “consists of” provides a complete enumeration of the one or more components of the element being described. The term “based on”, as used herein, should be interpreted as “based at least in part on” rather than, for example, “based solely on”. The term “and/or” as used herein represents any possible combination of enumerated elements. For example, “A, B, and/or C” may represent A; B; C; A and B; A and C; B and C; or A, B, and C.

If A and B are sets and every element of A is an element of B, A is called a subset of B. In this specification, only non-empty sets and subsets are considered. For example, possible subsets of B={cell1, cell2} are: {cell1}, {cell2}, and {cell1, cell2}. The phrase “based on” (or equally “based at least on”) is indicative that the phrase following the term “based on” is an example of one of a multitude of suitable possibilities that may, or may not, be employed to one or more of the various embodiments. The phrase “in response to” (or equally “in response at least to”) is indicative that the phrase following the phrase “in response to” is an example of one of a multitude of suitable possibilities that may, or may not, be employed to one or more of the various embodiments. The phrase “depending on” (or equally “depending at least to”) is indicative that the phrase following the phrase “depending on” is an example of one of a multitude of suitable possibilities that may, or may not, be employed to one or more of the various embodiments. The phrase “employing/using” (or equally “employing/using at least”) is indicative that the phrase following the phrase “employing/using” is an example of one of a multitude of suitable possibilities that may, or may not, be employed to one or more of the various embodiments.

The term configured may relate to the capacity of a device whether the device is in an operational or non-operational state. Configured may refer to specific settings in a device that affect the operational characteristics of the device whether the device is in an operational or non-operational state. In other words, the hardware, software, firmware, registers, memory values, and/or the like may be “configured” within a device, whether the device is in an operational or nonoperational state, to provide the device with specific characteristics. Terms such as “a control message to cause in a device” may mean that a control message has parameters that may be used to configure specific characteristics or may be used to implement certain actions in the device, whether the device is in an operational or non-operational state.

In this disclosure, parameters (or equally called, fields, or Information elements: IEs) may comprise one or more information objects, and an information object may comprise one or more other objects. For example, if parameter (IE) N comprises parameter (IE) M, and parameter (IE) M comprises parameter (IE) K, and parameter (IE) K comprises parameter (information element) J. Then, for example, N comprises K, and N comprises J. In an example embodiment, when one or more messages comprise a plurality of parameters, it implies that a parameter in the plurality of parameters is in at least one of the one or more messages, but does not have to be in each of the one or more messages.

Many features presented are described as being optional through the use of “may” or the use of parentheses. For the sake of brevity and legibility, the present disclosure does not explicitly recite each and every permutation that may be obtained by choosing from the set of optional features. The present disclosure is to be interpreted as explicitly disclosing all such permutations. For example, a system described as having three optional features may be embodied in seven ways, namely with just one of the three possible features, with any two of the three possible features or with three of the three possible features.

Many of the elements described in the disclosed embodiments may be implemented as modules. A module is defined here as an element that performs a defined function and has a defined interface to other elements. The modules described in this disclosure may be implemented in hardware, software in combination with hardware, firmware, wetware (e.g. hardware with a biological element) or a combination thereof, which may be behaviorally equivalent. For example, modules may be implemented as a software routine written in a computer language configured to be executed by a hardware machine (such as C, C++, Fortran, Java, Basic, Matlab or the like) or a modeling/simulation program such as Simulink, Stateflow, GNU Octave, or LabVIEWMathScript. It may be possible to implement modules using physical hardware that incorporates discrete or programmable analog, digital and/or quantum hardware. Examples of programmable hardware comprise: computers, microcontrollers, microprocessors, application-specific integrated circuits (ASICs); field programmable gate arrays (FPGAs); and complex programmable logic devices (CPLDs). Computers, microcontrollers and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. The mentioned technologies are often used in combination to achieve the result of a functional module.

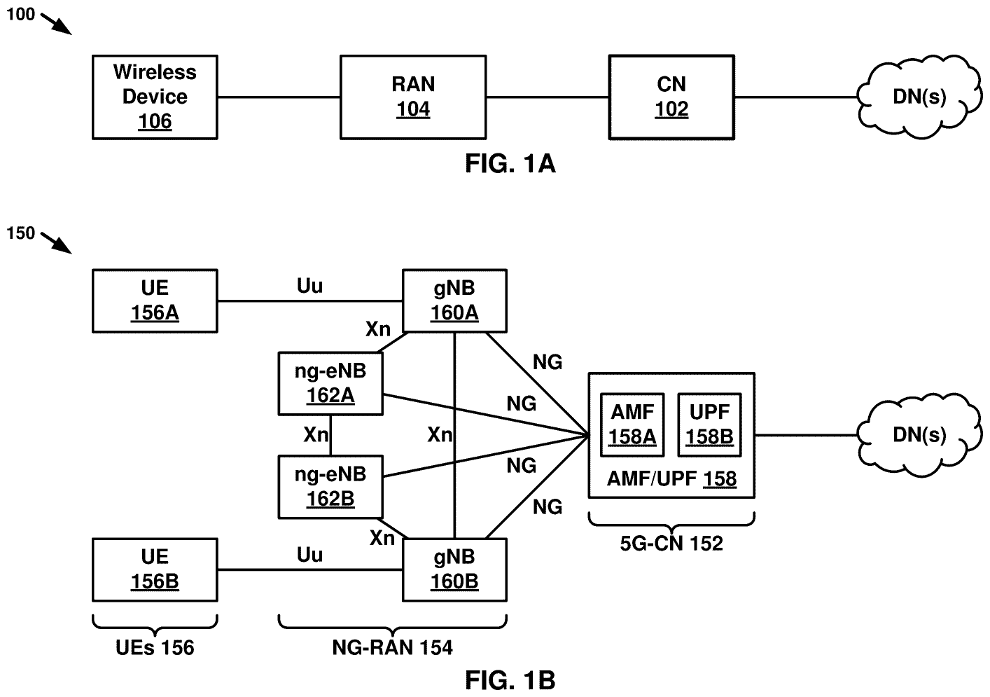

FIG. 1A illustrates an example of a mobile communication network 100 in which embodiments of the present disclosure may be implemented. The mobile communication network 100 may be, for example, a public land mobile network (PLMN) run by a network operator. As illustrated in FIG. 1A, the mobile communication network 100 includes a core network (CN) 102, a radio access network (RAN) 104, and a wireless device 106.

The CN 102 may provide the wireless device 106 with an interface to one or more data networks (DNs), such as public DNs (e.g., the Internet), private DNs, and/or intra-operator DNs. As part of the interface functionality, the CN 102 may set up end-to-end connections between the wireless device 106 and the one or more DNs, authenticate the wireless device 106, and provide charging functionality.

The RAN 104 may connect the CN 102 to the wireless device 106 through radio communications over an air interface. As part of the radio communications, the RAN 104 may provide scheduling, radio resource management, and retransmission protocols. The communication direction from the RAN 104 to the wireless device 106 over the air interface is known as the downlink and the communication direction from the wireless device 106 to the RAN 104 over the air interface is known as the uplink. Downlink transmissions may be separated from uplink transmissions using frequency division duplexing (FDD), time-division duplexing (TDD), and/or some combination of the two duplexing techniques.

The term wireless device may be used throughout this disclosure to refer to and encompass any mobile device or fixed (non-mobile) device for which wireless communication is needed or usable. For example, a wireless device may be a telephone, smart phone, tablet, computer, laptop, sensor, meter, wearable device, Internet of Things (IoT) device, vehicle roadside unit (RSU), relay node, automobile, and/or any combination thereof. The term wireless device encompasses other terminology, including user equipment (UE), user terminal (UT), access terminal (AT), mobile station, handset, wireless transmit and receive unit (WTRU), and/or wireless communication device.

The RAN 104 may include one or more base stations (not shown). The term base station may be used throughout this disclosure to refer to and encompass a Node B (associated with UMTS and/or 3G standards), an Evolved Node B (eNB, associated with E-UTRA and/or 4G standards), a remote radio head (RRH), a baseband processing unit coupled to one or more RRHs, a repeater node or relay node used to extend the coverage area of a donor node, a Next Generation Evolved Node B (ng-eNB), a Generation Node B (gNB, associated with NR and/or 5G standards), an access point (AP, associated with, for example, Wi-Fi or any other suitable wireless communication standard), and/or any combination thereof. A base station may comprise at least one gNB Central Unit (gNB-CU) and at least one a gNB Distributed Unit (gNB-DU).

A base station included in the RAN 104 may include one or more sets of antennas for communicating with the wireless device 106 over the air interface. For example, one or more of the base stations may include three sets of antennas to respectively control three cells (or sectors). The size of a cell may be determined by a range at which a receiver (e.g., a base station receiver) can successfully receive the transmissions from a transmitter (e.g., a wireless device transmitter) operating in the cell. Together, the cells of the base stations may provide radio coverage to the wireless device 106 over a wide geographic area to support wireless device mobility.

In addition to three-sector sites, other implementations of base stations are possible. For example, one or more of the base stations in the RAN 104 may be implemented as a sectored site with more or less than three sectors. One or more of the base stations in the RAN 104 may be implemented as an access point, as a baseband processing unit coupled to several remote radio heads (RRHs), and/or as a repeater or relay node used to extend the coverage area of a donor node. A baseband processing unit coupled to RRHs may be part of a centralized or cloud RAN architecture, where the baseband processing unit may be either centralized in a pool of baseband processing units or virtualized. A repeater node may amplify and rebroadcast a radio signal received from a donor node. A relay node may perform the same/similar functions as a repeater node but may decode the radio signal received from the donor node to remove noise before amplifying and rebroadcasting the radio signal.

The RAN 104 may be deployed as a homogenous network of macrocell base stations that have similar antenna patterns and similar high-level transmit powers. The RAN 104 may be deployed as a heterogeneous network. In heterogeneous networks, small cell base stations may be used to provide small coverage areas, for example, coverage areas that overlap with the comparatively larger coverage areas provided by macrocell base stations. The small coverage areas may be provided in areas with high data traffic (or so-called “hotspots”) or in areas with weak macrocell coverage. Examples of small cell base stations include, in order of decreasing coverage area, microcell base stations, picocell base stations, and femtocell base stations or home base stations.

The Third-Generation Partnership Project (3GPP) was formed in 1998 to provide global standardization of specifications for mobile communication networks similar to the mobile communication network 100 in FIG. 1A. To date, 3GPP has produced specifications for three generations of mobile networks: a third generation (3G) network known as Universal Mobile Telecommunications System (UMTS), a fourth generation (4G) network known as Long-Term Evolution (LTE), and a fifth generation (5G) network known as 5G System (5GS). Embodiments of the present disclosure are described with reference to the RAN of a 3GPP 5G network, referred to as next-generation RAN (NG-RAN). Embodiments may be applicable to RANs of other mobile communication networks, such as the RAN 104 in FIG. 1A, the RANs of earlier 3G and 4G networks, and those of future networks yet to be specified (e.g., a 3GPP 6G network). NG-RAN implements 5G radio access technology known as New Radio (NR) and may be provisioned to implement 4G radio access technology or other radio access technologies, including non-3GPP radio access technologies.

FIG. 1B illustrates another example mobile communication network 150 in which embodiments of the present disclosure may be implemented. Mobile communication network 150 may be, for example, a PLMN run by a network operator. As illustrated in FIG. 1B, mobile communication network 150 includes a 5G core network (5G-CN) 152, an NG-RAN 154, and UEs 156A and 156B (collectively UEs 156). These components may be implemented and operate in the same or similar manner as corresponding components described with respect to FIG. 1A.

The 5G-CN 152 provides the UEs 156 with an interface to one or more DNs, such as public DNs (e.g., the Internet), private DNs, and/or intra-operator DNs. As part of the interface functionality, the 5G-CN 152 may set up end-to-end connections between the UEs 156 and the one or more DNs, authenticate the UEs 156, and provide charging functionality. Compared to the CN of a 3GPP 4G network, the basis of the 5G-CN 152 may be a service-based architecture. This means that the architecture of the nodes making up the 5G-CN 152 may be defined as network functions that offer services via interfaces to other network functions. The network functions of the 5G-CN 152 may be implemented in several ways, including as network elements on dedicated or shared hardware, as software instances running on dedicated or shared hardware, or as virtualized functions instantiated on a platform (e.g., a cloud-based platform).

As illustrated in FIG. 1B, the 5G-CN 152 includes an Access and Mobility Management Function (AMF) 158A and a User Plane Function (UPF) 158B, which are shown as one component AMF/UPF 158 in FIG. 1B for ease of illustration. The UPF 158B may serve as a gateway between the NG-RAN 154 and the one or more DNs. The UPF 158B may perform functions such as packet routing and forwarding, packet inspection and user plane policy rule enforcement, traffic usage reporting, uplink classification to support routing of traffic flows to the one or more DNs, quality of service (QoS) handling for the user plane (e.g., packet filtering, gating, uplink/downlink rate enforcement, and uplink traffic verification), downlink packet buffering, and downlink data notification triggering. The UPF 158B may serve as an anchor point for intra-/inter-Radio Access Technology (RAT) mobility, an external protocol (or packet) data unit (PDU) session point of interconnect to the one or more DNs, and/or a branching point to support a multi-homed PDU session. The UEs 156 may be configured to receive services through a PDU session, which is a logical connection between a UE and a DN.

The AMF 158A may perform functions such as Non-Access Stratum (NAS) signaling termination, NAS signaling security, Access Stratum (AS) security control, inter-CN node signaling for mobility between 3GPP access networks, idle mode UE reachability (e.g., control and execution of paging retransmission), registration area management, intra-system and inter-system mobility support, access authentication, access authorization including checking of roaming rights, mobility management control (subscription and policies), network slicing support, and/or session management function (SMF) selection. NAS may refer to the functionality operating between a CN and a UE, and AS may refer to the functionality operating between the UE and a RAN.

The 5G-CN 152 may include one or more additional network functions that are not shown in FIG. 1B for the sake of clarity. For example, the 5G-CN 152 may include one or more of a Session Management Function (SMF), an NR Repository Function (NRF), a Policy Control Function (PCF), a Network Exposure Function (NEF), a Unified Data Management (UDM), an Application Function (AF), and/or an Authentication Server Function (AUSF).

The NG-RAN 154 may connect the 5G-CN 152 to the UEs 156 through radio communications over the air interface. The NG-RAN 154 may include one or more gNBs, illustrated as gNB 160A and gNB 160B (collectively gNBs 160) and/or one or more ng-eNBs, illustrated as ng-eNB 162A and ng-eNB 162B (collectively ng-eNBs 162). The gNBs 160 and ng-eNBs 162 may be more generically referred to as base stations. The gNBs 160 and ng-eNBs 162 may include one or more sets of antennas for communicating with the UEs 156 over an air interface. For example, one or more of the gNBs 160 and/or one or more of the ng-eNBs 162 may include three sets of antennas to respectively control three cells (or sectors). Together, the cells of the gNBs 160 and the ng-eNBs 162 may provide radio coverage to the UEs 156 over a wide geographic area to support UE mobility.

As shown in FIG. 1B, the gNBs 160 and/or the ng-eNBs 162 may be connected to the 5G-CN 152 by means of an NG interface and to other base stations by an Xn interface. The NG and Xn interfaces may be established using direct physical connections and/or indirect connections over an underlying transport network, such as an internet protocol (IP) transport network. The gNBs 160 and/or the ng-eNBs 162 may be connected to the UEs 156 by means of a Uu interface. For example, as illustrated in FIG. 1B, gNB 160A may be connected to the UE 156A by means of a Uu interface. The NG, Xn, and Uu interfaces are associated with a protocol stack. The protocol stacks associated with the interfaces may be used by the network elements in FIG. 1B to exchange data and signaling messages and may include two planes: a user plane and a control plane. The user plane may handle data of interest to a user. The control plane may handle signaling messages of interest to the network elements.

The gNBs 160 and/or the ng-eNBs 162 may be connected to one or more AMF/UPF functions of the 5G-CN 152, such as the AMF/UPF 158, by means of one or more NG interfaces. For example, the gNB 160A may be connected to the UPF 158B of the AMF/UPF 158 by means of an NG-User plane (NG-U) interface. The NG-U interface may provide delivery (e.g., non-guaranteed delivery) of user plane PDUs between the gNB 160A and the UPF 158B. The gNB 160A may be connected to the AMF 158A by means of an NG-Control plane (NG-C) interface. The NG-C interface may provide, for example, NG interface management, UE context management, UE mobility management, transport of NAS messages, paging, PDU session management, and configuration transfer and/or warning message transmission.

The gNBs 160 may provide NR user plane and control plane protocol terminations towards the UEs 156 over the Uu interface. For example, the gNB 160A may provide NR user plane and control plane protocol terminations toward the UE 156A over a Uu interface associated with a first protocol stack. The ng-eNBs 162 may provide Evolved UMTS Terrestrial Radio Access (E-UTRA) user plane and control plane protocol terminations towards the UEs 156 over a Uu interface, where E-UTRA refers to the 3GPP 4G radio-access technology. For example, the ng-eNB 162B may provide E-UTRA user plane and control plane protocol terminations towards the UE 156B over a Uu interface associated with a second protocol stack.

The 5G-CN 152 was described as being configured to handle NR and 4G radio accesses. It will be appreciated by one of ordinary skill in the art that it may be possible for NR to connect to a 4G core network in a mode known as “non-standalone operation.” In non-standalone operation, a 4G core network is used to provide (or at least support) control-plane functionality (e.g., initial access, mobility, and paging). Although only one AMF/UPF 158 is shown in FIG. 1B, one gNB or ng-eNB may be connected to multiple AMF/UPF nodes to provide redundancy and/or to load share across the multiple AMF/UPF nodes.

As discussed, an interface (e.g., Uu, Xn, and NG interfaces) between the network elements in FIG. 1B may be associated with a protocol stack that the network elements use to exchange data and signaling messages. A protocol stack may include two planes: a user plane and a control plane. The user plane may handle data of interest to a user, and the control plane may handle signaling messages of interest to the network elements.

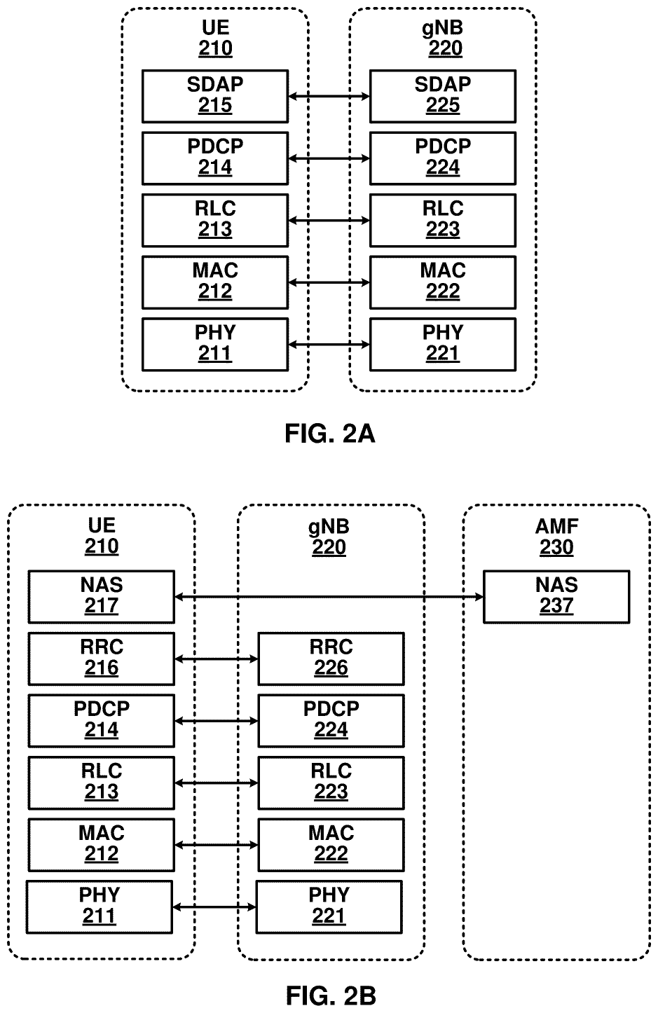

FIG. 2A and FIG. 2B respectively illustrate examples of NR user plane and NR control plane protocol stacks for the Uu interface that lies between a UE 210 and a gNB 220. The protocol stacks illustrated in FIG. 2A and FIG. 2B may be the same or similar to those used for the Uu interface between, for example, the UE 156A and the gNB 160A shown in FIG. 1B.

FIG. 2A illustrates a NR user plane protocol stack comprising five layers implemented in the UE 210 and the gNB 220. At the bottom of the protocol stack, physical layers (PHYs) 211 and 221 may provide transport services to the higher layers of the protocol stack and may correspond to layer 1 of the Open Systems Interconnection (OSI) model. The next four protocols above PHYs 211 and 221 comprise media access control layers (MACs) 212 and 222, radio link control layers (RLCs) 213 and 223, packet data convergence protocol layers (PDCPs) 214 and 224, and service data application protocol layers (SDAPs) 215 and 225. Together, these four protocols may make up layer 2, or the data link layer, of the OSI model.

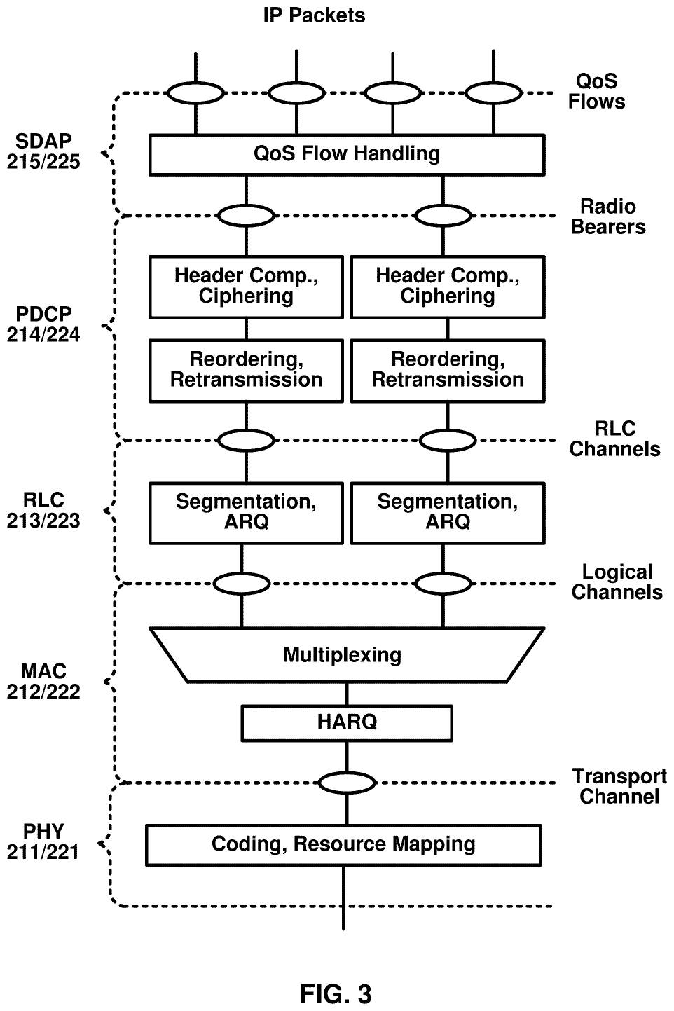

FIG. 3 illustrates an example of services provided between protocol layers of the NR user plane protocol stack. Starting from the top of FIG. 2A and FIG. 3, the SDAPs 215 and 225 may perform QoS flow handling. The UE 210 may receive services through a PDU session, which may be a logical connection between the UE 210 and a DN. The PDU session may have one or more QoS flows. A UPF of a CN (e.g., the UPF 158B) may map IP packets to the one or more QoS flows of the PDU session based on QoS requirements (e.g., in terms of delay, data rate, and/or error rate). The SDAPs 215 and 225 may perform mapping/de-mapping between the one or more QoS flows and one or more data radio bearers. The mapping/de-mapping between the QoS flows and the data radio bearers may be determined by the SDAP 225 at the gNB 220. The SDAP 215 at the UE 210 may be informed of the mapping between the QoS flows and the data radio bearers through reflective mapping or control signaling received from the gNB 220. For reflective mapping, the SDAP 225 at the gNB 220 may mark the downlink packets with a QoS flow indicator (QFI), which may be observed by the SDAP 215 at the UE 210 to determine the mapping/de-mapping between the QoS flows and the data radio bearers.

The PDCPs 214 and 224 may perform header compression/decompression to reduce the amount of data that needs to be transmitted over the air interface, ciphering/deciphering to prevent unauthorized decoding of data transmitted over the air interface, and integrity protection (to ensure control messages originate from intended sources. The PDCPs 214 and 224 may perform retransmissions of undelivered packets, in-sequence delivery and reordering of packets, and removal of packets received in duplicate due to, for example, an intra-gNB handover. The PDCPs 214 and 224 may perform packet duplication to improve the likelihood of the packet being received and, at the receiver, remove any duplicate packets. Packet duplication may be useful for services that require high reliability.

Although not shown in FIG. 3, PDCPs 214 and 224 may perform mapping/de-mapping between a split radio bearer and RLC channels in a dual connectivity scenario. Dual connectivity is a technique that allows a UE to connect to two cells or, more generally, two cell groups: a master cell group (MCG) and a secondary cell group (SCG). A split bearer is when a single radio bearer, such as one of the radio bearers provided by the PDCPs 214 and 224 as a service to the SDAPs 215 and 225, is handled by cell groups in dual connectivity. The PDCPs 214 and 224 may map/de-map the split radio bearer between RLC channels belonging to cell groups.

The RLCs 213 and 223 may perform segmentation, retransmission through Automatic Repeat Request (ARQ), and removal of duplicate data units received from MACs 212 and 222, respectively. The RLCs 213 and 223 may support three transmission modes: transparent mode (TM); unacknowledged mode (UM); and acknowledged mode (AM). Based on the transmission mode an RLC is operating, the RLC may perform one or more of the noted functions. The RLC configuration may be per logical channel with no dependency on numerologies and/or Transmission Time Interval (TTI) durations. As shown in FIG. 3, the RLCs 213 and 223 may provide RLC channels as a service to PDCPs 214 and 224, respectively.

The MACs 212 and 222 may perform multiplexing/demultiplexing of logical channels and/or mapping between logical channels and transport channels. The multiplexing/demultiplexing may include multiplexing/demultiplexing of data units, belonging to the one or more logical channels, into/from Transport Blocks (TBs) delivered to/from the PHYs 211 and 221. The MAC 222 may be configured to perform scheduling, scheduling information reporting, and priority handling between UEs by means of dynamic scheduling. Scheduling may be performed in the gNB 220 (at the MAC 222) for downlink and uplink. The MACs 212 and 222 may be configured to perform error correction through Hybrid Automatic Repeat Request (HARQ) (e.g., one HARQ entity per carrier in case of Carrier Aggregation (CA)), priority handling between logical channels of the UE 210 by means of logical channel prioritization, and/or padding. The MACs 212 and 222 may support one or more numerologies and/or transmission timings. In an example, mapping restrictions in a logical channel prioritization may control which numerology and/or transmission timing a logical channel may use. As shown in FIG. 3, the MACs 212 and 222 may provide logical channels as a service to the RLCs 213 and 223.

The PHYs 211 and 221 may perform mapping of transport channels to physical channels and digital and analog signal processing functions for sending and receiving information over the air interface. These digital and analog signal processing functions may include, for example, coding/decoding and modulation/demodulation. The PHYs 211 and 221 may perform multi-antenna mapping. As shown in FIG. 3, the PHYs 211 and 221 may provide one or more transport channels as a service to the MACs 212 and 222.

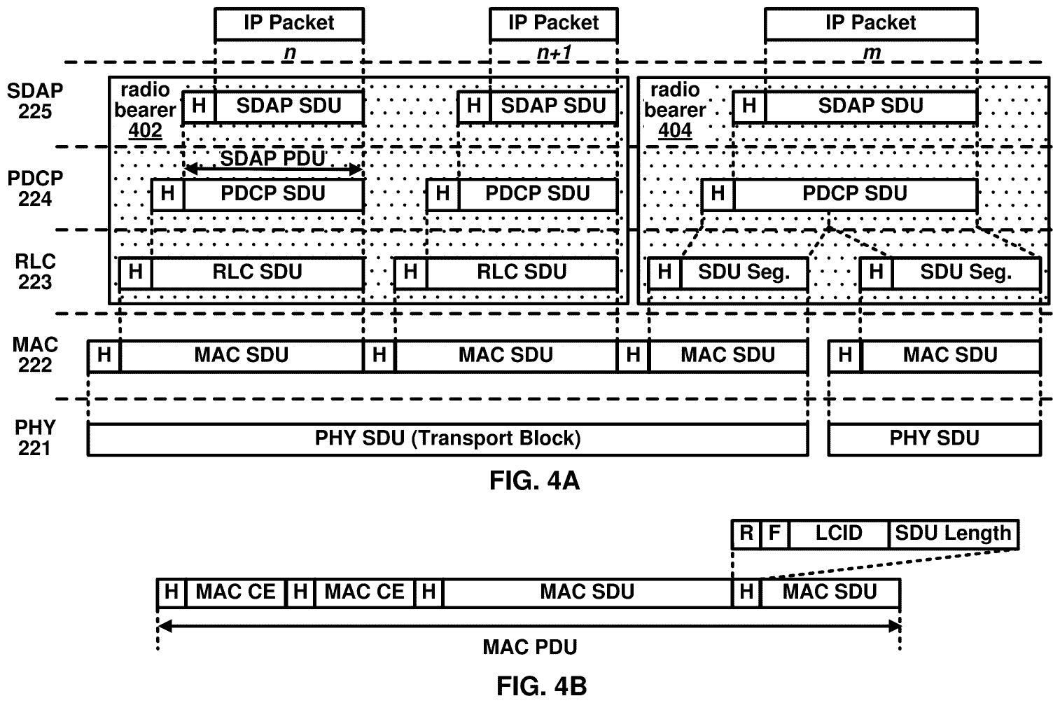

FIG. 4A illustrates an example downlink data flow through the NR user plane protocol stack. FIG. 4A illustrates a downlink data flow of three IP packets (n, n+1, and m) through the NR user plane protocol stack to generate two TBs at the gNB 220. An uplink data flow through the NR user plane protocol stack may be similar to the downlink data flow depicted in FIG. 4A.

The downlink data flow of FIG. 4A begins when SDAP 225 receives the three IP packets from one or more QoS flows and maps the three packets to radio bearers. In FIG. 4A, the SDAP 225 maps IP packets n and n+1 to a first radio bearer 402 and maps IP packet m to a second radio bearer 404. An SDAP header (labeled with an “H” in FIG. 4A) is added to an IP packet. The data unit from/to a higher protocol layer is referred to as a service data unit (SDU) of the lower protocol layer and the data unit to/from a lower protocol layer is referred to as a protocol data unit (PDU) of the higher protocol layer. As shown in FIG. 4A, the data unit from the SDAP 225 is an SDU of lower protocol layer PDCP 224 and is a PDU of the SDAP 225.

The remaining protocol layers in FIG. 4A may perform their associated functionality (e.g., with respect to FIG. 3), add corresponding headers, and forward their respective outputs to the next lower layer. For example, the PDCP 224 may perform IP-header compression and ciphering and forward its output to the RLC 223. The RLC 223 may optionally perform segmentation (e.g., as shown for IP packet m in FIG. 4A) and forward its output to the MAC 222. The MAC 222 may multiplex a number of RLC PDUs and may attach a MAC subheader to an RLC PDU to form a transport block. In NR, the MAC subheaders may be distributed across the MAC PDU, as illustrated in FIG. 4A. In LTE, the MAC subheaders may be entirely located at the beginning of the MAC PDU. The NR MAC PDU structure may reduce processing time and associated latency because the MAC PDU subheaders may be computed before the full MAC PDU is assembled.

FIG. 4B illustrates an example format of a MAC subheader in a MAC PDU. The MAC subheader includes: an SDU length field for indicating the length (e.g., in bytes) of the MAC SDU to which the MAC subheader corresponds; a logical channel identifier (LCID) field for identifying the logical channel from which the MAC SDU originated to aid in the demultiplexing process; a flag (F) for indicating the size of the SDU length field; and a reserved bit (R) field for future use.

FIG. 4B further illustrates MAC control elements (CEs) inserted into the MAC PDU by a MAC, such as MAC 223 or MAC 222. For example, FIG. 4B illustrates two MAC CEs inserted into the MAC PDU. MAC CEs may be inserted at the beginning of a MAC PDU for downlink transmissions (as shown in FIG. 4B) and at the end of a MAC PDU for uplink transmissions. MAC CEs may be used for in-band control signaling. Example MAC CEs include: scheduling-related MAC CEs, such as buffer status reports and power headroom reports; activation/deactivation MAC CEs, such as those for activation/deactivation of PDCP duplication detection, channel state information (CSI) reporting, sounding reference signal (SRS) transmission, and prior configured components; discontinuous reception (DRX) related MAC CEs; timing advance MAC CEs; and random access related MAC CEs. A MAC CE may be preceded by a MAC subheader with a similar format as described for MAC SDUs and may be identified with a reserved value in the LCID field that indicates the type of control information included in the MAC CE.

Before describing the NR control plane protocol stack, logical channels, transport channels, and physical channels are first described as well as a mapping between the channel types. One or more of the channels may be used to carry out functions associated with the NR control plane protocol stack described later below.

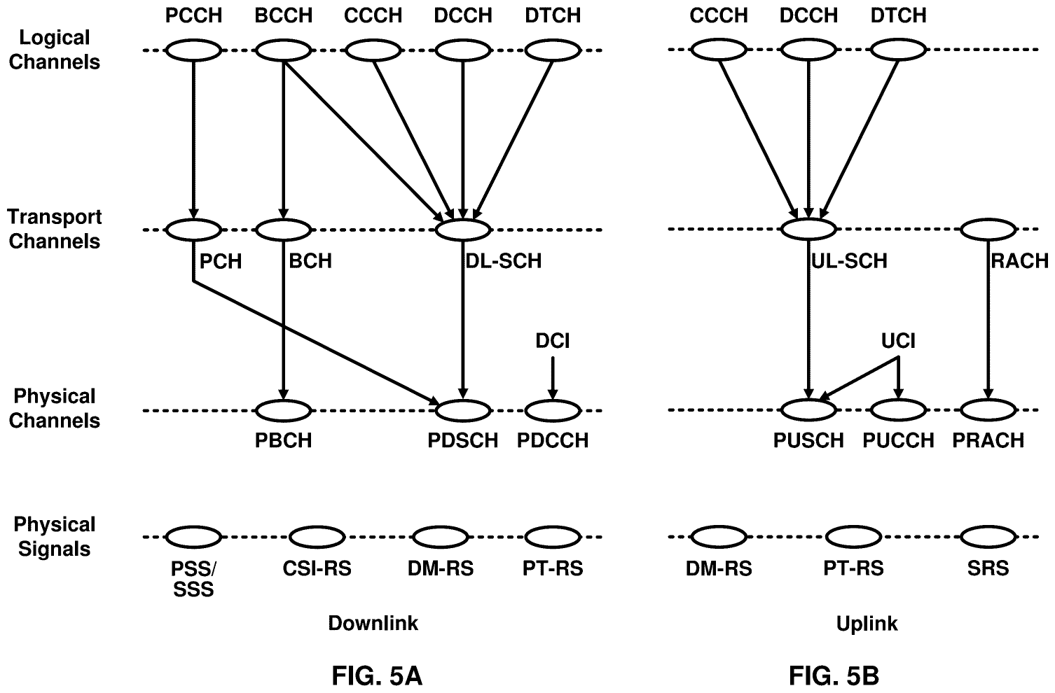

FIG. 5A and FIG. 5B illustrate, for downlink and uplink respectively, a mapping between logical channels, transport channels, and physical channels. Information is passed through channels between the RLC, the MAC, and the PHY of the NR protocol stack. A logical channel may be used between the RLC and the MAC and may be classified as a control channel that carries control and configuration information in the NR control plane or as a traffic channel that carries data in the NR user plane. A logical channel may be classified as a dedicated logical channel that is dedicated to a specific UE or as a common logical channel that may be used by more than one UE. A logical channel may also be defined by the type of information it carries. The set of logical channels defined by NR include, for example:
a paging control channel (PCCH) for carrying paging messages used to page a UE whose location is not known to the network on a cell level;
a broadcast control channel (BCCH) for carrying system information messages in the form of a master information block (MIB) and several system information blocks (SIBs), wherein the system information messages may be used by the UEs to obtain information about how a cell is configured and how to operate within the cell;
a common control channel (CCCH) for carrying control messages together with random access;
a dedicated control channel (DCCH) for carrying control messages to/from a specific the UE to configure the UE; and
a dedicated traffic channel (DTCH) for carrying user data to/from a specific the UE.

Transport channels are used between the MAC and PHY layers and may be defined by how the information they carry is transmitted over the air interface. The set of transport channels defined by NR include, for example:
a paging channel (PCH) for carrying paging messages that originated from the PCCH;
a broadcast channel (BCH) for carrying the MIB from the BCCH;
a downlink shared channel (DL-SCH) for carrying downlink data and signaling messages, including the SIBs from the BCCH;
an uplink shared channel (UL-SCH) for carrying uplink data and signaling messages; and
a random access channel (RACH) for allowing a UE to contact the network without any prior scheduling.

The PHY may use physical channels to pass information between processing levels of the PHY. A physical channel may have an associated set of time-frequency resources for carrying the information of one or more transport channels. The PHY may generate control information to support the low-level operation of the PHY and provide the control information to the lower levels of the PHY via physical control channels, known as L1/L2 control channels. The set of physical channels and physical control channels defined by NR include, for example:
a physical broadcast channel (PBCH) for carrying the MIB from the BCH;
a physical downlink shared channel (PDSCH) for carrying downlink data and signaling messages from the DL-SCH, as well as paging messages from the PCH;
a physical downlink control channel (PDCCH) for carrying downlink control information (DCI), which may include downlink scheduling commands, uplink scheduling grants, and uplink power control commands;
a physical uplink shared channel (PUSCH) for carrying uplink data and signaling messages from the UL-SCH and in some instances uplink control information (UCI) as described below;
a physical uplink control channel (PUCCH) for carrying UCI, which may include HARQ acknowledgments, channel quality indicators (CQI), pre-coding matrix indicators (PMI), rank indicators (RI), and scheduling requests (SR); and
a physical random access channel (PRACH) for random access.

Similar to the physical control channels, the physical layer generates physical signals to support the low-level operation of the physical layer. As shown in FIG. 5A and FIG. 5B, the physical layer signals defined by NR include: primary synchronization signals (PSS), secondary synchronization signals (SSS), channel state information reference signals (CSI-RS), demodulation reference signals (DMRS), sounding reference signals (SRS), and phase-tracking reference signals (PT-RS). These physical layer signals will be described in greater detail below.

FIG. 2B illustrates an example NR control plane protocol stack. As shown in FIG. 2B, the NR control plane protocol stack may use the same/similar first four protocol layers as the example NR user plane protocol stack. These four protocol layers include the PHYs 211 and 221, the MACs 212 and 222, the RLCs 213 and 223, and the PDCPs 214 and 224. Instead of having the SDAPs 215 and 225 at the top of the stack as in the NR user plane protocol stack, the NR control plane stack has radio resource controls (RRCs) 216 and 226 and NAS protocols 217 and 237 at the top of the NR control plane protocol stack.

The NAS protocols 217 and 237 may provide control plane functionality between the UE 210 and the AMF 230 (e.g., the AMF 158A) or, more generally, between the UE 210 and the CN. The NAS protocols 217 and 237 may provide control plane functionality between the UE 210 and the AMF 230 via signaling messages, referred to as NAS messages. There is no direct path between the UE 210 and the AMF 230 through which the NAS messages can be transported. The NAS messages may be transported using the AS of the Uu and NG interfaces. NAS protocols 217 and 237 may provide control plane functionality such as authentication, security, connection setup, mobility management, and session management.

The RRCs 216 and 226 may provide control plane functionality between the UE 210 and the gNB 220 or, more generally, between the UE 210 and the RAN. The RRCs 216 and 226 may provide control plane functionality between the UE 210 and the gNB 220 via signaling messages, referred to as RRC messages. RRC messages may be transmitted between the UE 210 and the RAN using signaling radio bearers and the same/similar PDCP, RLC, MAC, and PHY protocol layers. The MAC may multiplex control-plane and user-plane data into the same transport block (TB). The RRCs 216 and 226 may provide control plane functionality such as: broadcast of system information related to AS and NAS; paging initiated by the CN or the RAN; establishment, maintenance and release of an RRC connection between the UE 210 and the RAN; security functions including key management; establishment, configuration, maintenance and release of signaling radio bearers and data radio bearers; mobility functions; QoS management functions; the UE measurement reporting and control of the reporting; detection of and recovery from radio link failure (RLF); and/or NAS message transfer. As part of establishing an RRC connection, RRCs 216 and 226 may establish an RRC context, which may involve configuring parameters for communication between the UE 210 and the RAN.

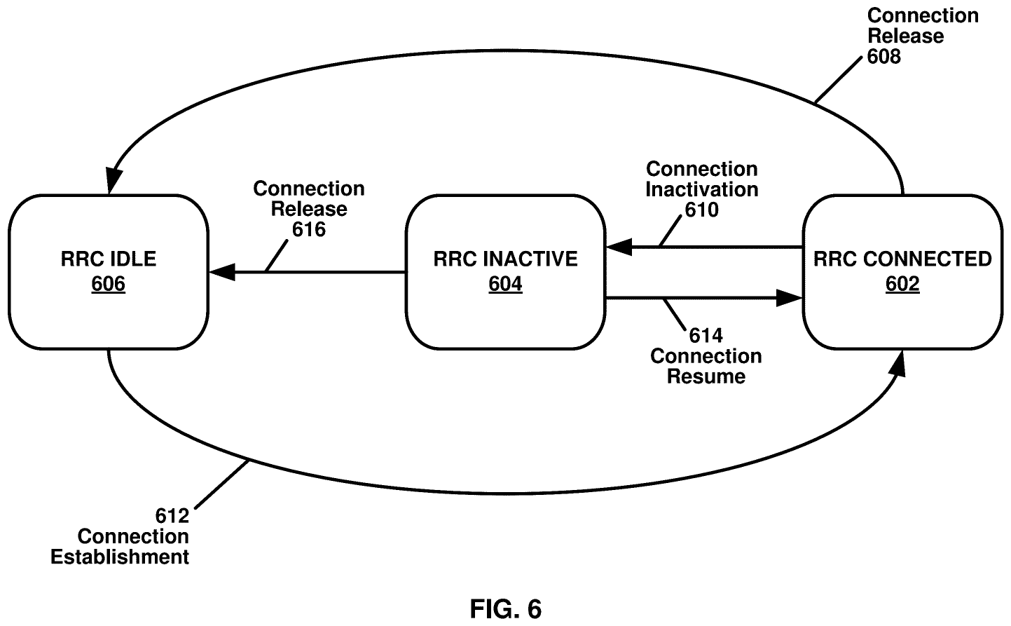

FIG. 6 is an example diagram showing RRC state transitions of a UE. The UE may be the same or similar to the wireless device 106 depicted in FIG. 1A, the UE 210 depicted in FIG. 2A and FIG. 2B, or any other wireless device described in the present disclosure. As illustrated in FIG. 6, a UE may be in at least one of three RRC states: RRC connected 602 (e.g., RRC_CONNECTED), RRC idle 604 (e.g., RRC_IDLE), and RRC inactive 606 (e.g., RRC_INACTIVE).

In RRC connected 602, the UE has an established RRC context and may have at least one RRC connection with a base station. The base station may be similar to one of the one or more base stations included in the RAN 104 depicted in FIG. 1A, one of the gNBs 160 or ng-eNBs 162 depicted in FIG. 1B, the gNB 220 depicted in FIG. 2A and FIG. 2B, or any other base station described in the present disclosure. The base station with which the UE is connected may have the RRC context for the UE. The RRC context, referred to as the UE context, may comprise parameters for communication between the UE and the base station. These parameters may include, for example: one or more AS contexts; one or more radio link configuration parameters; bearer configuration information (e.g., relating to a data radio bearer, signaling radio bearer, logical channel, QoS flow, and/or PDU session); security information; and/or PHY, MAC, RLC, PDCP, and/or SDAP layer configuration information. While in RRC connected 602, mobility of the UE may be managed by the RAN (e.g., the RAN 104 or the NG-RAN 154). The UE may measure the signal levels (e.g., reference signal levels) from a serving cell and neighboring cells and report these measurements to the base station currently serving the UE. The UE's serving base station may request a handover to a cell of one of the neighboring base stations based on the reported measurements. The RRC state may transition from RRC connected 602 to RRC idle 604 through a connection release procedure 608 or to RRC inactive 606 through a connection inactivation procedure 610.

In RRC idle 604, an RRC context may not be established for the UE. In RRC idle 604, the UE may not have an RRC connection with the base station. While in RRC idle 604, the UE may be in a sleep state for the majority of the time (e.g., to conserve battery power). The UE may wake up periodically (e.g., once in every discontinuous reception cycle) to monitor for paging messages from the RAN. Mobility of the UE may be managed by the UE through a procedure known as cell reselection. The RRC state may transition from RRC idle 604 to RRC connected 602 through a connection establishment procedure 612, which may involve a random access procedure as discussed in greater detail below.

In RRC inactive 606, the RRC context previously established is maintained in the UE and the base station. This allows for a fast transition to RRC connected 602 with reduced signaling overhead as compared to the transition from RRC idle 604 to RRC connected 602. While in RRC inactive 606, the UE may be in a sleep state and mobility of the UE may be managed by the UE through cell reselection. The RRC state may transition from RRC inactive 606 to RRC connected 602 through a connection resume procedure 614 or to RRC idle 604 though a connection release procedure 616 that may be the same as or similar to connection release procedure 608.

An RRC state may be associated with a mobility management mechanism. In RRC idle 604 and RRC inactive 606, mobility is managed by the UE through cell reselection. The purpose of mobility management in RRC idle 604 and RRC inactive 606 is to allow the network to be able to notify the UE of an event via a paging message without having to broadcast the paging message over the entire mobile communications network. The mobility management mechanism used in RRC idle 604 and RRC inactive 606 may allow the network to track the UE on a cell-group level so that the paging message may be broadcast over the cells of the cell group that the UE currently resides within instead of the entire mobile communication network. The mobility management mechanisms for RRC idle 604 and RRC inactive 606 track the UE on a cell-group level. They may do so using different granularities of grouping. For example, there may be three levels of cell-grouping granularity: individual cells; cells within a RAN area identified by a RAN area identifier (RAI); and cells within a group of RAN areas, referred to as a tracking area and identified by a tracking area identifier (TAI).

Tracking areas may be used to track the UE at the CN level. The CN (e.g., the CN 102 or the 5G-CN 152) may provide the UE with a list of TAIs associated with a UE registration area. If the UE moves, through cell reselection, to a cell associated with a TAI not included in the list of TAIs associated with the UE registration area, the UE may perform a registration update with the CN to allow the CN to update the UE's location and provide the UE with a new the UE registration area.

RAN areas may be used to track the UE at the RAN level. For a UE in RRC inactive 606 state, the UE may be assigned a RAN notification area. A RAN notification area may comprise one or more cell identities, a list of RAIs, or a list of TAIs. In an example, a base station may belong to one or more RAN notification areas. In an example, a cell may belong to one or more RAN notification areas. If the UE moves, through cell reselection, to a cell not included in the RAN notification area assigned to the UE, the UE may perform a notification area update with the RAN to update the UE's RAN notification area.

A base station storing an RRC context for a UE or a last serving base station of the UE may be referred to as an anchor base station. An anchor base station may maintain an RRC context for the UE at least during a period of time that the UE stays in a RAN notification area of the anchor base station and/or during a period of time that the UE stays in RRC inactive 606.

A gNB, such as gNBs 160 in FIG. 1B, may be split into two parts: a central unit (gNB-CU), and one or more distributed units (gNB-DU). A gNB-CU may be coupled to one or more gNB-DUs using an F1 interface. The gNB-CU may comprise the RRC, the PDCP, and the SDAP. A gNB-DU may comprise the RLC, the MAC, and the PHY.

In NR, the physical signals and physical channels (discussed with respect to FIG. 5A and FIG. 5B) may be mapped onto orthogonal frequency divisional multiplexing (OFDM) symbols. OFDM is a multicarrier communication scheme that transmits data over F orthogonal subcarriers (or tones). Before transmission, the data may be mapped to a series of complex symbols (e.g., M-quadrature amplitude modulation (M-QAM) or M-phase shift keying (M-PSK) symbols), referred to as source symbols, and divided into F parallel symbol streams. The F parallel symbol streams may be treated as though they are in the frequency domain and used as inputs to an Inverse Fast Fourier Transform (IFFT) block that transforms them into the time domain. The IFFT block may take in F source symbols at a time, one from each of the F parallel symbol streams, and use each source symbol to modulate the amplitude and phase of one of F sinusoidal basis functions that correspond to the F orthogonal subcarriers. The output of the IFFT block may be F time-domain samples that represent the summation of the F orthogonal subcarriers. The F time-domain samples may form a single OFDM symbol. After some processing (e.g., addition of a cyclic prefix) and up-conversion, an OFDM symbol provided by the IFFT block may be transmitted over the air interface on a carrier frequency. The F parallel symbol streams may be mixed using an FFT block before being processed by the IFFT block. This operation produces Discrete Fourier Transform (DFT)-precoded OFDM symbols and may be used by UEs in the uplink to reduce the peak to average power ratio (PAPR). Inverse processing may be performed on the OFDM symbol at a receiver using an FFT block to recover the data mapped to the source symbols.

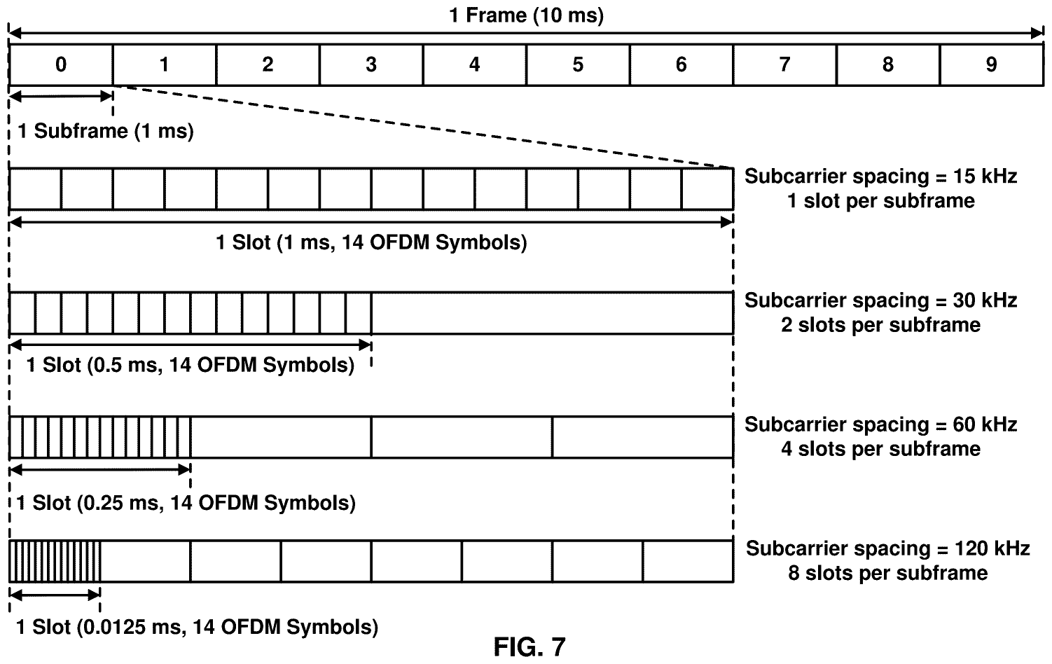

FIG. 7 illustrates an example configuration of an NR frame into which OFDM symbols are grouped. An NR frame may be identified by a system frame number (SFN). The SFN may repeat with a period of 1024 frames. As illustrated, one NR frame may be 10 milliseconds (ms) in duration and may include 10 subframes that are 1 ms in duration. A subframe may be divided into slots that include, for example, 14 OFDM symbols per slot.

The duration of a slot may depend on the numerology used for the OFDM symbols of the slot. In NR, a flexible numerology is supported to accommodate different cell deployments (e.g., cells with carrier frequencies below 1 GHz up to cells with carrier frequencies in the mm-wave range). A numerology may be defined in terms of subcarrier spacing and cyclic prefix duration. For a numerology in NR, subcarrier spacings may be scaled up by powers of two from a baseline subcarrier spacing of 15 kHz, and cyclic prefix durations may be scaled down by powers of two from a baseline cyclic prefix duration of 4.7 ps. For example, NR defines numerologies with the following subcarrier spacing/cyclic prefix duration combinations: 15 kHz/4.7 ps; 30 kHz/2.3 μs; 60 kHz/1.2 μs; 120 kHz/0.59 μs; and 240 kHz/0.29 μs.

A slot may have a fixed number of OFDM symbols (e.g., 14 OFDM symbols). A numerology with a higher subcarrier spacing has a shorter slot duration and, correspondingly, more slots per subframe. FIG. 7 illustrates this numerology-dependent slot duration and slots-per-subframe transmission structure (the numerology with a subcarrier spacing of 240 kHz is not shown in FIG. 7 for ease of illustration). A subframe in NR may be used as a numerology-independent time reference, while a slot may be used as the unit upon which uplink and downlink transmissions are scheduled. To support low latency, scheduling in NR may be decoupled from the slot duration and start at any OFDM symbol and last for as many symbols as needed for a transmission. These partial slot transmissions may be referred to as mini-slot or subslot transmissions.

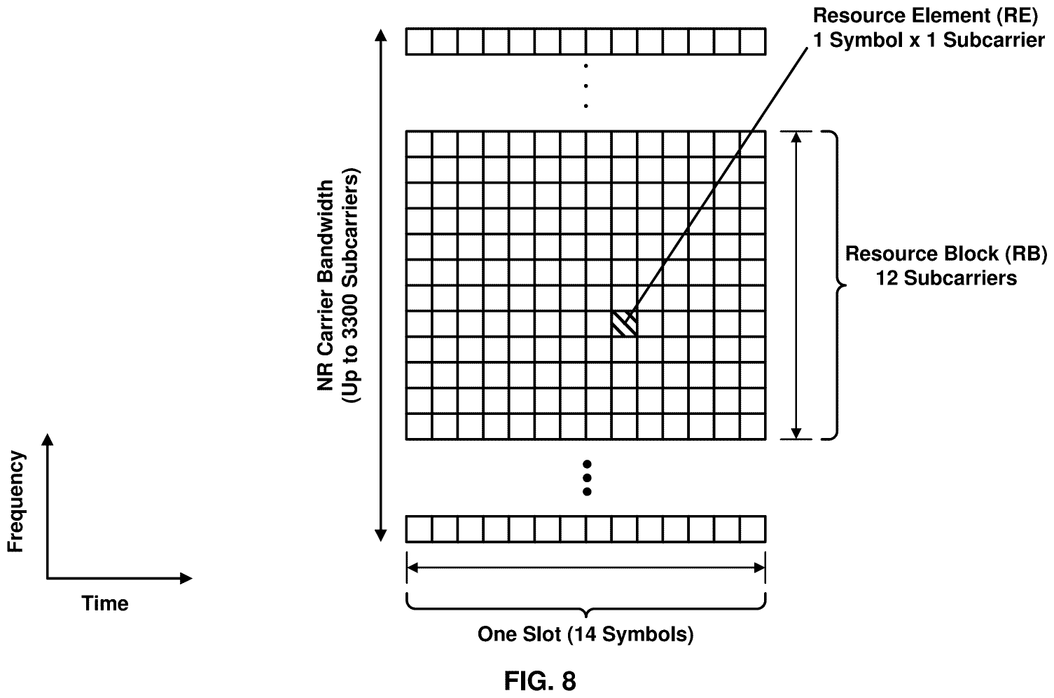

FIG. 8 illustrates an example configuration of a slot in the time and frequency domain for an NR carrier. The slot includes resource elements (REs) and resource blocks (RBs). An RE is the smallest physical resource in NR. An RE spans one OFDM symbol in the time domain by one subcarrier in the frequency domain as shown in FIG. 8. An RB spans twelve consecutive REs in the frequency domain as shown in FIG. 8. An NR carrier may be limited to a width of 275 RBs or 275×12=3300 subcarriers. Such a limitation, if used, may limit the NR carrier to 50, 100, 200, and 400 MHz for subcarrier spacings of 15, 30, 60, and 120 kHz, respectively, where the 400 MHz bandwidth may be set based on a 400 MHz per carrier bandwidth limit.

FIG. 8 illustrates a single numerology being used across the entire bandwidth of the NR carrier. In other example configurations, multiple numerologies may be supported on the same carrier.

NR may support wide carrier bandwidths (e.g., up to 400 MHz for a subcarrier spacing of 120 kHz). Not all UEs may be able to receive the full carrier bandwidth (e.g., due to hardware limitations). Also, receiving the full carrier bandwidth may be prohibitive in terms of UE power consumption. In an example, to reduce power consumption and/or for other purposes, a UE may adapt the size of the UE's receive bandwidth based on the amount of traffic the UE is scheduled to receive. This is referred to as bandwidth adaptation.

NR defines bandwidth parts (BWPs) to support UEs not capable of receiving the full carrier bandwidth and to support bandwidth adaptation. In an example, a BWP may be defined by a subset of contiguous RBs on a carrier. A UE may be configured (e.g., via RRC layer) with one or more downlink BWPs and one or more uplink BWPs per serving cell (e.g., up to four downlink BWPs and up to four uplink BWPs per serving cell). At a given time, one or more of the configured BWPs for a serving cell may be active. These one or more BWPs may be referred to as active BWPs of the serving cell. When a serving cell is configured with a secondary uplink carrier, the serving cell may have one or more first active BWPs in the uplink carrier and one or more second active BWPs in the secondary uplink carrier.

For unpaired spectra, a downlink BWP from a set of configured downlink BWPs may be linked with an uplink BWP from a set of configured uplink BWPs if a downlink BWP index of the downlink BWP and an uplink BWP index of the uplink BWP are the same. For unpaired spectra, a UE may expect that a center frequency for a downlink BWP is the same as a center frequency for an uplink BWP.

For a downlink BWP in a set of configured downlink BWPs on a primary cell (PCell), a base station may configure a UE with one or more control resource sets (CORESETs) for at least one search space. A search space is a set of locations in the time and frequency domains where the UE may find control information. The search space may be a UE-specific search space or a common search space (potentially usable by a plurality of UEs). For example, a base station may configure a UE with a common search space, on a PCell or on a primary secondary cell (PSCell), in an active downlink BWP.

For an uplink BWP in a set of configured uplink BWPs, a BS may configure a UE with one or more resource sets for one or more PUCCH transmissions. A UE may receive downlink receptions (e.g., PDCCH or PDSCH) in a downlink BWP according to a configured numerology (e.g., subcarrier spacing and cyclic prefix duration) for the downlink BWP. The UE may transmit uplink transmissions (e.g., PUCCH or PUSCH) in an uplink BWP according to a configured numerology (e.g., subcarrier spacing and cyclic prefix length for the uplink BWP).

One or more BWP indicator fields may be provided in Downlink Control Information (DCI). A value of a BWP indicator field may indicate which BWP in a set of configured BWPs is an active downlink BWP for one or more downlink receptions. The value of the one or more BWP indicator fields may indicate an active uplink BWP for one or more uplink transmissions.

A base station may semi-statically configure a UE with a default downlink BWP within a set of configured downlink BWPs associated with a PCell. If the base station does not provide the default downlink BWP to the UE, the default downlink BWP may be an initial active downlink BWP. The UE may determine which BWP is the initial active downlink BWP based on a CORESET configuration obtained using the PBCH.

A base station may configure a UE with a BWP inactivity timer value for a PCell. The UE may start or restart a BWP inactivity timer at any appropriate time. For example, the UE may start or restart the BWP inactivity timer (a) when the UE detects a DCI indicating an active downlink BWP other than a default downlink BWP for a paired spectra operation; or (b) when a UE detects a DCI indicating an active downlink BWP or active uplink BWP other than a default downlink BWP or uplink BWP for an unpaired spectra operation. If the UE does not detect DCI during an interval of time (e.g., 1 ms or 0.5 ms), the UE may run the BWP inactivity timer toward expiration (for example, increment from zero to the BWP inactivity timer value, or decrement from the BWP inactivity timer value to zero). When the BWP inactivity timer expires, the UE may switch from the active downlink BWP to the default downlink BWP.

In an example, a base station may semi-statically configure a UE with one or more BWPs. A UE may switch an active BWP from a first BWP to a second BWP in response to receiving a DCI indicating the second BWP as an active BWP and/or in response to an expiry of the BWP inactivity timer (e.g., if the second BWP is the default BWP).

Downlink and uplink BWP switching (where BWP switching refers to switching from a currently active BWP to a not currently active BWP) may be performed independently in paired spectra. In unpaired spectra, downlink and uplink BWP switching may be performed simultaneously. Switching between configured BWPs may occur based on RRC signaling, DCI, expiration of a BWP inactivity timer, and/or an initiation of random access.

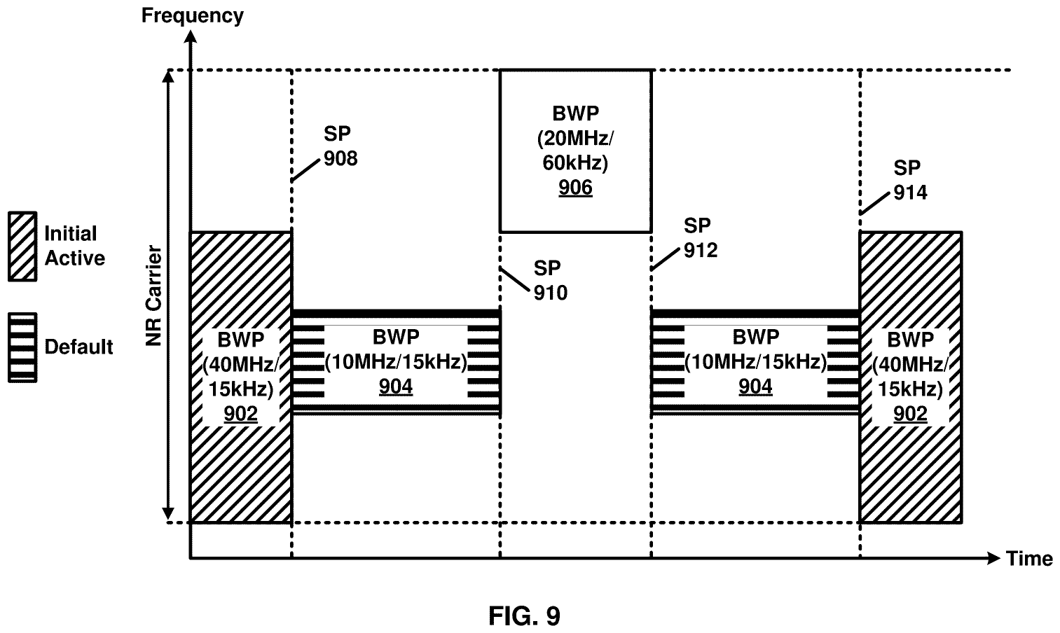

FIG. 9 illustrates an example of bandwidth adaptation using three configured BWPs for an NR carrier. A UE configured with the three BWPs may switch from one BWP to another BWP at a switching point. In the example illustrated in FIG. 9, the BWPs include: a BWP 902 with a bandwidth of 40 MHz and a subcarrier spacing of 15 kHz; a BWP 904 with a bandwidth of 10 MHz and a subcarrier spacing of 15 kHz; and a BWP 906 with a bandwidth of 20 MHz and a subcarrier spacing of 60 kHz. The BWP 902 may be an initial active BWP, and the BWP 904 may be a default BWP. The UE may switch between BWPs at switching points. In the example of FIG. 9, the UE may switch from the BWP 902 to the BWP 904 at a switching point 908. The switching at the switching point 908 may occur for any suitable reason, for example, in response to an expiry of a BWP inactivity timer (indicating switching to the default BWP) and/or in response to receiving a DCI indicating BWP 904 as the active BWP. The UE may switch at a switching point 910 from active BWP 904 to BWP 906 in response to receiving a DCI indicating BWP 906 as the active BWP. The UE may switch at a switching point 912 from active BWP 906 to BWP 904 in response to an expiry of a BWP inactivity timer and/or in response to receiving a DCI indicating BWP 904 as the active BWP. The UE may switch at a switching point 914 from active BWP 904 to BWP 902 in response to receiving a DCI indicating BWP 902 as the active BWP.

If a UE is configured for a secondary cell with a default downlink BWP in a set of configured downlink BWPs and a timer value, UE procedures for switching BWPs on a secondary cell may be the same/similar as those on a primary cell. For example, the UE may use the timer value and the default downlink BWP for the secondary cell in the same/similar manner as the UE would use these values for a primary cell.

To provide for greater data rates, two or more carriers can be aggregated and simultaneously transmitted to/from the same UE using carrier aggregation (CA). The aggregated carriers in CA may be referred to as component carriers (CCs). When CA is used, there are a number of serving cells for the UE, one for a CC. The CCs may have three configurations in the frequency domain.

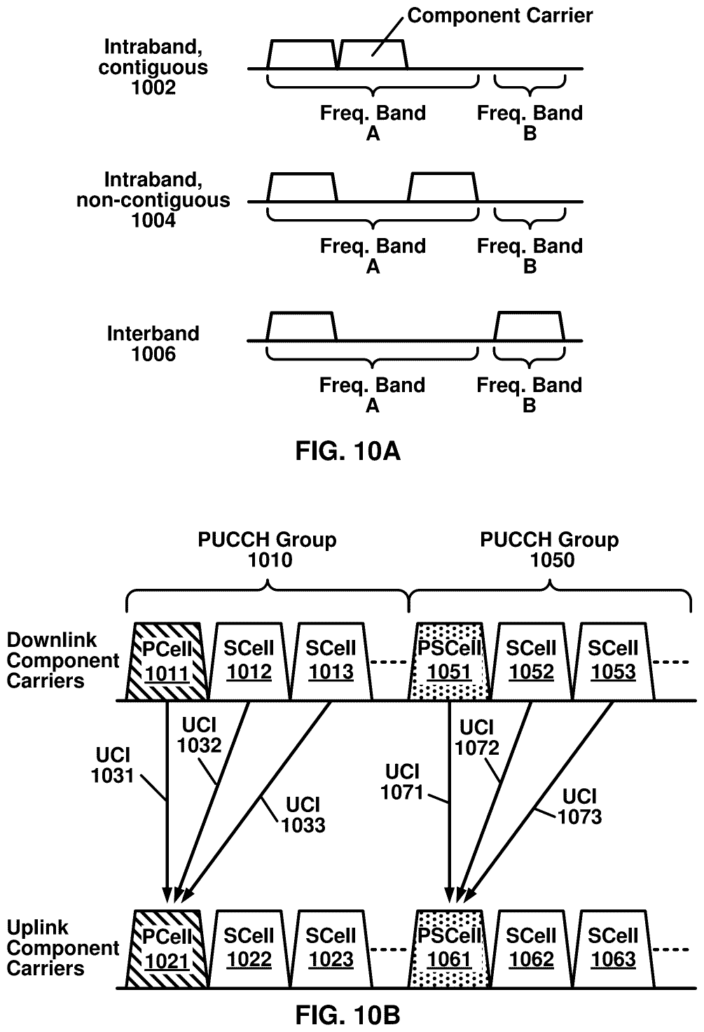

FIG. 10A illustrates the three CA configurations with two CCs. In the intraband, contiguous configuration 1002, the two CCs are aggregated in the same frequency band (frequency band A) and are located directly adjacent to each other within the frequency band. In the intraband, non-contiguous configuration 1004, the two CCs are aggregated in the same frequency band (frequency band A) and are separated in the frequency band by a gap. In the interband configuration 1006, the two CCs are located in frequency bands (frequency band A and frequency band B).

In an example, up to 32 CCs may be aggregated. The aggregated CCs may have the same or different bandwidths, subcarrier spacing, and/or duplexing schemes (TDD or FDD). A serving cell for a UE using CA may have a downlink CC. For FDD, one or more uplink CCs may be optionally configured for a serving cell. The ability to aggregate more downlink carriers than uplink carriers may be useful, for example, when the UE has more data traffic in the downlink than in the uplink.

When CA is used, one of the aggregated cells for a UE may be referred to as a primary cell (PCell). The PCell may be the serving cell that the UE initially connects to at RRC connection establishment, reestablishment, and/or handover. The PCell may provide the UE with NAS mobility information and the security input. UEs may have different PCells. In the downlink, the carrier corresponding to the PCell may be referred to as the downlink primary CC (DL PCC). In the uplink, the carrier corresponding to the PCell may be referred to as the uplink primary CC (UL PCC). The other aggregated cells for the UE may be referred to as secondary cells (SCells). In an example, the SCells may be configured after the PCell is configured for the UE. For example, an SCell may be configured through an RRC Connection Reconfiguration procedure. In the downlink, the carrier corresponding to an SCell may be referred to as a downlink secondary CC (DL SCC). In the uplink, the carrier corresponding to the SCell may be referred to as the uplink secondary CC (UL SCC).

Configured SCells for a UE may be activated and deactivated based on, for example, traffic and channel conditions. Deactivation of an SCell may mean that PDCCH and PDSCH reception on the SCell is stopped and PUSCH, SRS, and CQI transmissions on the SCell are stopped. Configured SCells may be activated and deactivated using a MAC CE with respect to FIG. 4B. For example, a MAC CE may use a bitmap (e.g., one bit per SCell) to indicate which SCells (e.g., in a subset of configured SCells) for the UE are activated or deactivated. Configured SCells may be deactivated in response to an expiration of an SCell deactivation timer (e.g., one SCell deactivation timer per SCell).

Downlink control information, such as scheduling assignments and scheduling grants, for a cell may be transmitted on the cell corresponding to the assignments and grants, which is known as self-scheduling. The DCI for the cell may be transmitted on another cell, which is known as cross-carrier scheduling. Uplink control information (e.g., HARQ acknowledgments and channel state feedback, such as CQI, PMI, and/or RI) for aggregated cells may be transmitted on the PUCCH of the PCell. For a larger number of aggregated downlink CCs, the PUCCH of the PCell may become overloaded. Cells may be divided into multiple PUCCH groups.

FIG. 10B illustrates an example of how aggregated cells may be configured into one or more PUCCH groups. A PUCCH group 1010 and a PUCCH group 1050 may include one or more downlink CCs, respectively. In the example of FIG. 10B, the PUCCH group 1010 includes three downlink CCs: a PCell 1011, an SCell 1012, and an SCell 1013. The PUCCH group 1050 includes three downlink CCs in the present example: a PCell 1051, an SCell 1052, and an SCell 1053. One or more uplink CCs may be configured as a PCell 1021, an SCell 1022, and an SCell 1023. One or more other uplink CCs may be configured as a primary SCell (PSCell) 1061, an SCell 1062, and an SCell 1063. Uplink control information (UCI) related to the downlink CCs of the PUCCH group 1010, shown as UCI 1031, UCI 1032, and UCI 1033, may be transmitted in the uplink of the PCell 1021. Uplink control information (UCI) related to the downlink CCs of the PUCCH group 1050, shown as UCI 1071, UCI 1072, and UCI 1073, may be transmitted in the uplink of the PSCell 1061. In an example, if the aggregated cells depicted in FIG. 10B were not divided into the PUCCH group 1010 and the PUCCH group 1050, a single uplink PCell to transmit UCI relating to the downlink CCs, and the PCell may become overloaded. By dividing transmissions of UCI between the PCell 1021 and the PSCell 1061, overloading may be prevented.

A cell, comprising a downlink carrier and optionally an uplink carrier, may be assigned with a physical cell ID and a cell index. The physical cell ID or the cell index may identify a downlink carrier and/or an uplink carrier of the cell, for example, depending on the context in which the physical cell ID is used. A physical cell ID may be determined using a synchronization signal transmitted on a downlink component carrier. A cell index may be determined using RRC messages. In the disclosure, a physical cell ID may be referred to as a carrier ID, and a cell index may be referred to as a carrier index. For example, when the disclosure refers to a first physical cell ID for a first downlink carrier, the disclosure may mean the first physical cell ID is for a cell comprising the first downlink carrier. The same/similar concept may apply to, for example, a carrier activation. When the disclosure indicates that a first carrier is activated, the specification may mean that a cell comprising the first carrier is activated.

In CA, a multi-carrier nature of a PHY may be exposed to a MAC. In an example, a HARQ entity may operate on a serving cell. A transport block may be generated per assignment/grant per serving cell. A transport block and potential HARQ retransmissions of the transport block may be mapped to a serving cell.

In the downlink, a base station may transmit (e.g., unicast, multicast, and/or broadcast) one or more Reference Signals (RSs) to a UE (e.g., PSS, SSS, CSI-RS, DMRS, and/or PT-RS, as shown in FIG. 5A). In the uplink, the UE may transmit one or more RSs to the base station (e.g., DMRS, PT-RS, and/or SRS, as shown in FIG. 5B). The PSS and the SSS may be transmitted by the base station and used by the UE to synchronize the UE to the base station. The PSS and the SSS may be provided in a synchronization signal (SS)/physical broadcast channel (PBCH) block that includes the PSS, the SSS, and the PBCH. The base station may periodically transmit a burst of SS/PBCH blocks.

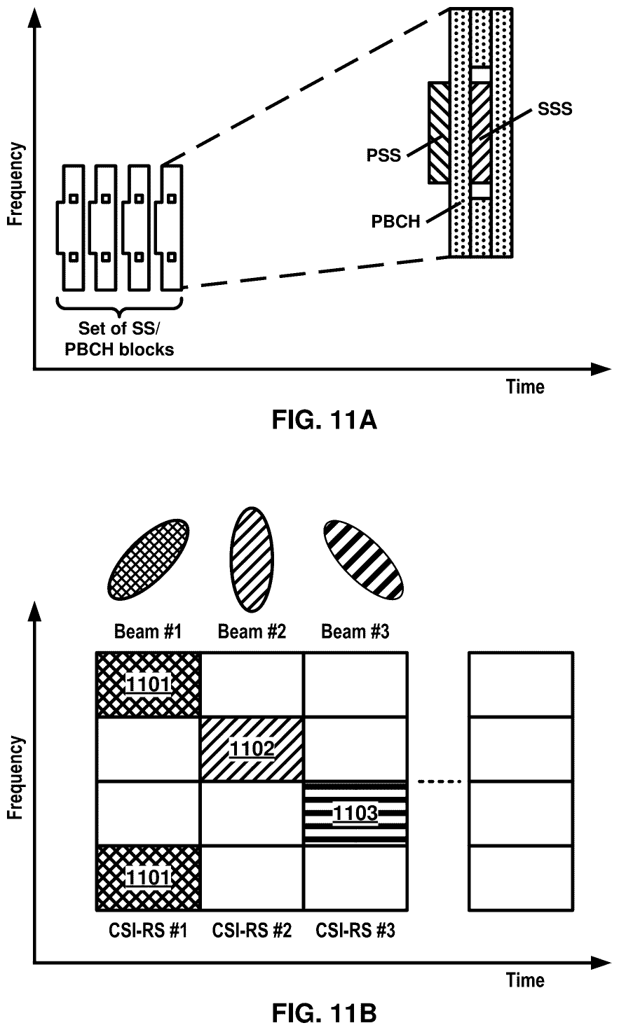

FIG. 11A illustrates an example of an SS/PBCH block's structure and location. A burst of SS/PBCH blocks may include one or more SS/PBCH blocks (e.g., 4 SS/PBCH blocks, as shown in FIG. 11A). Bursts may be transmitted periodically (e.g., every 2 frames or 20 ms). A burst may be restricted to a half-frame (e.g., a first half-frame having a duration of 5 ms). It will be understood that FIG. 11A is an example, and that these parameters (number of SS/PBCH blocks per burst, periodicity of bursts, position of burst within the frame) may be configured based on, for example: a carrier frequency of a cell in which the SS/PBCH block is transmitted; a numerology or subcarrier spacing of the cell; a configuration by the network (e.g., using RRC signaling); or any other suitable factor. In an example, the UE may assume a subcarrier spacing for the SS/PBCH block based on the carrier frequency being monitored, unless the radio network configured the UE to assume a different subcarrier spacing.

The SS/PBCH block may span one or more OFDM symbols in the time domain (e.g., 4 OFDM symbols, as shown in the example of FIG. 11A) and may span one or more subcarriers in the frequency domain (e.g., 240 contiguous subcarriers). The PSS, the SSS, and the PBCH may have a common center frequency. The PSS may be transmitted first and may span, for example, 1 OFDM symbol and 127 subcarriers. The SSS may be transmitted after the PSS (e.g., two symbols later) and may span 1 OFDM symbol and 127 subcarriers. The PBCH may be transmitted after the PSS (e.g., across the next 3 OFDM symbols) and may span 240 subcarriers.

The location of the SS/PBCH block in the time and frequency domains may not be known to the UE (e.g., if the UE is searching for the cell). To find and select the cell, the UE may monitor a carrier for the PSS. For example, the UE may monitor a frequency location within the carrier. If the PSS is not found after a certain duration (e.g., 20 ms), the UE may search for the PSS at a different frequency location within the carrier, as indicated by a synchronization raster. If the PSS is found at a location in the time and frequency domains, the UE may determine, based on a known structure of the SS/PBCH block, the locations of the SSS and the PBCH, respectively. The SS/PBCH block may be a cell-defining SS block (CD-SSB). In an example, a primary cell may be associated with a CD-SSB. The CD-SSB may be located on a synchronization raster. In an example, a cell selection/search and/or reselection may be based on the CD-SSB.

The SS/PBCH block may be used by the UE to determine one or more parameters of the cell. For example, the UE may determine a physical cell identifier (PCI) of the cell based on the sequences of the PSS and the SSS, respectively. The UE may determine a location of a frame boundary of the cell based on the location of the SS/PBCH block. For example, the SS/PBCH block may indicate that it has been transmitted in accordance with a transmission pattern, wherein a SS/PBCH block in the transmission pattern is a known distance from the frame boundary.

The PBCH may use a QPSK modulation and may use forward error correction (FEC). The FEC may use polar coding. One or more symbols spanned by the PBCH may carry one or more DMRSs for demodulation of the PBCH. The PBCH may include an indication of a current system frame number (SFN) of the cell and/or a SS/PBCH block timing index. These parameters may facilitate time synchronization of the UE to the base station. The PBCH may include a master information block (MIB) used to provide the UE with one or more parameters. The MIB may be used by the UE to locate remaining minimum system information (RMSI) associated with the cell. The RMSI may include a System Information Block Type 1 (SIB1). The SIB1 may contain information needed by the UE to access the cell. The UE may use one or more parameters of the MIB to monitor PDCCH, which may be used to schedule PDSCH. The PDSCH may include the SIB1. The SIB1 may be decoded using parameters provided in the MIB. The PBCH may indicate an absence of SIB1. Based on the PBCH indicating the absence of SIB1, the UE may be pointed to a frequency. The UE may search for an SS/PBCH block at the frequency to which the UE is pointed.

The UE may assume that one or more SS/PBCH blocks transmitted with a same SS/PBCH block index are quasi co-located (QCLed) (e.g., having the same/similar Doppler spread, Doppler shift, average gain, average delay, and/or spatial Rx parameters). The UE may not assume QCL for SS/PBCH block transmissions having different SS/PBCH block indices.

SS/PBCH blocks (e.g., those within a half-frame) may be transmitted in spatial directions (e.g., using different beams that span a coverage area of the cell). In an example, a first SS/PBCH block may be transmitted in a first spatial direction using a first beam, and a second SS/PBCH block may be transmitted in a second spatial direction using a second beam.

In an example, within a frequency span of a carrier, a base station may transmit a plurality of SS/PBCH blocks. In an example, a first PCI of a first SS/PBCH block of the plurality of SS/PBCH blocks may be different from a second PCI of a second SS/PBCH block of the plurality of SS/PBCH blocks. The PCIs of SS/PBCH blocks transmitted in different frequency locations may be different or the same.

The CSI-RS may be transmitted by the base station and used by the UE to acquire channel state information (CSI). The base station may configure the UE with one or more CSI-RSs for channel estimation or any other suitable purpose. The base station may configure a UE with one or more of the same/similar CSI-RSs. The UE may measure the one or more CSI-RSs. The UE may estimate a downlink channel state and/or generate a CSI report based on the measuring of the one or more downlink CSI-RSs. The UE may provide the CSI report to the base station. The base station may use feedback provided by the UE (e.g., the estimated downlink channel state) to perform link adaptation.

The base station may semi-statically configure the UE with one or more CSI-RS resource sets. A CSI-RS resource may be associated with a location in the time and frequency domains and a periodicity. The base station may selectively activate and/or deactivate a CSI-RS resource. The base station may indicate to the UE that a CSI-RS resource in the CSI-RS resource set is activated and/or deactivated.

The base station may configure the UE to report CSI measurements. The base station may configure the UE to provide CSI reports periodically, aperiodically, or semi-persistently. For periodic CSI reporting, the UE may be configured with a timing and/or periodicity of a plurality of CSI reports. For aperiodic CSI reporting, the base station may request a CSI report. For example, the base station may command the UE to measure a configured CSI RS resource and provide a CSI report relating to the measurements. For semi-persistent CSI reporting, the base station may configure the UE to transmit periodically, and selectively activate or deactivate the periodic reporting. The base station may configure the UE with a CSI-RS resource set and CSI reports using RRC signaling.

The CSI-RS configuration may comprise one or more parameters indicating, for example, up to 32 antenna ports. The UE may be configured to employ the same OFDM symbols for a downlink CSI-RS and a control resource set (CORESET) when the downlink CSI-RS and CORESET are spatially QCLed and resource elements associated with the downlink CSI-RS are outside of the physical resource blocks (PRBs) configured for the CORESET. The UE may be configured to employ the same OFDM symbols for downlink CSI-RS and SS/PBCH blocks when the downlink CSI-RS and SS/PBCH blocks are spatially QCLed and resource elements associated with the downlink CSI-RS are outside of PRBs configured for the SS/PBCH blocks.

Downlink DMRSs may be transmitted by a base station and used by a UE for channel estimation. For example, the downlink DMRS may be used for coherent demodulation of one or more downlink physical channels (e.g., PDSCH). An NR network may support one or more variable and/or configurable DMRS patterns for data demodulation. At least one downlink DMRS configuration may support a front-loaded DMRS pattern. A front-loaded DMRS may be mapped over one or more OFDM symbols (e.g., one or two adjacent OFDM symbols). A base station may semi-statically configure the UE with a number (e.g. a maximum number) of front-loaded DMRS symbols for PDSCH. A DMRS configuration may support one or more DMRS ports. For example, for single user-MIMO, a DMRS configuration may support up to eight orthogonal downlink DMRS ports per UE. For multiuser-MIMO, a DMRS configuration may support up to 4 orthogonal downlink DMRS ports per UE. A radio network may support (e.g., at least for CP-OFDM) a common DMRS structure for downlink and uplink, wherein a DMRS location, a DMRS pattern, and/or a scrambling sequence may be the same or different. The base station may transmit a downlink DMRS and a corresponding PDSCH using the same precoding matrix. The UE may use the one or more downlink DMRSs for coherent demodulation/channel estimation of the PDSCH.

In an example, a transmitter (e.g., a base station) may use a precoder matrices for a part of a transmission bandwidth. For example, the transmitter may use a first precoder matrix for a first bandwidth and a second precoder matrix for a second bandwidth. The first precoder matrix and the second precoder matrix may be different based on the first bandwidth being different from the second bandwidth. The UE may assume that a same precoding matrix is used across a set of PRBs. The set of PRBs may be denoted as a precoding resource block group (PRG).

A PDSCH may comprise one or more layers. The UE may assume that at least one symbol with DMRS is present on a layer of the one or more layers of the PDSCH. A higher layer may configure up to 3 DMRSs for the PDSCH.

Downlink PT-RS may be transmitted by a base station and used by a UE for phase-noise compensation. Whether a downlink PT-RS is present or not may depend on an RRC configuration. The presence and/or pattern of the downlink PT-RS may be configured on a UE-specific basis using a combination of RRC signaling and/or an association with one or more parameters employed for other purposes (e.g., modulation and coding scheme (MCS)), which may be indicated by DCI. When configured, a dynamic presence of a downlink PT-RS may be associated with one or more DCI parameters comprising at least MCS. An NR network may support a plurality of PT-RS densities defined in the time and/or frequency domains. When present, a frequency domain density may be associated with at least one configuration of a scheduled bandwidth. The UE may assume a same precoding for a DMRS port and a PT-RS port. A number of PT-RS ports may be fewer than a number of DMRS ports in a scheduled resource. Downlink PT-RS may be confined in the scheduled time/frequency duration for the UE. Downlink PT-RS may be transmitted on symbols to facilitate phase tracking at the receiver.

The UE may transmit an uplink DMRS to a base station for channel estimation. For example, the base station may use the uplink DMRS for coherent demodulation of one or more uplink physical channels. For example, the UE may transmit an uplink DMRS with a PUSCH and/or a PUCCH. The uplink DM-RS may span a range of frequencies that is similar to a range of frequencies associated with the corresponding physical channel. The base station may configure the UE with one or more uplink DMRS configurations. At least one DMRS configuration may support a front-loaded DMRS pattern. The front-loaded DMRS may be mapped over one or more OFDM symbols (e.g., one or two adjacent OFDM symbols). One or more uplink DMRSs may be configured to transmit at one or more symbols of a PUSCH and/or a PUCCH. The base station may semi-statically configure the UE with a number (e.g. maximum number) of front-loaded DMRS symbols for the PUSCH and/or the PUCCH, which the UE may use to schedule a single-symbol DMRS and/or a double-symbol DMRS. An NR network may support (e.g., for cyclic prefix orthogonal frequency division multiplexing (CP-OFDM)) a common DMRS structure for downlink and uplink, wherein a DMRS location, a DMRS pattern, and/or a scrambling sequence for the DMRS may be the same or different.

A PUSCH may comprise one or more layers, and the UE may transmit at least one symbol with DMRS present on a layer of the one or more layers of the PUSCH. In an example, a higher layer may configure up to three DMRSs for the PUSCH.

Uplink PT-RS (which may be used by a base station for phase tracking and/or phase-noise compensation) may or may not be present depending on an RRC configuration of the UE. The presence and/or pattern of uplink PT-RS may be configured on a UE-specific basis by a combination of RRC signaling and/or one or more parameters employed for other purposes (e.g., Modulation and Coding Scheme (MCS)), which may be indicated by DCI. When configured, a dynamic presence of uplink PT-RS may be associated with one or more DCI parameters comprising at least MCS. A radio network may support a plurality of uplink PT-RS densities defined in time/frequency domain. When present, a frequency domain density may be associated with at least one configuration of a scheduled bandwidth. The UE may assume a same precoding for a DMRS port and a PT-RS port. A number of PT-RS ports may be fewer than a number of DMRS ports in a scheduled resource. For example, uplink PT-RS may be confined in the scheduled time/frequency duration for the UE.

SRS may be transmitted by a UE to a base station for channel state estimation to support uplink channel dependent scheduling and/or link adaptation. SRS transmitted by the UE may allow a base station to estimate an uplink channel state at one or more frequencies. A scheduler at the base station may employ the estimated uplink channel state to assign one or more resource blocks for an uplink PUSCH transmission from the UE. The base station may semi-statically configure the UE with one or more SRS resource sets. For an SRS resource set, the base station may configure the UE with one or more SRS resources. An SRS resource set applicability may be configured by a higher layer (e.g., RRC) parameter. For example, when a higher layer parameter indicates beam management, an SRS resource in an SRS resource set of the one or more SRS resource sets (e.g., with the same/similar time domain behavior, periodic, aperiodic, and/or the like) may be transmitted at a time instant (e.g., simultaneously). The UE may transmit one or more SRS resources in SRS resource sets. An NR network may support aperiodic, periodic and/or semi-persistent SRS transmissions. The UE may transmit SRS resources based on one or more trigger types, wherein the one or more trigger types may comprise higher layer signaling (e.g., RRC) and/or one or more DCI formats. In an example, at least one DCI format may be employed for the UE to select at least one of one or more configured SRS resource sets. An SRS trigger type 0 may refer to an SRS triggered based on a higher layer signaling. An SRS trigger type 1 may refer to an SRS triggered based on one or more DCI formats. In an example, when PUSCH and SRS are transmitted in a same slot, the UE may be configured to transmit SRS after a transmission of a PUSCH and a corresponding uplink DMRS.

The base station may semi-statically configure the UE with one or more SRS configuration parameters indicating at least one of following: a SRS resource configuration identifier; a number of SRS ports; time domain behavior of an SRS resource configuration (e.g., an indication of periodic, semi-persistent, or aperiodic SRS); slot, mini-slot, and/or subframe level periodicity; offset for a periodic and/or an aperiodic SRS resource; a number of OFDM symbols in an SRS resource; a starting OFDM symbol of an SRS resource; an SRS bandwidth; a frequency hopping bandwidth; a cyclic shift; and/or an SRS sequence ID.

An antenna port is defined such that the channel over which a symbol on the antenna port is conveyed can be inferred from the channel over which another symbol on the same antenna port is conveyed. If a first symbol and a second symbol are transmitted on the same antenna port, the receiver may infer the channel (e.g., fading gain, multipath delay, and/or the like) for conveying the second symbol on the antenna port, from the channel for conveying the first symbol on the antenna port. A first antenna port and a second antenna port may be referred to as quasi co-located (QCLed) if one or more large-scale properties of the channel over which a first symbol on the first antenna port is conveyed may be inferred from the channel over which a second symbol on a second antenna port is conveyed. The one or more large-scale properties may comprise at least one of: a delay spread; a Doppler spread; a Doppler shift; an average gain; an average delay; and/or spatial Receiving (Rx) parameters.

Channels that use beamforming require beam management. Beam management may comprise beam measurement, beam selection, and beam indication. A beam may be associated with one or more reference signals. For example, a beam may be identified by one or more beamformed reference signals. The UE may perform downlink beam measurement based on downlink reference signals (e.g., a channel state information reference signal (CSI-RS)) and generate a beam measurement report. The UE may perform the downlink beam measurement procedure after an RRC connection is set up with a base station.

FIG. 11B illustrates an example of channel state information reference signals (CSI-RSs) that are mapped in the time and frequency domains. A square shown in FIG. 11B may span a resource block (RB) within a bandwidth of a cell. A base station may transmit one or more RRC messages comprising CSI-RS resource configuration parameters indicating one or more CSI-RSs. One or more of the following parameters may be configured by higher layer signaling (e.g., RRC and/or MAC signaling) for a CSI-RS resource configuration: a CSI-RS resource configuration identity, a number of CSI-RS ports, a CSI-RS configuration (e.g., symbol and resource element (RE) locations in a subframe), a CSI-RS subframe configuration (e.g., subframe location, offset, and periodicity in a radio frame), a CSI-RS power parameter, a CSI-RS sequence parameter, a code division multiplexing (CDM) type parameter, a frequency density, a transmission comb, quasi co-location (QCL) parameters (e.g., QCL-scramblingidentity, crs-portscount, mbsfn-subframeconfiglist, csi-rs-configZPid, qcl-csi-rs-configNZPid), and/or other radio resource parameters.

The three beams illustrated in FIG. 11B may be configured for a UE in a UE-specific configuration. Three beams are illustrated in FIG. 11B (beam #1, beam #2, and beam #3), more or fewer beams may be configured. Beam #1 may be allocated with CSI-RS 1101 that may be transmitted in one or more subcarriers in an RB of a first symbol. Beam #2 may be allocated with CSI-RS 1102 that may be transmitted in one or more subcarriers in an RB of a second symbol. Beam #3 may be allocated with CSI-RS 1103 that may be transmitted in one or more subcarriers in an RB of a third symbol. By using frequency division multiplexing (FDM), a base station may use other subcarriers in a same RB (for example, those that are not used to transmit CSI-RS 1101) to transmit another CSI-RS associated with a beam for another UE. By using time domain multiplexing (TDM), beams used for the UE may be configured such that beams for the UE use symbols from beams of other UEs.

CSI-RSs such as those illustrated in FIG. 11B (e.g., CSI-RS 1101, 1102, 1103) may be transmitted by the base station and used by the UE for one or more measurements. For example, the UE may measure a reference signal received power (RSRP) of configured CSI-RS resources. The base station may configure the UE with a reporting configuration and the UE may report the RSRP measurements to a network (for example, via one or more base stations) based on the reporting configuration. In an example, the base station may determine, based on the reported measurement results, one or more transmission configuration indication (TCI) states comprising a number of reference signals. In an example, the base station may indicate one or more TCI states to the UE (e.g., via RRC signaling, a MAC CE, and/or a DCI). The UE may receive a downlink transmission with a receive (Rx) beam determined based on the one or more TCI states. In an example, the UE may or may not have a capability of beam correspondence. If the UE has the capability of beam correspondence, the UE may determine a spatial domain filter of a transmit (Tx) beam based on a spatial domain filter of the corresponding Rx beam. If the UE does not have the capability of beam correspondence, the UE may perform an uplink beam selection procedure to determine the spatial domain filter of the Tx beam. The UE may perform the uplink beam selection procedure based on one or more sounding reference signal (SRS) resources configured to the UE by the base station. The base station may select and indicate uplink beams for the UE based on measurements of the one or more SRS resources transmitted by the UE.

In a beam management procedure, a UE may assess (e.g., measure) a channel quality of one or more beam pair links, a beam pair link comprising a transmitting beam transmitted by a base station and a receiving beam received by the UE. Based on the assessment, the UE may transmit a beam measurement report indicating one or more beam pair quality parameters comprising, e.g., one or more beam identifications (e.g., a beam index, a reference signal index, or the like), RSRP, a precoding matrix indicator (PMI), a channel quality indicator (CQI), and/or a rank indicator (RI).

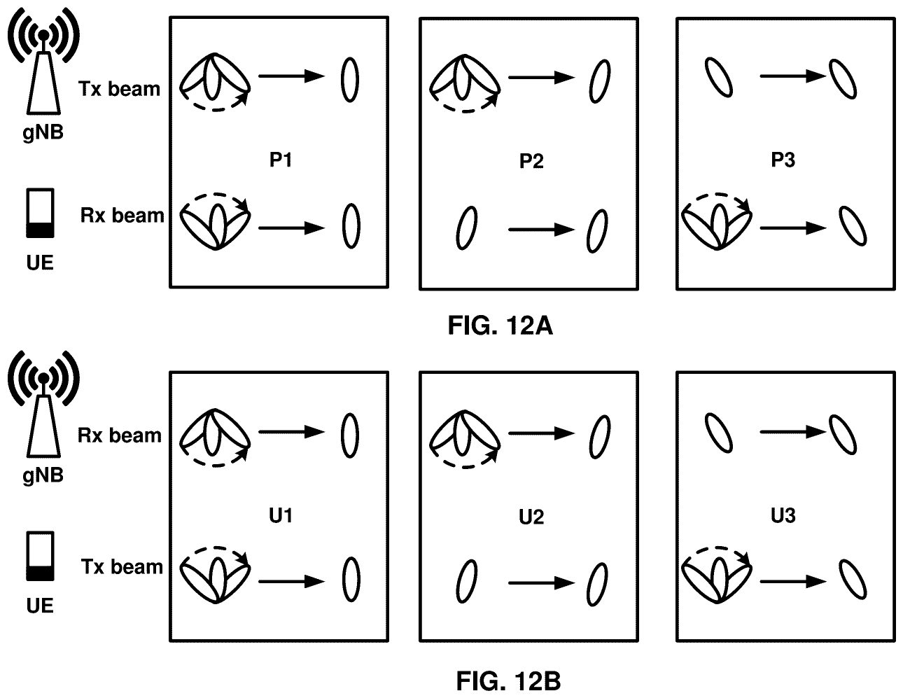

FIG. 12A illustrates examples of three downlink beam management procedures: P1, P2, and P3. Procedure P1 may enable a UE measurement on transmit (Tx) beams of a transmission reception point (TRP) (or multiple TRPs), e.g., to support a selection of one or more base station Tx beams and/or UE Rx beams (shown as ovals in the top row and bottom row, respectively, of P1). Beamforming at a TRP may comprise a Tx beam sweep for a set of beams (shown, in the top rows of P1 and P2, as ovals rotated in a counterclockwise direction indicated by the dashed arrow). Beamforming at a UE may comprise an Rx beam sweep for a set of beams (shown, in the bottom rows of P1 and P3, as ovals rotated in a clockwise direction indicated by the dashed arrow). Procedure P2 may be used to enable a UE measurement on Tx beams of a TRP (shown, in the top row of P2, as ovals rotated in a counterclockwise direction indicated by the dashed arrow). The UE and/or the base station may perform procedure P2 using a smaller set of beams than is used in procedure P1, or using narrower beams than the beams used in procedure P1. This may be referred to as beam refinement. The UE may perform procedure P3 for Rx beam determination by using the same Tx beam at the base station and sweeping an Rx beam at the UE.

FIG. 12B illustrates examples of three uplink beam management procedures: U1, U2, and U3. Procedure U1 may be used to enable a base station to perform a measurement on Tx beams of a UE, e.g., to support a selection of one or more UE Tx beams and/or base station Rx beams (shown as ovals in the top row and bottom row, respectively, of U1). Beamforming at the UE may include, e.g., a Tx beam sweep from a set of beams (shown in the bottom rows of U1 and U3 as ovals rotated in a clockwise direction indicated by the dashed arrow). Beamforming at the base station may include, e.g., an Rx beam sweep from a set of beams (shown, in the top rows of U1 and U2, as ovals rotated in a counterclockwise direction indicated by the dashed arrow). Procedure U2 may be used to enable the base station to adjust its Rx beam when the UE uses a fixed Tx beam. The UE and/or the base station may perform procedure U2 using a smaller set of beams than is used in procedure P1, or using narrower beams than the beams used in procedure P1. This may be referred to as beam refinement The UE may perform procedure U3 to adjust its Tx beam when the base station uses a fixed Rx beam.

A UE may initiate a beam failure recovery (BFR) procedure based on detecting a beam failure. The UE may transmit a BFR request (e.g., a preamble, a UCI, an SR, a MAC CE, and/or the like) based on the initiating of the BFR procedure. The UE may detect the beam failure based on a determination that a quality of beam pair link(s) of an associated control channel is unsatisfactory (e.g., having an error rate higher than an error rate threshold, a received signal power lower than a received signal power threshold, an expiration of a timer, and/or the like).

The UE may measure a quality of a beam pair link using one or more reference signals (RSs) comprising one or more SS/PBCH blocks, one or more CSI-RS resources, and/or one or more demodulation reference signals (DMRSs). A quality of the beam pair link may be based on one or more of a block error rate (BLER), an RSRP value, a signal to interference plus noise ratio (SINR) value, a reference signal received quality (RSRQ) value, and/or a CSI value measured on RS resources. The base station may indicate that an RS resource is quasi co-located (QCLed) with one or more DM-RSs of a channel (e.g., a control channel, a shared data channel, and/or the like). The RS resource and the one or more DMRSs of the channel may be QCLed when the channel characteristics (e.g., Doppler shift, Doppler spread, average delay, delay spread, spatial Rx parameter, fading, and/or the like) from a transmission via the RS resource to the UE are similar or the same as the channel characteristics from a transmission via the channel to the UE.

A network (e.g., a gNB and/or an ng-eNB of a network) and/or the UE may initiate a random access procedure. A UE in an RRC_IDLE state and/or an RRC_INACTIVE state may initiate the random access procedure to request a connection setup to a network. The UE may initiate the random access procedure from an RRC_CONNECTED state. The UE may initiate the random access procedure to request uplink resources (e.g., for uplink transmission of an SR when there is no PUCCH resource available) and/or acquire uplink timing (e.g., when uplink synchronization status is non-synchronized). The UE may initiate the random access procedure to request one or more system information blocks (SIBs) (e.g., other system information such as SIB2, SIB3, and/or the like). The UE may initiate the random access procedure for a beam failure recovery request. A network may initiate a random access procedure for a handover and/or for establishing time alignment for an SCell addition.

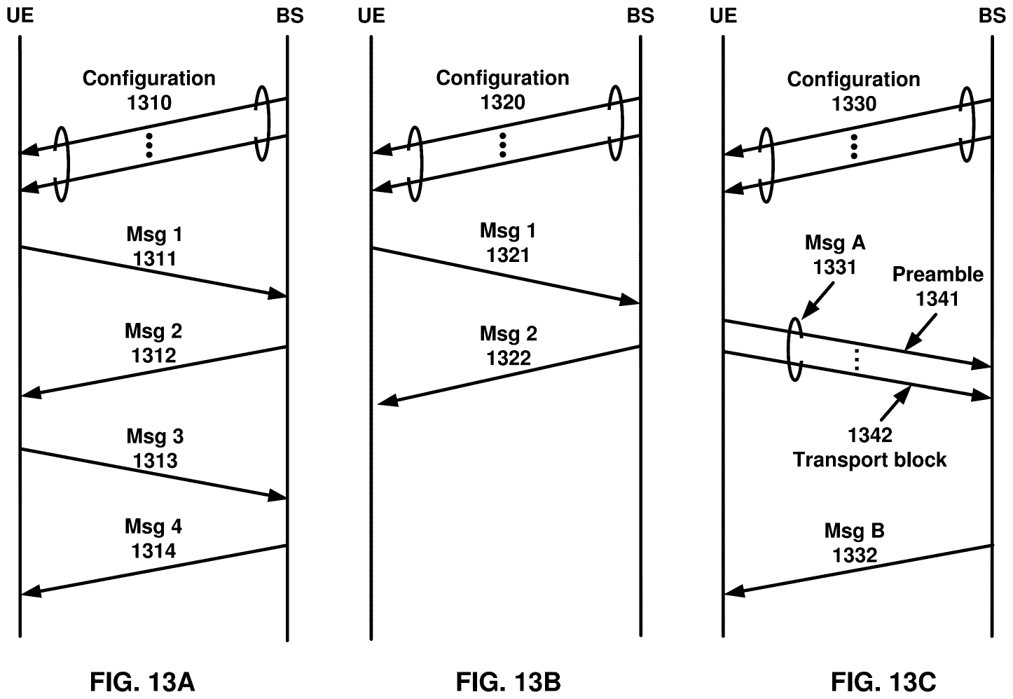

FIG. 13A illustrates a four-step contention-based random access procedure. Prior to initiation of the procedure, a base station may transmit a configuration message 1310 to the UE. The procedure illustrated in FIG. 13A comprises transmission of four messages: a Msg 1 1311, a Msg 2 1312, a Msg 3 1313, and a Msg 4 1314. The Msg 1 1311 may include and/or be referred to as a preamble (or a random access preamble). The Msg 2 1312 may include and/or be referred to as a random access response (RAR).

The configuration message 1310 may be transmitted, for example, using one or more RRC messages. The one or more RRC messages may indicate one or more random access channel (RACH) parameters to the UE. The one or more RACH parameters may comprise at least one of following: general parameters for one or more random access procedures (e.g., RACH-configGeneral); cell-specific parameters (e.g., RACH-ConfigCommon); and/or dedicated parameters (e.g., RACH-configDedicated). The base station may broadcast or multicast the one or more RRC messages to one or more UEs. The one or more RRC messages may be UE-specific (e.g., dedicated RRC messages transmitted to a UE in an RRC_CONNECTED state and/or in an RRC_INACTIVE state). The UE may determine, based on the one or more RACH parameters, a time-frequency resource and/or an uplink transmit power for transmission of the Msg 1 1311 and/or the Msg 3 1313. Based on the one or more RACH parameters, the UE may determine a reception timing and a downlink channel for receiving the Msg 2 1312 and the Msg 4 1314.

The one or more RACH parameters provided in the configuration message 1310 may indicate one or more Physical RACH (PRACH) occasions available for transmission of the Msg 1 1311. The one or more PRACH occasions may be predefined. The one or more RACH parameters may indicate one or more available sets of one or more PRACH occasions (e.g., prach-Configlndex). The one or more RACH parameters may indicate an association between (a) one or more PRACH occasions and (b) one or more reference signals. The one or more RACH parameters may indicate an association between (a) one or more preambles and (b) one or more reference signals. The one or more reference signals may be SS/PBCH blocks and/or CSI-RSs. For example, the one or more RACH parameters may indicate a number of SS/PBCH blocks mapped to a PRACH occasion and/or a number of preambles mapped to a SS/PBCH blocks.

The one or more RACH parameters provided in the configuration message 1310 may be used to determine an uplink transmit power of Msg 1 1311 and/or Msg 3 1313. For example, the one or more RACH parameters may indicate a reference power for a preamble transmission (e.g., a received target power and/or an initial power of the preamble transmission). There may be one or more power offsets indicated by the one or more RACH parameters. For example, the one or more RACH parameters may indicate: a power ramping step; a power offset between SSB and CSI-RS; a power offset between transmissions of the Msg 1 1311 and the Msg 3 1313; and/or a power offset value between preamble groups. The one or more RACH parameters may indicate one or more thresholds based on which the UE may determine at least one reference signal (e.g., an SSB and/or CSI-RS) and/or an uplink carrier (e.g., a normal uplink (NUL) carrier and/or a supplemental uplink (SUL) carrier).

The Msg 1 1311 may include one or more preamble transmissions (e.g., a preamble transmission and one or more preamble retransmissions). An RRC message may be used to configure one or more preamble groups (e.g., group A and/or group B). A preamble group may comprise one or more preambles. The UE may determine the preamble group based on a pathloss measurement and/or a size of the Msg 3 1313. The UE may measure an RSRP of one or more reference signals (e.g., SSBs and/or CSI-RSs) and determine at least one reference signal having an RSRP above an RSRP threshold (e.g., rsrp-ThresholdSSB and/or rsrp-ThresholdCSI-RS). The UE may select at least one preamble associated with the one or more reference signals and/or a selected preamble group, for example, if the association between the one or more preambles and the at least one reference signal is configured by an RRC message.

The UE may determine the preamble based on the one or more RACH parameters provided in the configuration message 1310. For example, the UE may determine the preamble based on a pathloss measurement, an RSRP measurement, and/or a size of the Msg 3 1313. As another example, the one or more RACH parameters may indicate: a preamble format; a maximum number of preamble transmissions; and/or one or more thresholds for determining one or more preamble groups (e.g., group A and group B). A base station may use the one or more RACH parameters to configure the UE with an association between one or more preambles and one or more reference signals (e.g., SSBs and/or CSI-RSs). If the association is configured, the UE may determine the preamble to include in Msg 1 1311 based on the association. The Msg 1 1311 may be transmitted to the base station via one or more PRACH occasions. The UE may use one or more reference signals (e.g., SSBs and/or CSI-RSs) for selection of the preamble and for determining of the PRACH occasion. One or more RACH parameters (e.g., ra-ssb-OccasionMskIndex and/or ra-OccasionList) may indicate an association between the PRACH occasions and the one or more reference signals.

The UE may perform a preamble retransmission if no response is received following a preamble transmission. The UE may increase an uplink transmit power for the preamble retransmission. The UE may select an initial preamble transmit power based on a pathloss measurement and/or a target received preamble power configured by the network. The UE may determine to retransmit a preamble and may ramp up the uplink transmit power. The UE may receive one or more RACH parameters (e.g., PREAMBLE_POWER_RAMPING_STEP) indicating a ramping step for the preamble retransmission. The ramping step may be an amount of incremental increase in uplink transmit power for a retransmission. The UE may ramp up the uplink transmit power if the UE determines a reference signal (e.g., SSB and/or CSI-RS) that is the same as a previous preamble transmission. The UE may count a number of preamble transmissions and/or retransmissions (e.g., PREAMBLE_TRANSMISSION_COUNTER). The UE may determine that a random access procedure completed unsuccessfully, for example, if the number of preamble transmissions exceeds a threshold configured by the one or more RACH parameters (e.g., preambleTransMax).

The Msg 2 1312 received by the UE may include an RAR. In some scenarios, the Msg 2 1312 may include multiple RARs corresponding to multiple UEs. The Msg 2 1312 may be received after or in response to the transmitting of the Msg 1 1311. The Msg 2 1312 may be scheduled on the DL-SCH and indicated on a PDCCH using a random access RNTI (RA-RNTI). The Msg 2 1312 may indicate that the Msg 1 1311 was received by the base station. The Msg 2 1312 may include a time-alignment command that may be used by the UE to adjust the UE's transmission timing, a scheduling grant for transmission of the Msg 3 1313, and/or a Temporary Cell RNTI (TC-RNTI). After transmitting a preamble, the UE may start a time window (e.g., ra-ResponseWindow) to monitor a PDCCH for the Msg 2 1312. The UE may determine when to start the time window based on a PRACH occasion that the UE uses to transmit the preamble. For example, the UE may start the time window one or more symbols after a last symbol of the preamble (e.g., at a first PDCCH occasion from an end of a preamble transmission). The one or more symbols may be determined based on a numerology. The PDCCH may be in a common search space (e.g., a Type1-PDCCH common search space) configured by an RRC message. The UE may identify the RAR based on a Radio Network Temporary Identifier (RNTI). RNTIs may be used depending on one or more events initiating the random access procedure. The UE may use random access RNTI (RA-RNTI). The RA-RNTI may be associated with PRACH occasions in which the UE transmits a preamble. For example, the UE may determine the RA-RNTI based on: an OFDM symbol index; a slot index; a frequency domain index; and/or a UL carrier indicator of the PRACH occasions. An example of RA-RNTI may be as follows:

RA-RNTI=1+s_id+14×t_id+14×80×f_id+14×80×8×ul_carrier_id

where s_id may be an index of a first OFDM symbol of the PRACH occasion (e.g., 0≤s_id<14), t_id may be an index of a first slot of the PRACH occasion in a system frame (e.g., 0≤t_id<80), f_id may be an index of the PRACH occasion in the frequency domain (e.g., 0≤f_id<8), and ul_carrier_id may be a UL carrier used for a preamble transmission (e.g., 0 for an NUL carrier, and 1 for an SUL carrier).
The UE may transmit the Msg 3 1313 in response to a successful reception of the Msg 2 1312 (e.g., using resources identified in the Msg 2 1312). The Msg 3 1313 may be used for contention resolution in, for example, the contention-based random access procedure illustrated in FIG. 13A. In some scenarios, a plurality of UEs may transmit a same preamble to a base station and the base station may provide an RAR that corresponds to a UE. Collisions may occur if the plurality of UEs interpret the RAR as corresponding to themselves. Contention resolution (e.g., using the Msg 3 1313 and the Msg 4 1314) may be used to increase the likelihood that the UE does not incorrectly use an identity of another the UE. To perform contention resolution, the UE may include a device identifier in the Msg 3 1313 (e.g., a C-RNTI if assigned, a TC-RNTI included in the Msg 2 1312, and/or any other suitable identifier).

The Msg 4 1314 may be received after or in response to the transmitting of the Msg 3 1313. If a C-RNTI was included in the Msg 3 1313, the base station will address the UE on the PDCCH using the C-RNTI. If the UE's unique C-RNTI is detected on the PDCCH, the random access procedure is determined to be successfully completed. If a TC-RNTI is included in the Msg 3 1313 (e.g., if the UE is in an RRC_IDLE state or not otherwise connected to the base station), Msg 4 1314 will be received using a DL-SCH associated with the TC-RNTI. If a MAC PDU is successfully decoded and a MAC PDU comprises the UE contention resolution identity MAC CE that matches or otherwise corresponds with the CCCH SDU sent (e.g., transmitted) in Msg 3 1313, the UE may determine that the contention resolution is successful and/or the UE may determine that the random access procedure is successfully completed.

The UE may be configured with a supplementary uplink (SUL) carrier and a normal uplink (NUL) carrier. An initial access (e.g., random access procedure) may be supported in an uplink carrier. For example, a base station may configure the UE with two separate RACH configurations: one for an SUL carrier and the other for an NUL carrier. For random access in a cell configured with an SUL carrier, the network may indicate which carrier to use (NUL or SUL). The UE may determine the SUL carrier, for example, if a measured quality of one or more reference signals is lower than a broadcast threshold. Uplink transmissions of the random access procedure (e.g., the Msg 1 1311 and/or the Msg 3 1313) may remain on the selected carrier. The UE may switch an uplink carrier during the random access procedure (e.g., between the Msg 1 1311 and the Msg 3 1313) in one or more cases. For example, the UE may determine and/or switch an uplink carrier for the Msg 1 1311 and/or the Msg 3 1313 based on a channel clear assessment (e.g., a listen-before-talk).

FIG. 13B illustrates a two-step contention-free random access procedure. Similar to the four-step contention-based random access procedure illustrated in FIG. 13A, a base station may, prior to initiation of the procedure, transmit a configuration message 1320 to the UE. The configuration message 1320 may be analogous in some respects to the configuration message 1310. The procedure illustrated in FIG. 13B comprises transmission of two messages: a Msg 1 1321 and a Msg 2 1322. The Msg 1 1321 and the Msg 2 1322 may be analogous in some respects to the Msg 1 1311 and a Msg 2 1312 illustrated in FIG. 13A, respectively. As will be understood from FIGS. 13A and 13B, the contention-free random access procedure may not include messages analogous to the Msg 31313 and/or the Msg 4 1314.

The contention-free random access procedure illustrated in FIG. 13B may be initiated for a beam failure recovery, other SI request, SCell addition, and/or handover. For example, a base station may indicate or assign to the UE the preamble to be used for the Msg 1 1321. The UE may receive, from the base station via PDCCH and/or RRC, an indication of a preamble (e.g., ra-PreambleIndex).

After transmitting a preamble, the UE may start a time window (e.g., ra-ResponseWindow) to monitor a PDCCH for the RAR. In the event of a beam failure recovery request, the base station may configure the UE with a separate time window and/or a separate PDCCH in a search space indicated by an RRC message (e.g., recoverySearchSpaceId). The UE may monitor for a PDCCH transmission addressed to a Cell RNTI (C-RNTI) on the search space. In the contention-free random access procedure illustrated in FIG. 13B, the UE may determine that a random access procedure successfully completes after or in response to transmission of Msg 1 1321 and reception of a corresponding Msg 2 1322. The UE may determine that a random access procedure successfully completes, for example, if a PDCCH transmission is addressed to a C-RNTI. The UE may determine that a random access procedure successfully completes, for example, if the UE receives an RAR comprising a preamble identifier corresponding to a preamble transmitted by the UE and/or the RAR comprises a MAC sub-PDU with the preamble identifier. The UE may determine the response as an indication of an acknowledgement for an SI request.

FIG. 13C illustrates another two-step random access procedure. Similar to the random access procedures illustrated in FIGS. 13A and 13B, a base station may, prior to initiation of the procedure, transmit a configuration message 1330 to the UE. The configuration message 1330 may be analogous in some respects to the configuration message 1310 and/or the configuration message 1320. The procedure illustrated in FIG. 13C comprises transmission of two messages: a Msg A 1331 and a Msg B 1332.

Msg A 1331 may be transmitted in an uplink transmission by the UE. Msg A 1331 may comprise one or more transmissions of a preamble 1341 and/or one or more transmissions of a transport block 1342. The transport block 1342 may comprise contents that are similar and/or equivalent to the contents of the Msg 3 1313 illustrated in FIG. 13A. The transport block 1342 may comprise UCI (e.g., an SR, a HARQ ACK/NACK, and/or the like). The UE may receive the Msg B 1332 after or in response to transmitting the Msg A 1331. The Msg B 1332 may comprise contents that are similar and/or equivalent to the contents of the Msg 2 1312 (e.g., an RAR) illustrated in FIGS. 13A and 13B and/or the Msg 4 1314 illustrated in FIG. 13A.

The UE may initiate the two-step random access procedure in FIG. 13C for licensed spectrum and/or unlicensed spectrum. The UE may determine, based on one or more factors, whether to initiate the two-step random access procedure. The one or more factors may be: a radio access technology in use (e.g., LTE, NR, and/or the like); whether the UE has valid TA or not; a cell size; the UE's RRC state; a type of spectrum (e.g., licensed vs. unlicensed); and/or any other suitable factors.

The UE may determine, based on two-step RACH parameters included in the configuration message 1330, a radio resource and/or an uplink transmit power for the preamble 1341 and/or the transport block 1342 included in the Msg A 1331. The RACH parameters may indicate a modulation and coding schemes (MCS), a time-frequency resource, and/or a power control for the preamble 1341 and/or the transport block 1342. A time-frequency resource for transmission of the preamble 1341 (e.g., a PRACH) and a time-frequency resource for transmission of the transport block 1342 (e.g., a PUSCH) may be multiplexed using FDM, TDM, and/or CDM. The RACH parameters may enable the UE to determine a reception timing and a downlink channel for monitoring for and/or receiving Msg B 1332.

The transport block 1342 may comprise data (e.g., delay-sensitive data), an identifier of the UE, security information, and/or device information (e.g., an International Mobile Subscriber Identity (IMSI)). The base station may transmit the Msg B 1332 as a response to the Msg A 1331. The Msg B 1332 may comprise at least one of following: a preamble identifier; a timing advance command; a power control command; an uplink grant (e.g., a radio resource assignment and/or an MCS); a UE identifier for contention resolution; and/or an RNTI (e.g., a C-RNTI or a TC-RNTI). The UE may determine that the two-step random access procedure is successfully completed if: a preamble identifier in the Msg B 1332 is matched to a preamble transmitted by the UE; and/or the identifier of the UE in Msg B 1332 is matched to the identifier of the UE in the Msg A 1331 (e.g., the transport block 1342).

A UE and a base station may exchange control signaling. The control signaling may be referred to as L1/L2 control signaling and may originate from the PHY layer (e.g., layer 1) and/or the MAC layer (e.g., layer 2). The control signaling may comprise downlink control signaling transmitted from the base station to the UE and/or uplink control signaling transmitted from the UE to the base station.

The downlink control signaling may comprise: a downlink scheduling assignment; an uplink scheduling grant indicating uplink radio resources and/or a transport format; a slot format information; a preemption indication; a power control command; and/or any other suitable signaling. The UE may receive the downlink control signaling in a payload transmitted by the base station on a physical downlink control channel (PDCCH). The payload transmitted on the PDCCH may be referred to as downlink control information (DCI). In some scenarios, the PDCCH may be a group common PDCCH (GC-PDCCH) that is common to a group of UEs.

A base station may attach one or more cyclic redundancy check (CRC) parity bits to a DCI in order to facilitate detection of transmission errors. When the DCI is intended for a UE (or a group of the UEs), the base station may scramble the CRC parity bits with an identifier of the UE (or an identifier of the group of the UEs). Scrambling the CRC parity bits with the identifier may comprise Modulo-2 addition (or an exclusive OR operation) of the identifier value and the CRC parity bits. The identifier may comprise a 16-bit value of a radio network temporary identifier (RNTI).

DCIs may be used for different purposes. A purpose may be indicated by the type of RNTI used to scramble the CRC parity bits. For example, a DCI having CRC parity bits scrambled with a paging RNTI (P-RNTI) may indicate paging information and/or a system information change notification. The P-RNTI may be predefined as “FFFE” in hexadecimal. A DCI having CRC parity bits scrambled with a system information RNTI (SI-RNTI) may indicate a broadcast transmission of the system information. The SI-RNTI may be predefined as “FFFF” in hexadecimal. A DCI having CRC parity bits scrambled with a random access RNTI (RA-RNTI) may indicate a random access response (RAR). A DCI having CRC parity bits scrambled with a cell RNTI (C-RNTI) may indicate a dynamically scheduled unicast transmission and/or a triggering of PDCCH-ordered random access. A DCI having CRC parity bits scrambled with a temporary cell RNTI (TC-RNTI) may indicate a contention resolution (e.g., a Msg 3 analogous to the Msg 3 1313 illustrated in FIG. 13A). Other RNTIs configured to the UE by a base station may comprise a Configured Scheduling RNTI (CS-RNTI), a Transmit Power Control-PUCCH RNTI (TPC-PUCCH-RNTI), a Transmit Power Control-PUSCH RNTI (TPC-PUSCH-RNTI), a Transmit Power Control-SRS RNTI (TPC-SRS-RNTI), an Interruption RNTI (INT-RNTI), a Slot Format Indication RNTI (SFI-RNTI), a Semi-Persistent CSI RNTI (SP-CSI-RNTI), a Modulation and Coding Scheme Cell RNTI (MCS-C-RNTI), and/or the like.

Depending on the purpose and/or content of a DCI, the base station may transmit the DCIs with one or more DCI formats. For example, DCI format 0_0 may be used for scheduling of PUSCH in a cell. DCI format 0_0 may be a fallback DCI format (e.g., with compact DCI payloads). DCI format 0_1 may be used for scheduling of PUSCH in a cell (e.g., with more DCI payloads than DCI format 0_0). DCI format 1_0 may be used for scheduling of PDSCH in a cell. DCI format 1_0 may be a fallback DCI format (e.g., with compact DCI payloads). DCI format 1_1 may be used for scheduling of PDSCH in a cell (e.g., with more DCI payloads than DCI format 1_0). DCI format 2_0 may be used for providing a slot format indication to a group of UEs. DCI format 2_1 may be used for notifying a group of UEs of a physical resource block and/or OFDM symbol where the UE may assume no transmission is intended to the UE. DCI format 2_2 may be used for transmission of a transmit power control (TPC) command for PUCCH or PUSCH. DCI format 2_3 may be used for transmission of a group of TPC commands for SRS transmissions by one or more UEs. DCI format(s) for new functions may be defined in future releases. DCI formats may have different DCI sizes, or may share the same DCI size.

After scrambling a DCI with a RNTI, the base station may process the DCI with channel coding (e.g., polar coding), rate matching, scrambling and/or QPSK modulation. A base station may map the coded and modulated DCI on resource elements used and/or configured for a PDCCH. Based on a payload size of the DCI and/or a coverage of the base station, the base station may transmit the DCI via a PDCCH occupying a number of contiguous control channel elements (CCEs). The number of the contiguous CCEs (referred to as aggregation level) may be 1, 2, 4, 8, 16, and/or any other suitable number. A CCE may comprise a number (e.g., 6) of resource-element groups (REGs). A REG may comprise a resource block in an OFDM symbol. The mapping of the coded and modulated DCI on the resource elements may be based on mapping of CCEs and REGs (e.g., CCE-to-REG mapping).

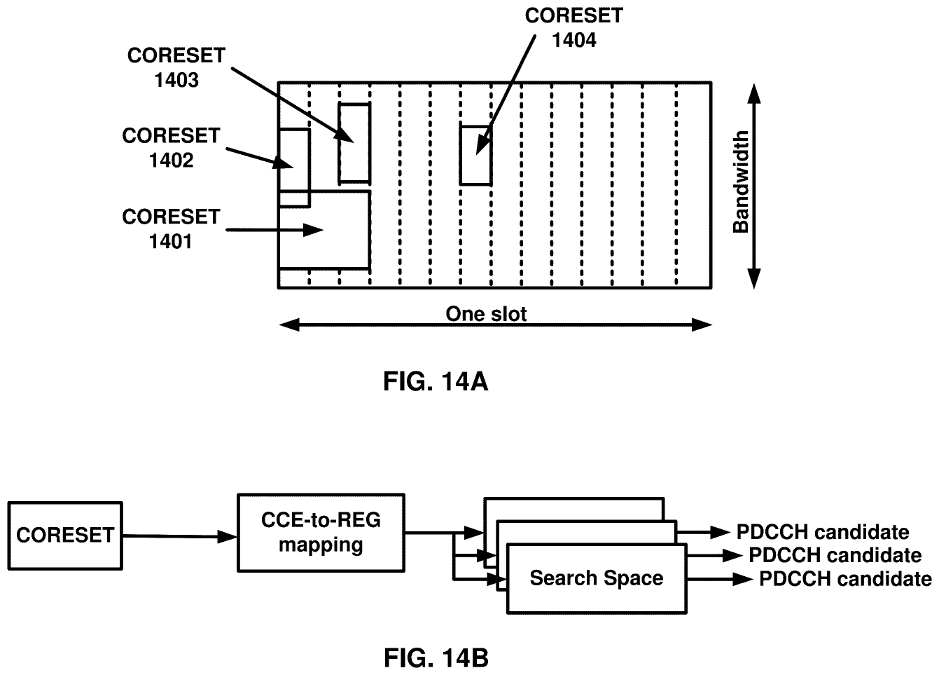

FIG. 14A illustrates an example of CORESET configurations for a bandwidth part. The base station may transmit a DCI via a PDCCH on one or more control resource sets (CORESETs). A CORESET may comprise a time-frequency resource in which the UE tries to decode a DCI using one or more search spaces. The base station may configure a CORESET in the time-frequency domain. In the example of FIG. 14A, a first CORESET 1401 and a second CORESET 1402 occur at the first symbol in a slot. The first CORESET 1401 overlaps with the second CORESET 1402 in the frequency domain. A third CORESET 1403 occurs at a third symbol in the slot. A fourth CORESET 1404 occurs at the seventh symbol in the slot. CORESETs may have a different number of resource blocks in frequency domain.

FIG. 14B illustrates an example of a CCE-to-REG mapping for DCI transmission on a CORESET and PDCCH processing. The CCE-to-REG mapping may be an interleaved mapping (e.g., for the purpose of providing frequency diversity) or a non-interleaved mapping (e.g., for the purposes of facilitating interference coordination and/or frequency-selective transmission of control channels). The base station may perform different or same CCE-to-REG mapping on different CORESETs. A CORESET may be associated with a CCE-to-REG mapping by RRC configuration. A CORESET may be configured with an antenna port quasi co-location (QCL) parameter. The antenna port QCL parameter may indicate QCL information of a demodulation reference signal (DMRS) for PDCCH reception in the CORESET.

The base station may transmit, to the UE, RRC messages comprising configuration parameters of one or more CORESETs and one or more search space sets. The configuration parameters may indicate an association between a search space set and a CORESET. A search space set may comprise a set of PDCCH candidates formed by CCEs at a given aggregation level. The configuration parameters may indicate: a number of PDCCH candidates to be monitored per aggregation level; a PDCCH monitoring periodicity and a PDCCH monitoring pattern; one or more DCI formats to be monitored by the UE; and/or whether a search space set is a common search space set or a UE-specific search space set. A set of CCEs in the common search space set may be predefined and known to the UE. A set of CCEs in the UE-specific search space set may be configured based on the UE's identity (e.g., C-RNTI).

As shown in FIG. 14B, the UE may determine a time-frequency resource for a CORESET based on RRC messages. The UE may determine a CCE-to-REG mapping (e.g., interleaved or non-interleaved, and/or mapping parameters) for the CORESET based on configuration parameters of the CORESET. The UE may determine a number (e.g., at most 10) of search space sets configured on the CORESET based on the RRC messages. The UE may monitor a set of PDCCH candidates according to configuration parameters of a search space set. The UE may monitor a set of PDCCH candidates in one or more CORESETs for detecting one or more DCIs. Monitoring may comprise decoding one or more PDCCH candidates of the set of the PDCCH candidates according to the monitored DCI formats. Monitoring may comprise decoding a DCI content of one or more PDCCH candidates with possible (or configured) PDCCH locations, possible (or configured) PDCCH formats (e.g., number of CCEs, number of PDCCH candidates in common search spaces, and/or number of PDCCH candidates in the UE-specific search spaces) and possible (or configured) DCI formats. The decoding may be referred to as blind decoding. The UE may determine a DCI as valid for the UE, in response to CRC checking (e.g., scrambled bits for CRC parity bits of the DCI matching a RNTI value). The UE may process information contained in the DCI (e.g., a scheduling assignment, an uplink grant, power control, a slot format indication, a downlink preemption, and/or the like).

The UE may transmit uplink control signaling (e.g., uplink control information (UCI)) to a base station. The uplink control signaling may comprise hybrid automatic repeat request (HARQ) acknowledgements for received DL-SCH transport blocks. The UE may transmit the HARQ acknowledgements after receiving a DL-SCH transport block. Uplink control signaling may comprise channel state information (CSI) indicating channel quality of a physical downlink channel. The UE may transmit the CSI to the base station. The base station, based on the received CSI, may determine transmission format parameters (e.g., comprising multi-antenna and beamforming schemes) for a downlink transmission. Uplink control signaling may comprise scheduling requests (SR). The UE may transmit an SR indicating that uplink data is available for transmission to the base station. The UE may transmit a UCI (e.g., HARQ acknowledgements (HARQ-ACK), CSI report, SR, and the like) via a physical uplink control channel (PUCCH) or a physical uplink shared channel (PUCCH). The UE may transmit the uplink control signaling via a PUCCH using one of several PUCCH formats.

There may be five PUCCH formats and the UE may determine a PUCCH format based on a size of the UCI (e.g., a number of uplink symbols of UCI transmission and a number of UCI bits). PUCCH format 0 may have a length of one or two OFDM symbols and may include two or fewer bits. The UE may transmit UCI in a PUCCH resource using PUCCH format 0 if the transmission is over one or two symbols and the number of HARQ-ACK information bits with positive or negative SR (HARQ-ACK/SR bits) is one or two. PUCCH format 1 may occupy a number between four and fourteen OFDM symbols and may include two or fewer bits. The UE may use PUCCH format 1 if the transmission is four or more symbols and the number of HARQ-ACK/SR bits is one or two. PUCCH format 2 may occupy one or two OFDM symbols and may include more than two bits. The UE may use PUCCH format 2 if the transmission is over one or two symbols and the number of UCI bits is two or more. PUCCH format 3 may occupy a number between four and fourteen OFDM symbols and may include more than two bits. The UE may use PUCCH format 3 if the transmission is four or more symbols, the number of UCI bits is two or more and PUCCH resource does not include an orthogonal cover code. PUCCH format 4 may occupy a number between four and fourteen OFDM symbols and may include more than two bits. The UE may use PUCCH format 4 if the transmission is four or more symbols, the number of UCI bits is two or more and the PUCCH resource includes an orthogonal cover code.

The base station may transmit configuration parameters to the UE for a plurality of PUCCH resource sets using, for example, an RRC message. The plurality of PUCCH resource sets (e.g., up to four sets) may be configured on an uplink BWP of a cell. A PUCCH resource set may be configured with a PUCCH resource set index, a plurality of PUCCH resources with a PUCCH resource being identified by a PUCCH resource identifier (e.g., pucch-Resourceid), and/or a number (e.g. a maximum number) of UCI information bits the UE may transmit using one of the plurality of PUCCH resources in the PUCCH resource set. When configured with a plurality of PUCCH resource sets, the UE may select one of the plurality of PUCCH resource sets based on a total bit length of the UCI information bits (e.g., HARQ-ACK, SR, and/or CSI). If the total bit length of UCI information bits is two or fewer, the UE may select a first PUCCH resource set having a PUCCH resource set index equal to “0”. If the total bit length of UCI information bits is greater than two and less than or equal to a first configured value, the UE may select a second PUCCH resource set having a PUCCH resource set index equal to “1”. If the total bit length of UCI information bits is greater than the first configured value and less than or equal to a second configured value, the UE may select a third PUCCH resource set having a PUCCH resource set index equal to “2”. If the total bit length of UCI information bits is greater than the second configured value and less than or equal to a third value (e.g., 1406), the UE may select a fourth PUCCH resource set having a PUCCH resource set index equal to “3”.

After determining a PUCCH resource set from a plurality of PUCCH resource sets, the UE may determine a PUCCH resource from the PUCCH resource set for UCI (HARQ-ACK, CSI, and/or SR) transmission. The UE may determine the PUCCH resource based on a PUCCH resource indicator in a DCI (e.g., with a DCI format 1_0 or DCI for 1_1) received on a PDCCH. A three-bit PUCCH resource indicator in the DCI may indicate one of eight PUCCH resources in the PUCCH resource set. Based on the PUCCH resource indicator, the UE may transmit the UCI (HARQ-ACK, CSI and/or SR) using a PUCCH resource indicated by the PUCCH resource indicator in the DCI.

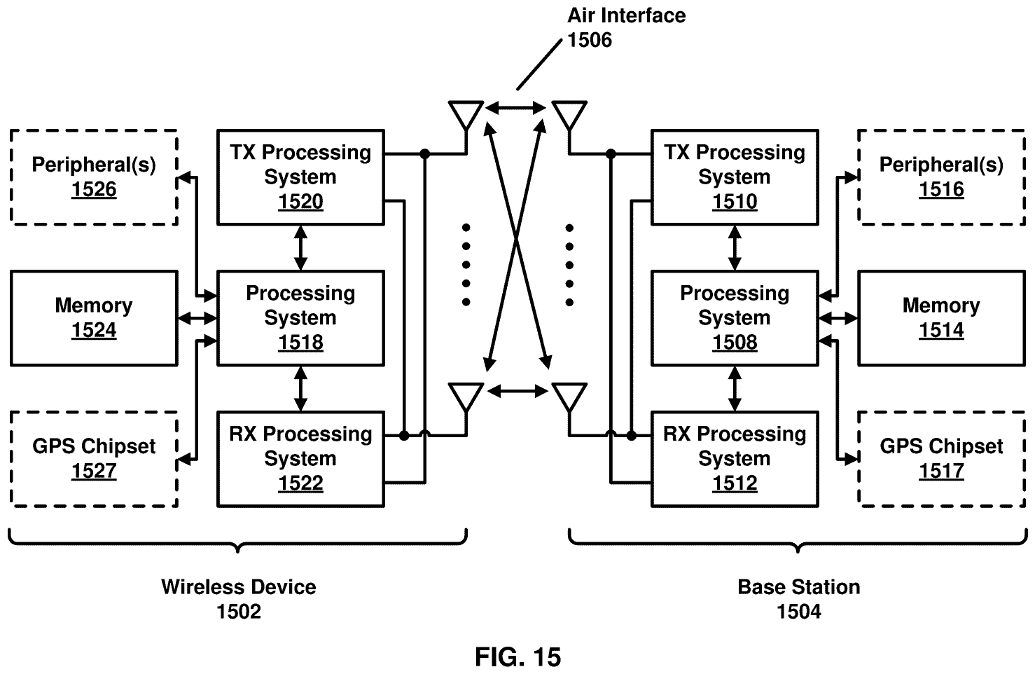

FIG. 15 illustrates an example of a wireless device 1502 in communication with a base station 1504 in accordance with embodiments of the present disclosure. The wireless device 1502 and base station 1504 may be part of a mobile communication network, such as the mobile communication network 100 illustrated in FIG. 1A, the mobile communication network 150 illustrated in FIG. 1B, or any other communication network. Only one wireless device 1502 and one base station 1504 are illustrated in FIG. 15, but it will be understood that a mobile communication network may include more than one UE and/or more than one base station, with the same or similar configuration as those shown in FIG. 15.

The base station 1504 may connect the wireless device 1502 to a core network (not shown) through radio communications over the air interface (or radio interface) 1506. The communication direction from the base station 1504 to the wireless device 1502 over the air interface 1506 is known as the downlink, and the communication direction from the wireless device 1502 to the base station 1504 over the air interface is known as the uplink. Downlink transmissions may be separated from uplink transmissions using FDD, TDD, and/or some combination of the two duplexing techniques.

In the downlink, data to be sent to the wireless device 1502 from the base station 1504 may be provided to the processing system 1508 of the base station 1504. The data may be provided to the processing system 1508 by, for example, a core network. In the uplink, data to be sent to the base station 1504 from the wireless device 1502 may be provided to the processing system 1518 of the wireless device 1502. The processing system 1508 and the processing system 1518 may implement layer 3 and layer 2 OSI functionality to process the data for transmission. Layer 2 may include an SDAP layer, a PDCP layer, an RLC layer, and a MAC layer, for example, with respect to FIG. 2A, FIG. 2B, FIG. 3, and FIG. 4A. Layer 3 may include an RRC layer as with respect to FIG. 2B.

After being processed by processing system 1508, the data to be sent to the wireless device 1502 may be provided to a transmission processing system 1510 of base station 1504. Similarly, after being processed by the processing system 1518, the data to be sent to base station 1504 may be provided to a transmission processing system 1520 of the wireless device 1502. The transmission processing system 1510 and the transmission processing system 1520 may implement layer 1 OSI functionality. Layer 1 may include a PHY layer with respect to FIG. 2A, FIG. 2B, FIG. 3, and FIG. 4A. For transmit processing, the PHY layer may perform, for example, forward error correction coding of transport channels, interleaving, rate matching, mapping of transport channels to physical channels, modulation of physical channel, multiple-input multiple-output (MIMO) or multi-antenna processing, and/or the like.

At the base station 1504, a reception processing system 1512 may receive the uplink transmission from the wireless device 1502. At the wireless device 1502, a reception processing system 1522 may receive the downlink transmission from base station 1504. The reception processing system 1512 and the reception processing system 1522 may implement layer 1 OSI functionality. Layer 1 may include a PHY layer with respect to FIG. 2A, FIG. 2B, FIG. 3, and FIG. 4A. For receive processing, the PHY layer may perform, for example, error detection, forward error correction decoding, deinterleaving, demapping of transport channels to physical channels, demodulation of physical channels, MIMO or multi-antenna processing, and/or the like.

As shown in FIG. 15, a wireless device 1502 and the base station 1504 may include multiple antennas. The multiple antennas may be used to perform one or more MIMO or multi-antenna techniques, such as spatial multiplexing (e.g., single-user MIMO or multi-user MIMO), transmit/receive diversity, and/or beamforming. In other examples, the wireless device 1502 and/or the base station 1504 may have a single antenna.

The processing system 1508 and the processing system 1518 may be associated with a memory 1514 and a memory 1524, respectively. Memory 1514 and memory 1524 (e.g., one or more non-transitory computer readable mediums) may store computer program instructions or code that may be executed by the processing system 1508 and/or the processing system 1518 to carry out one or more of the functionalities discussed in the present application. Although not shown in FIG. 15, the transmission processing system 1510, the transmission processing system 1520, the reception processing system 1512, and/or the reception processing system 1522 may be coupled to a memory (e.g., one or more non-transitory computer readable mediums) storing computer program instructions or code that may be executed to carry out one or more of their respective functionalities.

The processing system 1508 and/or the processing system 1518 may comprise one or more controllers and/or one or more processors. The one or more controllers and/or one or more processors may comprise, for example, a general-purpose processor, a digital signal processor (DSP), a microcontroller, an application specific integrated circuit (ASIC), a field programmable gate array (FPGA) and/or other programmable logic device, discrete gate and/or transistor logic, discrete hardware components, an on-board unit, or any combination thereof. The processing system 1508 and/or the processing system 1518 may perform at least one of signal coding/processing, data processing, power control, input/output processing, and/or any other functionality that may enable the wireless device 1502 and the base station 1504 to operate in a wireless environment.

The processing system 1508 and/or the processing system 1518 may be connected to one or more peripherals 1516 and one or more peripherals 1526, respectively. The one or more peripherals 1516 and the one or more peripherals 1526 may include software and/or hardware that provide features and/or functionalities, for example, a speaker, a microphone, a keypad, a display, a touchpad, a power source, a satellite transceiver, a universal serial bus (USB) port, a hands-free headset, a frequency modulated (FM) radio unit, a media player, an Internet browser, an electronic control unit (e.g., for a motor vehicle), and/or one or more sensors (e.g., an accelerometer, a gyroscope, a temperature sensor, a radar sensor, a lidar sensor, an ultrasonic sensor, a light sensor, a camera, and/or the like). The processing system 1508 and/or the processing system 1518 may receive user input data from and/or provide user output data to the one or more peripherals 1516 and/or the one or more peripherals 1526. The processing system 1518 in the wireless device 1502 may receive power from a power source and/or may be configured to distribute the power to the other components in the wireless device 1502. The power source may comprise one or more sources of power, for example, a battery, a solar cell, a fuel cell, or any combination thereof. The processing system 1508 and/or the processing system 1518 may be connected to a GPS chipset 1517 and a GPS chipset 1527, respectively. The GPS chipset 1517 and the GPS chipset 1527 may be configured to provide geographic location information of the wireless device 1502 and the base station 1504, respectively.

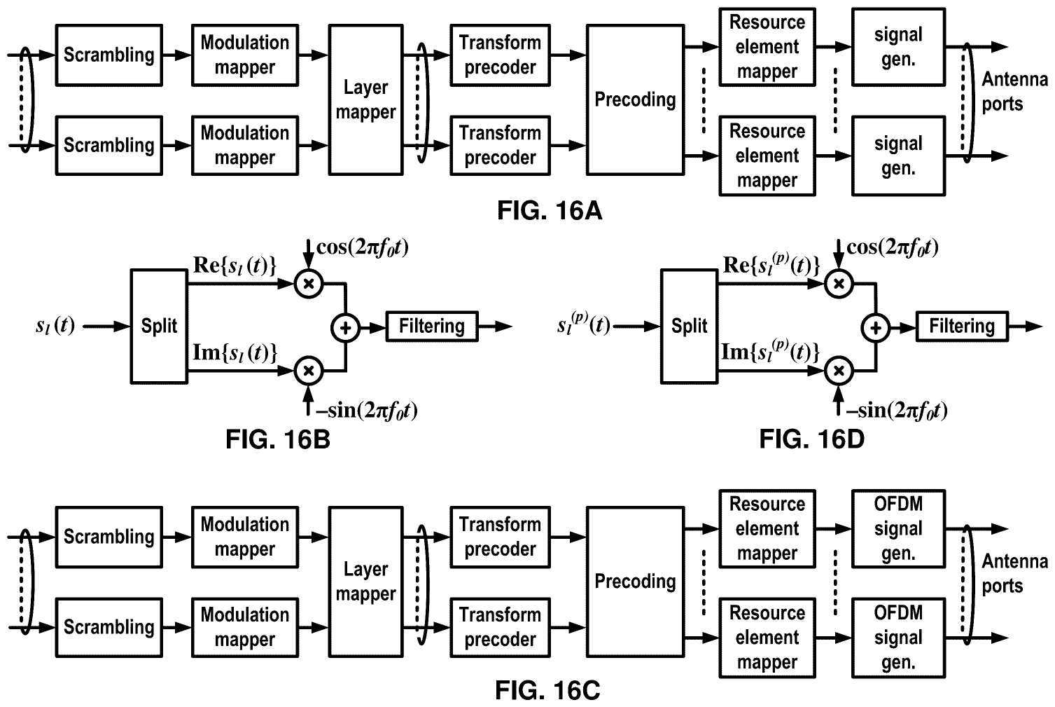

FIG. 16A illustrates an example structure for uplink transmission. A baseband signal representing a physical uplink shared channel may perform one or more functions. The one or more functions may comprise at least one of: scrambling; modulation of scrambled bits to generate complex-valued symbols; mapping of the complex-valued modulation symbols onto one or several transmission layers; transform precoding to generate complex-valued symbols; precoding of the complex-valued symbols; mapping of precoded complex-valued symbols to resource elements; generation of complex-valued time-domain Single Carrier-Frequency Division Multiple Access (SC-FDMA) or CP-OFDM signal for an antenna port; and/or the like. In an example, when transform precoding is enabled, a SC-FDMA signal for uplink transmission may be generated. In an example, when transform precoding is not enabled, a CP-OFDM signal for uplink transmission may be generated by FIG. 16A. These functions are illustrated as examples and it is anticipated that other mechanisms may be implemented in various embodiments.

FIG. 16B illustrates an example structure for modulation and up-conversion of a baseband signal to a carrier frequency. The baseband signal may be a complex-valued SC-FDMA or CP-OFDM baseband signal for an antenna port and/or a complex-valued Physical Random Access Channel (PRACH) baseband signal. Filtering may be employed prior to transmission.

FIG. 16C illustrates an example structure for downlink transmissions. A baseband signal representing a physical downlink channel may perform one or more functions. The one or more functions may comprise: scrambling of coded bits in a codeword to be transmitted on a physical channel; modulation of scrambled bits to generate complex-valued modulation symbols; mapping of the complex-valued modulation symbols onto one or several transmission layers; precoding of the complex-valued modulation symbols on a layer for transmission on the antenna ports; mapping of complex-valued modulation symbols for an antenna port to resource elements; generation of complex-valued time-domain OFDM signal for an antenna port; and/or the like. These functions are illustrated as examples and it is anticipated that other mechanisms may be implemented in various embodiments.

FIG. 16D illustrates another example structure for modulation and up-conversion of a baseband signal to a carrier frequency. The baseband signal may be a complex-valued OFDM baseband signal for an antenna port. Filtering may be employed prior to transmission.

A wireless device may receive from a base station one or more messages (e.g. RRC messages) comprising configuration parameters of a plurality of cells (e.g. primary cell, secondary cell). The wireless device may communicate with at least one base station (e.g. two or more base stations in dual-connectivity) via the plurality of cells. The one or more messages (e.g. as a part of the configuration parameters) may comprise parameters of physical, MAC, RLC, PCDP, SDAP, RRC layers for configuring the wireless device. For example, the configuration parameters may comprise parameters for configuring physical and MAC layer channels, bearers, etc. For example, the configuration parameters may comprise parameters indicating values of timers for physical, MAC, RLC, PCDP, SDAP, RRC layers, and/or communication channels.

A timer may begin running once it is started and continue running until it is stopped or until it expires. A timer may be started if it is not running or restarted if it is running. A timer may be associated with a value (e.g. the timer may be started or restarted from a value or may be started from zero and expire once it reaches the value). The duration of a timer may not be updated until the timer is stopped or expires (e.g., due to BWP switching). A timer may be used to measure a time period/window for a process. When the specification refers to an implementation and procedure related to one or more timers, it will be understood that there are multiple ways to implement the one or more timers. For example, it will be understood that one or more of the multiple ways to implement a timer may be used to measure a time period/window for the procedure. For example, a random access response window timer may be used for measuring a window of time for receiving a random access response. In an example, instead of starting and expiry of a random access response window timer, the time difference between two time stamps may be used. When a timer is restarted, a process for measurement of time window may be restarted. Other example implementations may be provided to restart a measurement of a time window.

A slot format may comprise downlink symbols, uplink symbols, and/or flexible symbols. In various embodiments of the present disclosure, a slot format may include one or more DL symbols (D), one or more UL symbols (U), and one or more flexible symbols (F). In various embodiments of the present disclosure, the corresponding configurations may be described as DL, UL, and flexible symbol(s), respectively, for the convenience of description.

For each serving cell, a wireless device may receive an RRC message and/or SIB message (e.g., SIB1) comprising a common RRC configuration information (e.g., TDD-UL-DL-ConfigCommon). The common RRC configuration information may comprise one or more parameters that indicate to the wireless device to set the slot format of each slot of a number of one or more slots. For example, the common RRC configuration message may indicate at least one of: a reference subcarrier spacing (SCS) μ_{ref}; and/or at least one pattern. A first pattern of the at least one patterns may comprise at least one of: a slot configuration period of P msec; a number of slots dₛₗₒₜₛ with only downlink symbols; a number of downlink symbols d_{sym}; a number of slots uₛₗₒₜₛ with only uplink symbols; a number of uplink symbols u_{sym}. The slot configuration period of P msec may comprise S=P·2^{μ}^{_{ref}} slots with SCS configuration μ_{ref}. From the S slots, a first dₛₗₒₜₛ slots may comprise one or more downlink symbols and a last μₛₗₒₜₛ slots may comprise one or more uplink symbols. A d_{sym} symbols after the first dₛₗₒₜₛ slots may comprise one or more downlink symbols. A u_{sym} ymbols before the last uₛₗₒₜₛ slots may comprise one or more uplink symbols. A remaining (S−dₛₗₒₜₛ −uₛₗₒₜₛ)·N_{symb}^{slot}−d_{sym}−u_{sym} symbols may comprise one or more flexible symbols. A second pattern of the at least one patterns may be configured. The wireless device may set the slot format of each slot of a first number of slots as indicated by the first pattern, and may set the slot format of each slot of a second number of slots as indicated by the second pattern.

When the higher-layer parameter TDD-UL-DL-ConfigurationCommon provides higher-layer parameters pattern1 and pattern2, the UE configures a slot format per slot over a first number of slots based on the higher-layer parameter pattern1, and a slot format per slot over a second number of slots based on the higher-layer parameter pattern2. The higher-layer parameter pattern2 may provide the following: A slot configuration periodicity P₂ msec based on a higher-layer parameter dl-UL-TransmissionPeriodicity; the number d_{slots,2} of slots including only DL symbols based on a higher-layer parameter nrofDownlinkSlots; the number d_{sym,2} of DL symbols based on a higher-layer parameter nrofDownlinkSymbols; the number u_{slots,2} of slots including only UL symbols based on a higher-layer parameter nrofUplinkSlots; the number u_{sym,2} of UL symbols based on a higher-layer parameter nrofUplinkSymbols.

For an SCS configuration μ_{ref}=3, only P=0.625 msec may be valid. For an SCS configuration μ_{ref}=2 or μ_{ref}=3, only P=1.25 msec may be valid. For an SCS configuration μ_{ref}=1, μ_{ref}=2 or μ_{ref}=3, only P=2.5 msec may be valid. The first symbol of every 20/P period is the first symbol of an even-numbered frame.

A P₂ value applicable according to an SCS configuration is equal to a P value applicable according to the SCS configuration. A slot configuration periodicity P+P2 msec includes the first S slots where S=P·2^{μ ref} ref and the second S₂ slots where S₂=P₂·2^{μ ref}. The first d_{slots,2} ones of the S₂ slots include only DL symbols, and the last u_{slots,2} ones of the S₂ slots include only UL symbols. d_{sym,2} symbols following the first d_{slots,2slots} are DL symbols. u_{sym,2} symbols preceding the u_{slots,2slots} are UL symbols. The remaining (S₂−d_{slots,2}−u_{slots,2})·N_{symb}^{slots}−d_{sym,2}−u_{sym,2} symbols are flexible symbols.

The UE expects the value of P+P₂ to be divided by 20 msec without a remainder. In other words, the UE expects the value of P+P2 to be an integer multiple of 20 msec. The first symbol of every 20/(P+P₂) period is the first symbol of an even-numbered frame.

The UE expects that the reference SCS configuration pref is smaller than or equal to an SCS configuration for μ any configured DL BWP or UL BWP. Each slot (configuration) provided by the higher-layer parameter pattern1 or pattern2 is applicable to 2^{(μ-μ ref)} consecutive slots in the active DL BWP or active UL BWP in the first slot which starts at the same time as the first slot for the reference SCS configuration μ_{ref}. Each DL, flexible, or UL symbol for the reference SCS configuration Pref corresponds to 2^{(μ-μ ref)} consecutive DL, flexible, or UL symbols for the SCS configuration μ.

A wireless device may receive an RRC message comprising a dedicated RRC configuration information specific to the wireless device (e.g., TDD-UL-DL-Configdedicated). The dedicated RRC configuration information may comprise one or more parameters that may override one or more flexible symbols of each slot of a number of slots configured by a common RRC configuration message. For example, the dedicated RRC configuration message may comprise at least one of: one or more slot configurations; and/or for each slot configuration of the one or more slot configurations: a slot index for a slot (slotlndex); one or more symbols of a slot (symbols) which indicates a first number of zero or more downlink first symbols in the slot, and a second number of zero or more uplink last symbols in the slot, and a remaining number of zero or more flexible symbols in the slot. The wireless device may determine a slot format for each slot with a corresponding slot index of the slot (slotlndex) based on a format indicated by the one or more symbols of the slot (symbols).

When the UE is additionally provided with a higher-layer parameter Tdd-UL-DL-ConfigurationDedicated, the higher-layer parameter Tdd-UL-DL-ConfigurationDedicated overrides only flexible symbols per slot over the number of slots as provided by the higher-layer parameter Tdd-UL-DL-ConfigurationCommon.

The higher-layer parameter Tdd-UL-DL-ConfigurationDedicated may provide the following: A set of slot configurations based on a higher-layer parameter slotSpecificConfigurationsToAddModList; each slot configuration in the set of slot configurations; a slot index based on a higher-layer parameter slotlndex; a set of symbols based on a higher-layer parameter symbols. If the higher-layer parameter symbols=allDownlink, all symbols in the slot are DL symbols. If the higher-layer parameter symbols=allUplink, all symbols in the slot are UL symbols. If the higher-layer parameter symbols=explicit, the higher-layer parameter nrofDownlinkSymols provides the number of first DL symbols in the slot, and the higher-layer parameter nrofUplinkSymbols provides the number of last UL symbols in the slot. If the higher-layer parameter nrofDownlinkSymbols is not provided, this implies that there are no first DL symbols in the slot. If the higher-layer parameter nrofUplinkSymbols is not provided, this implies that there are no last UL symbols in the slot. The remaining symbols in the slot are flexible symbols.

For each slot having an index provided by a higher-layer parameter slotlndex, the UE applies a (slot) format provided by a corresponding symbols. The UE does not expect the higher-layer parameter TDD-UL-DL-ConfigurationDedicated to indicate, as UL or DL, a symbol that the higher-layer parameter TDD-UL-DL-ConfigurationCommon indicates as DL or UL.

For each slot configuration provided by the higher-layer parameter TDD-UL-DL-ConfigurationDedicated, a reference SCS configuration is the reference SCS configuration μ_{ref} provided by the higher-layer parameter TDD-UL-DL-ConfigurationCommon.

A slot configuration periodicity and the number of DL/UL/flexible symbols in each slot of the slot configuration periodicity is determined based on the higher-layer parameters TDD-UL-DL-ConfigurationCommon and TDD-UL-DL-ConfigurationDedicated, and the information is common to each configured BWP.

The UE considers symbols in a slot indicated as DL by the higher-layer parameter TDD-UL-DL-ConfigurationCommon or TDD-UL-DL-ConfigurationDedicated to be available for signal reception. Further, the UE considers symbols in a slot indicated as UL by the higher-layer parameter TDD-UL-DL-ConfigurationCommon or TDD-UL-DL-ConfigurationDedicated to be available for signal transmission.

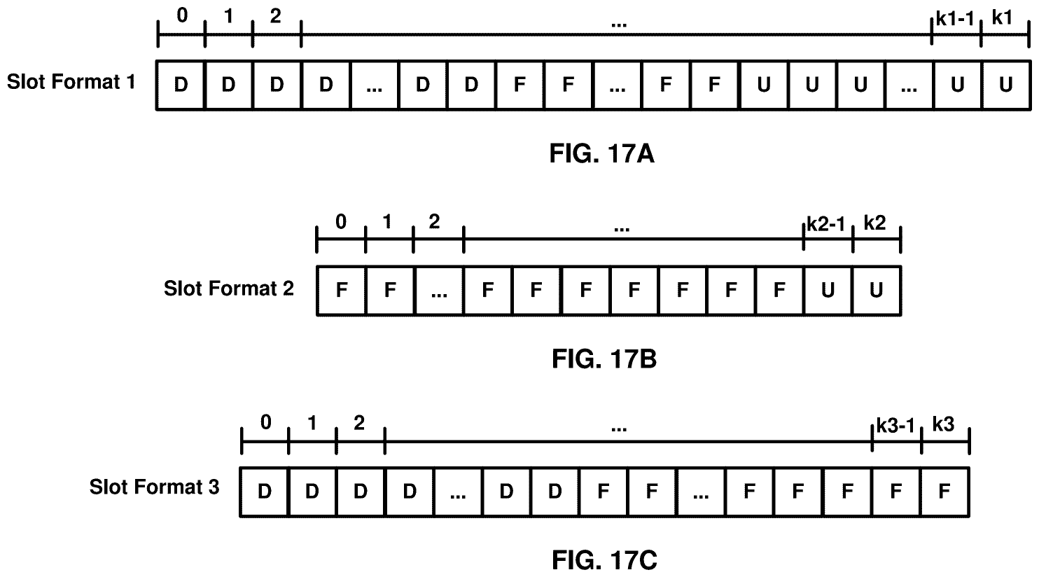

FIG. 17A and FIG. 17B and FIG. 17C illustrate example slot formats for one or more slots. For example, the slot format 1 in FIG. 17A comprises of k1 symbols indicated as downlink symbols (D) and/or uplink symbols (U) and/or flexible symbols (F). For example, the slot format 2 in FIG. 17B comprises of k2 symbols indicated as uplink symbols and/or flexible symbols. For example, the slot format 3 in FIG. 17C comprises of k3 symbols indicated as downlink symbols and/or flexible symbols.

A wireless device may not expect a dedicated RRC configuration message to indicate as uplink or as downlink a symbol that a common RRC configuration message indicates as a downlink or as an uplink symbol, respectively. For each slot configuration of one or more slot configurations indicated by the dedicated RRC configuration message, a reference SCS is the reference SCS indicated by the common RRC configuration message. A slot configuration period and a number of downlink/uplink/flexible symbols in each slot of the one or more slot configuration period may be determined from the common/dedicated RRC configuration messages, and may be common to each one of one or more configured BWPs.

A wireless device may receive a common RRC configuration message and/or a dedicated RRC configuration message indicating one or more symbols in a slot as downlink. The wireless device may consider the one or more symbols to be available for reception. The wireless device may receive a common RRC configuration message and/or a dedicated RRC configuration message indicating one or more symbols in a slot as uplink. The wireless device may consider the one or more symbols to be available for transmission.

One or more symbols of a slot may be indicated as flexible symbols by one or more RRC configuration messages. The wireless device may not receive the one or more RRC configuration messages indicating a slot format configuration. The wireless device may receive a downlink control signals, e.g., DCI format 1_0, DCI format 1_1, DCI format 0_1, DCI format 0_0, and/or DCI format 2_3, scheduling downlink/uplink transmissions. The downlink control signal (e.g., DCI format 1_0, DCI format 1_1, and/or DCI format 0_1) or an RRC message (e.g., SIB1) may indicate to the wireless device a reception of one or more downlink channels/signals (e.g., PDSCH, PDCCH, SSB, and/or CSI-RS) in the one or more symbols of the slot. The wireless device may receive the one or more downlink channels/signals in the one or more symbols. The downlink control signal (e.g., DCI format 1_0, DCI format 1_1, DCI format 0_0, DCI format 2_3, and/or DCI format 0_1) may indicate to the wireless device a transmission of one or more uplink channels/signals (e.g., PUSCH, PUCCH, PRACH, and/or SRS) in the one or more symbols of the slot. The wireless device may transmit the one or more uplink channels/signals in the one or more symbols.

A wireless device may be configured by higher layers to receive a PDCCH, PDSCH, and/or CSI-RS in one or more symbols of a slot. The wireless device may receive the PDCCH, PDSCH, and/or CSI-RS, for example, if the wireless device does not detect a DCI (e.g., DCI format 0_0, DCI format 0_1, DCI format 1_0, DCI format 1_1, and/or DCI format 2_3) indicating to the wireless device to transmit a PUSCH, a PUCCH, a PRACH, and/or a SRS in at least one symbol of the one or more symbols of the slot. The wireless device may not receive the PDCCH, PDSCH, and/or CSI-RS, for example, if the wireless device detects the DCI (e.g., DCI format 0_0, DCI format 0_1, DCI format 1_0, DCI format 1_1, and/or DCI format 2_3) indicating to the wireless device to transmit a PUSCH, a PUCCH, a PRACH, and/or a SRS in the at least one symbol of the one or more symbols of the slot.

A wireless device may be configured by higher layers to transmit SRS, PUCCH, PUSCH, and/or PRACH in one or more symbols of a slot. The wireless device may detect a DCI format 1_0, DCI format 1_1, or DCI format 0_1 indicating to the wireless device to receive CSI-RS and/or PDSCH in at least one symbol of the one or more symbols of the slot. The wireless device may not expect to cancel the transmission in the at least one symbol of the one or more symbols that occur, relative to a last symbol of a CORESET where the wireless device detects the DCI format 1_0 or the DCI format 1_1 or the DCI format 0_1, after a number of symbols that is smaller than the PUSCH preparation time, for the corresponding wireless device processing capability. The wireless device may cancel the SRS, PUCCH, PUSCH, and/or PRACH transmission in remaining symbols from the one or more symbols.

For one or more symbols of a slot that are indicated to a wireless device as uplink by one or more RRC configuration messages (common and/or dedicated), the wireless device may not receive PDCCH, PDSCH, or CSI-RS in the one or more symbols of the slot. For the one or more symbols of the slot that are indicated to the wireless device as downlink by the one or more RRC configuration messages (common and/or dedicated), the wireless device may not transmit PUSCH, PUCCH, PRACH, and/or SRS in the one or more symbols of the slot.

For one or more symbols of a slot that are indicated to a wireless device by one or more RRC parameters for reception of SS/PBCH blocks, the wireless device may not transmit PUSCH, PUCCH, and/or PRACH in the slot if a transmission overlap with at least one symbol from the one or more symbols and the wireless device may not transmit SRS in the one or more symbols of the slot. The wireless device may not expect the one or more symbols of the slot to be indicated as uplink by RRC configuration messages (common/dedicated) when provided to the wireless device.

For one or more symbols of a slot corresponding to a valid PRACH occasion and symbols before the valid PRACH occasion, the wireless device may not receive PDCCH for Type1-PDCCH CSS set, PDSCH, or CSI-RS in the slot if a reception overlaps with at least one symbol from the one or more symbols. The wireless device may not expect the one or more symbols of the slot to be indicated as downlink by RRC configuration messages (common/dedicated).

If a wireless device is scheduled by a DCI format 1_1 to receive PDSCH over a plurality of slots, and if RRC configuration messages indicate that, for a slot in the plurality of slots, at least one symbol from one or more symbols where the wireless device is scheduled PDSCH reception in the slot is an uplink symbol, the wireless device may not receive the PDSCH in the slot.

If a wireless device is scheduled by a DCI format 0_1 to transmit PUSCH over plurality of slots, and if RRC configuration messages indicates that, for a slot from the plurality of slots, at least one symbol from one or more symbols where the wireless device is scheduled PUSCH transmission in the slot is a downlink symbol, the wireless device may not transmit the PUSCH in the slot.

A wireless device may be configured by higher layers with a parameter indicating one or more slot formats (SlotFormatIndicator). In an example, a DCI format (e.g., DCI format 2_0) may be used for notifying the one or more slot formats. The DCI format may comprise CRC bits scrambled by a first radio network temporary identifier (e.g., SFI-RNTI). The first radio network temporary identifier may be configured by higher layers, or may be predefined, or a fixed value. A size of the DCI format may be configured by higher layers, e.g., up to 128 bits. The DCI format may comprise at least one information of one or more slot format indicators (SFIs). The wireless device may be configured to monitor a group-common-PDCCH for the one or more slot format indicators for each one of one or more serving cells configured by the parameters indicating the one or more slot formats. For each serving cell, the wireless device may be provided at least one of: an identity of the serving cell; a location of an SFI-index field in the DCI format; and/or a set of slot format combinations comprising one or more slot format combinations (slotFormatCombinations), where each of the one or more slot format combinations may comprise: one or more slot formats (slotFormats) for the slot format combination; a mapping for the slot format to a corresponding SFI-index field value in the DCI format (slotFormatCombinationId); and/or at least one reference SCS configuration.

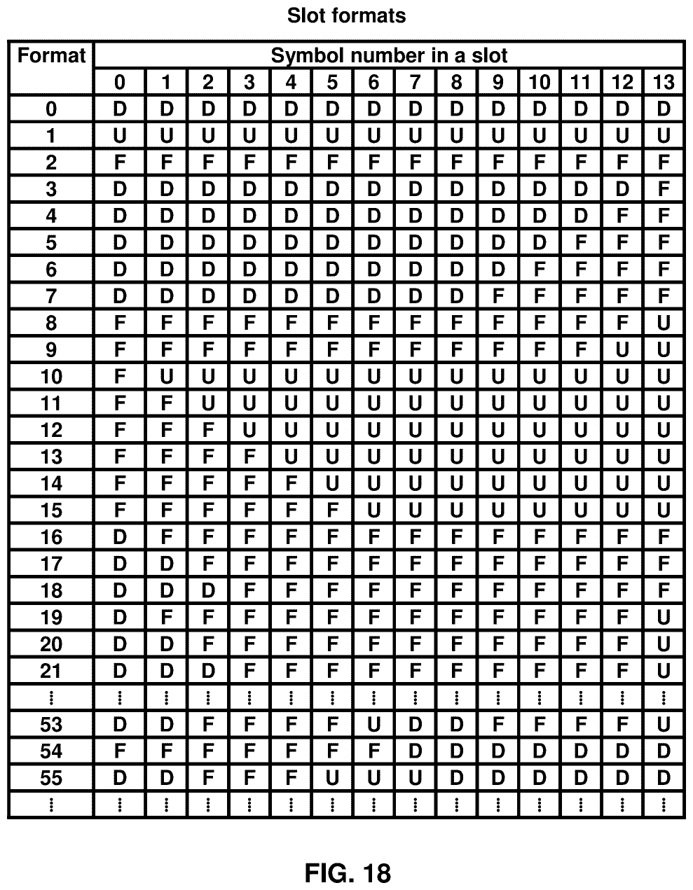

A slot format may be identified by a corresponding format index as shown in the table in FIG. 18. FIG. 18 shows an example of slot formats of a slot, wherein each symbol in the slot may be a downlink (D) symbol and/or an uplink (U) symbol and/or a flexible (F) symbol. For example, slot format 0 comprises of all downlink (D) symbols. For example, slot format 1 comprises of all uplink (U) symbols. For example, slot format 55 comprises of two downlink (D) symbols, followed by three flexible (F) symbols, followed by three uplink (U) symbols, followed by six downlink (D) symbols.

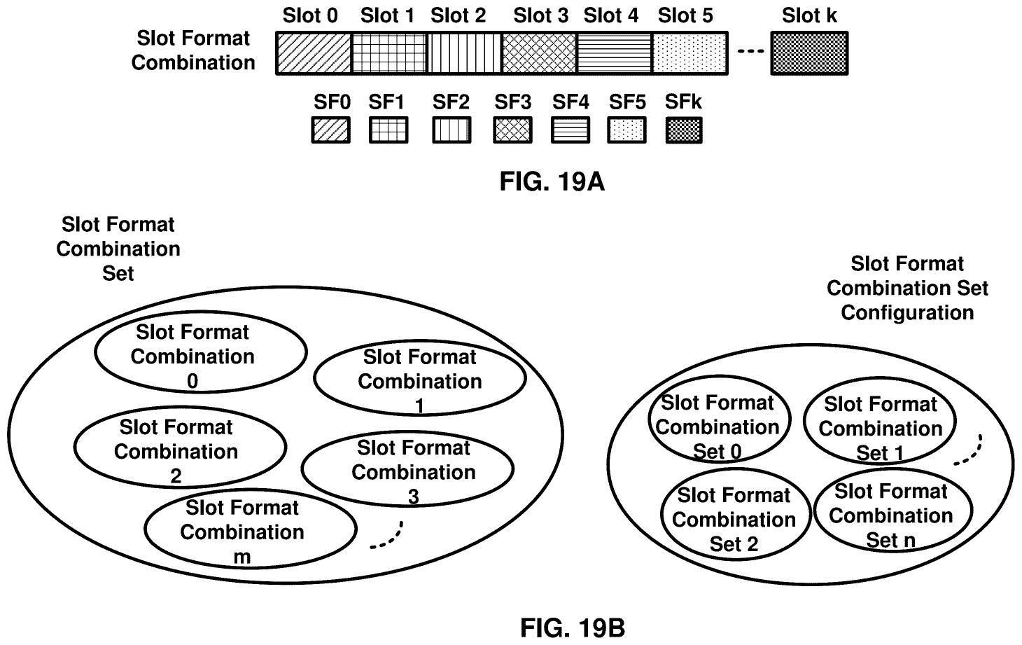

FIG. 19A illustrates a slot format combination. In an example, the slot format combination may comprise k slots. In an example, each slot of the slot format combination may have a slot format (for example, slot0 may have slot format SF0, slot1 may have slot format SF1, slot2 may have slot format SF2, slot3 may have slot format SF3, slot4 may have slot format SF4, slot5 may have slot format SF5 and slot k may have slot format SFk). In an example, two or more of SF0, SF1, SF2, SF3, SF4, SF5 and SFk may correspond to different slot formats. In an example, two or more of SF0, SF1, SF2, SF3, SF4, SF5 and SFk may correspond to the same slot format. In an example, two or more slot formats of SF0, SF1, SF2, SF3, SF4, SF5 and SFk may be same. As shown in FIG. 19B, a plurality of slot format combinations of a cell (e.g. slot format combination 0, slot format combination 1, slot format combination 2, slot format combination 3, . . . , and slot format combination m) may be configured to a wireless device via RRC messages. In an example, the plurality of slot format combinations may be slot format combinations of NR system. In an example, the plurality of slot format combinations may be slot format combinations designed based on an interference condition of NR-U system. In an example, the plurality of slot format combinations may be slot format combinations designed based on a channel condition of NR-U system. In an example, a slot format combination may be indicated to a wireless device via downlink control channel. In an example, the slot format combination may be indicated to the wireless device via a PDCCH. In an example, the slot format combination may be indicated to the wireless device via a GC-PDCCH.

In an example, and as shown in FIG. 19B, the plurality of the slot format combinations may be parted into a plurality of slot format combination sets (for example, slot format combination0, slot format combination set1, slot format combination set 2, . . . , and slot format combination set n). In an example, the plurality of slot format combination sets may be configured to a wireless device via RRC messages. In an example, the number of slot format combinations in each of the slot format combination sets may be different. In an example, the number of slot format combinations in each of the slot format combination sets may be same. In an example, a time length of a slot format combination in each of the slot format combination sets may be equal to a time length of a channel occupancy time (COT). In an example, the time length of the slot format combination in each of the slot format combination sets may be larger than the time length of the COT.

An SFI-index field value in a DCI format may indicate to a wireless device a slot format for each of one or more slots in a number of slots for each DL BWP and/or each UL BWP starting from a slot where the wireless device detects the DCI format.

For one or more symbols of a slot, a wireless device may not expect to detect a DCI format (e.g., DCI format 2_0) with an SFI-index field value indicating the one or more symbols of the slot as uplink and to detect a DCI format 1_0, a DCI format 1_1, or DCI format 0_1 indicating to the wireless device to receive PDSCH or CSI-RS in the one or more symbols of the slot.

For one or more symbols of a slot, a wireless device may not expect to detect a DCI format (e.g., DCI format 2_0) with an SFI-index field value indicating the one or more symbols in the slot as downlink and to detect a DCI format 0_0, DCI format 0_1, DCI format 1_0, DCI format 1_1, DCI format 2_3, or a RAR UL grant indicating to the wireless device to transmit PUSCH, PUCCH, PRACH, or SRS in the one or more symbols of the slot.

For one or more symbols of a slot that are indicated as downlink/uplink by RRC configuration messages (e.g., TDD-UL-DL-ConfigurationCommon, or TDD-UL-DL-ConfigDedicated), the wireless device may not expect to detect a DCI format (e.g., DCI format 2_0) with an SFI-index field value indicating the one or more symbols of the slot as uplink/downlink, respectively, or as flexible.

For one or more symbols of a slot indicated to a wireless device by RRC messages (e.g., ssb-PositionsInBurst in SystemInformationBlockType1 or ssb-PositionsInBurst in ServingCellConfigCommon) for reception of SS/PBCH blocks, the wireless device may not expect to detect a DCI format (e.g., DCI format 2_0) with an SFI-index field value indicating the one or more symbols of the slot as uplink.

For one or more symbols of a slot indicated to a wireless device by RRC messages (e.g., prach-ConfigurationIndex in RACH-ConfigCommon) for PRACH transmissions, the wireless device may not expect to detect a DCI format (e.g., DCI format 2_0) with an SFI-index field value indicating the one or more symbols of the slot as downlink.

For one or more symbols of a slot indicated to a wireless device by RRC messages (e.g., pdcch-ConfigSIB1 in MIB) for a CORESET for Type0-PDCCH CSS set, the wireless device may not expect to detect a DCI format (e.g., DCI format 2_0) with an SFI-index field value indicating the one or more symbols of the slot as uplink.

For one or more symbols of a slot indicated to a wireless device as flexible by RRC configuration messages (e.g., TDD-UL-DL-ConfigurationCommon and TDD-UL-DL-ConfigDedicated), or when RRC configuration messages are not provided to the wireless device, the wireless device may detect a DCI format (e.g. DCI format 2_0) providing a format for the slot. If at least one symbol of the one or more symbols is a symbol in a CORESET configured to the wireless device for PDCCH monitoring, the wireless device may receive PDCCH in the CORESET only if an SFI-index field value in the DCI format indicates that the at least one symbol is a downlink symbol. If the SFI-index field value in the DCI format indicates the one or more symbols of the slot as flexible and the wireless device detects a DCI format 1_0, DCI format 1_1, or DCI format 0_1 indicating to the wireless device to receive PDSCH or CSI-RS in the one or more symbols of the slot, the wireless device may receive PDSCH or CSI-RS in the one or more symbols of the slot. If the SFI-index field value in the DCI format indicates the one or more symbols of the slot as flexible and the wireless device detects a DCI format 0_0, DCI format 0_1, DCI format 1_0, DCI format 1_1, DCI format 2_3, or a RAR UL grant indicating to the wireless device to transmit PUSCH, PUCCH, PRACH, or SRS in the one or more symbols of the slot, the wireless device may transmit the PUSCH, PUCCH, PRACH, or SRS in the one or more symbols of the slot. If the SFI-index field value in the DCI format indicates the one or more symbols of the slot as flexible, and the wireless device does not detect a DCI format 1_0, DCI format 1_1, or DCI format 0_1 indicating to the wireless device to receive PDSCH or CSI-RS, or the wireless device does not detect a DCI format 0_0, DCI format 0_1, DCI format 1_0, DCI format 1_1, DCI format 2_3, or a RAR UL grant indicating to the wireless device to transmit PUSCH, PUCCH, PRACH, or SRS in the one or more symbols of the slot, the wireless device may not transmit or receive in the one or more symbols of the slot. If the wireless device is configured by higher layers to receive PDSCH or CSI-RS in the one or more symbols of the slot, the wireless device may receive the PDSCH or the CSI-RS in the one or more symbols of the slot only if an SFI-index field value in the DCI format indicates the one or more symbols of the slot as downlink. If the wireless device is configured by higher layers to transmit PUCCH, or PUSCH, or PRACH in the one or more symbols of the slot, the wireless device transmits the PUCCH, or the PUSCH, or the PRACH in the slot only if an SFI-index field value in the DCI format indicates the one or more symbols of the slot as uplink. If the wireless device is configured by higher layers to transmit SRS in the one or more symbols of the slot, the wireless device transmits the SRS only in a subset of symbols from the one or more symbols of the slot indicated as uplink symbols by an SFI-index field value in the DCI format. A wireless device may not expect to detect an SFI-index field value in the DCI format indicating the one or more symbols of the slot as downlink and also detect a DCI format 0_0, DCI format 0_1, DCI format 1_0, DCI format 1_1, DCI format 2_3, or a RAR UL grant indicating to the wireless device to transmit SRS, PUSCH, PUCCH, or PRACH, in at least one symbol of the one or more symbols of the slot. A wireless device may not expect to detect an SFI-index field value in the DCI format indicating the one or more symbols of the slot as downlink or flexible if the one or more symbols of the slot comprises at least one symbol corresponding to any repetition of a PUSCH transmission activated by an UL Type 2 grant PDCCH. A wireless device may not expect to detect an SFI-index field value in the DCI format indicating the one or more symbols of the slot as uplink and also detect a DCI format 1_0 or DCI format 1_1 or DCI format 0_1 indicating to the wireless device to receive PDSCH or CSI-RS in at least one symbol of the one or more symbols of the slot.

If a wireless device is configured by higher layers to receive a CSI-RS or a PDSCH in one or more symbols of a slot and the wireless device detects a DCI format (e.g., DCI format 2_0) with a slot format value that indicates a slot format with a subset of symbols from the one or more symbols as uplink or flexible, or the wireless device detects a DCI format 0_0, DCI format 0_1, DCI format 1_0, DCI format 1_1, or DCI format 2_3 indicating to the wireless device to transmit PUSCH, PUCCH, SRS, or PRACH in at least one symbol in the one or more symbols, the wireless device cancels the CSI-RS reception in the one or more symbols of the slot or cancels the PDSCH reception in the slot.

A wireless device may be configured by higher layers to transmit SRS, or PUCCH, or PUSCH, or PRACH i n one or more symbols of a slot and the wireless device may detect a DCI format (e.g., DCI format 2_0) with a slot format value that indicates a slot format with a subset of symbols from the one or more symbols as downlink or flexible, or the wireless device may detect a DCI format 1_0, DCI format 1_1, or DCI format 0_1 indicating to the wireless device to receive CSI-RS or PDSCH in a subset of symbols from the one or more symbols. The wireless device may not expect to cancel the transmission in symbols from the subset of symbols that occur, relative to a last symbol of a CORESET where the wireless device detects the DCI format 2_0 or the DCI format 1_0 or the DCI format 1_1 or the DCI format 0_1, after a number of symbols that is smaller than the PUSCH preparation time for the corresponding PUSCH processing capability. The wireless device may cancel the PUCCH, or PUSCH, or PRACH transmission in remaining symbols from the one or more symbols and may cancel the SRS transmission in remaining symbols from the subset of symbols.

A wireless device may assume that flexible symbols in a CORESET configured to the wireless device for PDCCH monitoring are downlink symbols if the wireless device does not detect an SFI-index field value in a DCI format (e.g., DCI format 2_0) indicating one or more symbols of a slot as flexible or uplink and the wireless device does not detect a DCI format 0_0, DCI format 0_1, DCI format 1_0, DCI format 1_1, or DCI format 2_3 indicating to the wireless device to transmit SRS, PUSCH, PUCCH, or PRACH in the one or more symbols.

For one or more symbols of a slot that are indicated as flexible by RRC configuration messages (e.g. TDD-UL-DL-ConfigurationCommon, and TDD-UL-DL-ConfigDedicated), or when RRC configuration messages are not provided to a wireless device, the wireless device may not detect a DCI format (e.g., DCI format 2_0) providing a slot format for the slot. The wireless device may receive PDSCH or CSI-RS in the one or more symbols of the slot if the wireless device receives a corresponding indication by a DCI format 1_0, DCI format 1_1, or DCI format 0_1. The wireless device may transmit PUSCH, PUCCH, PRACH, or SRS in the one or more symbols of the slot if the wireless device receives a corresponding indication by a DCI format 0_0, DCI format 0_1, DCI format 1_0, DCI format 1_1, or DCI format 2_3. The wireless device may receive PDCCH. If the wireless device is configured by higher layers to receive PDSCH or CSI-RS in the one or more symbols of the slot, the wireless device may not receive the PDSCH or the CSI-RS in the one or more symbols of the slot. If the wireless device is configured by higher layers to transmit SRS, or PUCCH, or PUSCH, or PRACH in the one or more symbols of the slot, the wireless device may not transmit the PUCCH, or the PUSCH, or the PRACH in the slot and may not transmit the SRS in symbols from the one or more symbols in the slot, if any, starting from a symbol that is a number of symbols equal to the PUSCH preparation time for the corresponding PUSCH timing capability after a last symbol of a CORESET where the wireless device is configured to monitor PDCCH for DCI format 2_0. The wireless device may not expect to cancel the transmission of the SRS, or the PUCCH, or the PUSCH, or the PRACH in symbols from the one or more symbols in the slot, if any, starting before a symbol that is a number of symbols equal to the PUSCH preparation time for the corresponding PUSCH timing capability after a last symbol of a CORESET where the wireless device is configured to monitor PDCCH for DCI format 2_0.

For unpaired spectrum operation for a wireless device on a cell in a frequency band of FR1, and when the scheduling restrictions due to RRM measurements are not applicable, if the wireless device detects a DCI format 0_0, DCI format 0_1, DCI format 1_0, DCI format 1_1, or DCI format 2_3 indicating to the wireless device to transmit in one or more symbols, the wireless device may not be required to perform RRM measurements based on a SS/PBCH block or CSI-RS reception on a different cell in the frequency band if the SS/PBCH block or CSI-RS reception comprise at least one symbol from the set of symbols.

In an example, a UE may be configured with sidelink (SL) operation. The UE may be provided a BWP for SL transmissions (SL BWP, e.g., by parameter SL-BWP-Config) with a first numerology and a first resource grid. The UE may receive the following SL synchronization signals in order to perform synchronization procedures based on S-SS/PSBCH blocks: SL primary synchronization signals (S-PSS) and SL secondary synchronization signals (S-SSS). The UE may assume that reception occasions of a physical sidelink broadcast channel (PSBCH), S-PSS, and S-SSS are in consecutive symbols and form a S-SS/PSBCH block.

For paired spectrum (e.g., FDD operation), an S-SS/PSBCH block can be transmitted/received in a slot of an UL carrier. For unpaired spectrum (e.g., TDD operation), an S-SS/PSBCH block can be transmitted/received in a slot of which all OFDM symbols are semi-statically configured as UL as per the higher layer parameter tdd-UL-DL-ConfigurationCommon of the serving cell if provided and/or sl-TDD-Configuration-r16 if provided or sl-TDD-Config-r16 of the received PSBCH if provided. Or if tdd-UL-DL-ConfigurationCommon and sl-TDD-Configuration are not provided for a spectrum, an S-SS/PSBCH block can be transmitted/received in any slot of the spectrum.

The UE may receive TDD configuration for sidelink, e.g., via sl-TDD-Configuration. For example, the sidelink TDD configuration parameter may indicate the TDD configuration associated with the reception pool of a cell indicated by sl-SyncConfigIndex. The sidelink TDD configuration, is similar to and based on the common TDD configuration of the cell (e.g., using tdd-UL-DL-ConfigurationCommon).

For transmission of an S-SS/PSBCH block, a UE includes a bit sequence a₀, a₁, a₂, a₃, . . . , a₁₁ in the PSBCH payload to indicate sl-TDD-Config and provide a slot format over a number of slots.

For paired spectrum, or if tdd-UL-DL-ConfigurationCommon and sl-TDD-Configuration are not provided for a spectrum, a₀, a₁, a₂, a₃, a₄, a₅, a₆, a₇, a₈, a₉, a₁₀, a₁₁ are set to ‘1’. Otherwise (e.g., for unpaired spectrum), a₀, a₁, a₂, a₃, a₄, a₅, a₆, a₇, a₈, a₉, a₁₀, a₁₁ values are determined based on parameters indicated by the common TDD configuration of the cell (tdd-UL-DL-ConfigurationCommon), e.g., based on whether pattern2 is configured or not, and/or based on periodicity P and P2, and/or based on the uplink symbols and/or downlink symbols indicated by the common TDD configuration, etc.

The usage scenarios that have been identified for 5G are enhanced mobile broadband (eMBB), massive machine-type communication (mMTC), and Ultra-Reliable and Low Latency communication (URLLC). Yet another identified area to locate the boundary between mMTC and URLLC would be time sensitive communication (TSC). In particular, mMTC, URLLC and TSC are associated with novel IoT use cases that are targeted in vertical industries. It is envisaged that eMBB, mMTC, URLLC and TSC use cases may all need to be supported in the same network.

One objective of 5G is to enable connected industries. 5G connectivity can serve as a catalyst for the next wave of industrial transformation and digitalization, which improves flexibility, enhances productivity and efficiency, reduces maintenance cost, and improves operational safety. Devices in such an environment include, e.g. pressure sensors, humidity sensors, thermometers, motion sensors, accelerometers, actuators, etc. It is desirable to connect these sensors and actuators to 5G radio access and core networks. The massive industrial wireless sensor network (IWSN) use cases and requirements described in 3GPP TR 22.804, TS 22.104, TR 22.832 and TS 22.261 include not only URLLC services with high requirements, but also relatively low-end services with the requirement of small device form factors, and/or being completely wireless with a battery life of several years.

Similar to connected industries, 5G connectivity can serve as catalyst for the next wave of smart city innovations. As an example, 3GPP TS 22.804 describes smart city use cases and requirements for smart city use cases. The smart city vertical covers data collection and processing to more efficiently monitor and control city resources and to provide services to city residents. The deployment of surveillance cameras is an essential part of the smart city but also of factories and industries.

Finally, the wearables use case includes smart watches, rings, eHealth related devices, medical monitoring devices, etc. One characteristic for the wearables use case is that the device is small in size.

As a baseline, the requirements for these use cases, also known as NR-Light, are device complexity, device size, and deployment scenarios. For device complexity, the main motivation for the new device type is to lower the device cost and complexity as compared to high-end eMBB and URLLC devices of Rel-15/Rel-16. This is the case for industrial sensors. For device size, the requirement for most use cases is that the standard enables a device design with compact form factor. For deployment scenarios, the system should support all FR1/FR2 bands for FDD and TDD. Use case specific requirements may include industrial wireless sensors, for which communication service availability is 99.99% and end-to-end latency less than 100 ms; the reference bit rate is less than 2 Mbps (potentially asymmetric e.g. UL heavy traffic) for all use cases and the device is stationary; the battery should last at least few years; for safety related sensors, latency requirement is lower, 5-10 ms. Use case specific requirements may include video surveillance, for which reference economic video bitrate would be 2-4 Mbps, latency <500 ms, reliability 99%-99.9%. High-end video (e.g., for farming) would require 7.5-25 Mbps. It is noted that traffic pattern is dominated by UL transmissions. Use case specific requirements may include wearables. Reference bitrate for smart wearable application can be 10-50 Mbps in DL and minimum 5 Mbps in UL and peak bit rate of the device higher, 150 Mbps for downlink and 50 Mbps for uplink. Battery of the device should last multiple days (up to 1-2 weeks).

Recognizing UE features and parameters with lower end capabilities, relative to Release 16 eMBB and URLLC NR, may help to serve the use cases mentioned above. Potential UE complexity reduction features may include: reduced number of UE RX/TX antennas; reduced UE bandwidth (e.g. Rel-15 SSB bandwidth may be reused and L1 changes minimized); Half-Duplex-FDD; relaxed UE processing time; and relaxed UE processing capability.

UE power saving may be enabled and battery lifetime enhancements may be considered for reduced capability UEs (RedCap UEs) in applicable use cases (e.g., delay tolerant use case). For example, by enabling reduced PDCCH monitoring by smaller numbers of blind decodes and CCE limits; and/or by enabling extended DRX for RRC Inactive and/or Idle; and/or enabling RRM relaxation for stationary devices. Functionalities may be enabled that mitigate or limit the performance degradation of such features and complexity reductions, e.g., coverage recovery to compensate for potential coverage reduction due to the device complexity reduction. Standardization framework and principles may be studied for how to define and constrain such reduced capabilities, considering the definition of a limited set of one or more device types and considering how to ensure those device types are used for the intended use cases. Functionalities may be studied that may allow devices with reduced capabilities (RedCap UEs) to be explicitly identifiable to networks and network operators and allow operators to restrict their access if desired.

As described above, many types of use scenarios are being envisaged and enabled for interfacing with 5G technologies. In some embodiments, these use scenarios are enabled through UEs that have different capabilities. For example, a UE may be one of and/or a variation/combination of the following types of wireless devices: an NB-IoT device, an eMTC device, an NR-Light (sometimes referred to as NR-Lite) device, a URLCC device, or an eMBB device. The NB-IoT device type and the eMTC device type may be part of the lower-power wide area IoT use case whereas the URLCC device type and the eMBB device type are for the full NR use case. For example, the eMBB device type may be a legacy UE such as a smartphone. In some embodiments, the RedCap UEs described above may be an NR-Light device type. In some embodiments, the RedCap UEs may be an NB-IoT device type or an eMTC device type. Unlike UEs of the URLLC device type or the eMBB device types, RedCap UEs may have limited hardware and related capabilities.

In some embodiments, reduction of UE bandwidth may be beneficial in terms of UE complexity reduction, e.g., in frequency range 1 and/or frequency range 2 (FR1 and/or FR2). For determining a RedCap UE bandwidth, one or more of the following may be considered: reusing legacy initial access scheme, SSB bandwidth, CORESET #0 configurations, initial BWP bandwidth, data rates needed for RedCap use cases, leverage of the LTE ecosystem (e.g., using the same bandwidth as LTE), UE cost saving consideration, UE power saving consideration, PDCCH performance (e.g., implication on the aggregation level), scheduling flexibility, or a combination thereof.

Reduction of UE bandwidth may be beneficial in terms of UE complexity reduction, e.g., in frequency range 1 and/or frequency range 2 (FR1 and/or FR2). For determining a RedCap UE bandwidth, the following may be considered: reusing legacy initial access scheme, SSB bandwidth, CORESET #0 configurations, initial BWP bandwidth, data rates needed for RedCap use cases, leverage of the LTE ecosystem (e.g., using the same bandwidth as LTE), UE cost saving consideration, UE power saving consideration, PDCCH performance (e.g., implication on the aggregation level), and scheduling flexibility.

For example, a UE bandwidth reduction, compared to a legacy UE bandwidth, to 20 MHz or lower (e.g., 5/10/15 MHz) in FR1 may be considered. The lowest bandwidth capability may not be less than LTE Category 1bis modem (20 MHz). For example, for low-end use cases, a 20 MHz UE bandwidth may be enough to achieve a data rate requirement. For example, for high-end use cases, such as small size wearables, 20 MHz may not be enough to achieve the 150 Mbps DL peak data rate for single antenna case. Considering that initial access should support different RedCap UEs, a 20 MHz bandwidth may be considered as the baseline for initial access in FR1. For example, 20 MHz may be useful for future RedCap unlicensed devices to support a Listen-Before-Talk (LBT) bandwidth of 20 MHz. For example, RedCap UEs may support at least a maximum of 20 MHz bandwidth in FR1. In FR1, the existing configuration options for SSB and CORESET #0 may be preserved, while reducing the specification impact when RedCap is introduced in Rel-17. The market acceptance of RedCap may be weakened if enabling RedCap support in the network comes at the cost of losing certain configuration options for SSB or CORESET #0. In FR1, CORESET #0 bandwidth can be up to 17.28 MHz. Therefore, a RedCap UE can be expected to support at least 20 MHz maximum channel bandwidth, at least during initial access. 20 MHz may also be considered as a sweet spot that balances device cost and required data rate for various services. Further reduction of maximum UE bandwidth may lead to diminishing gain in cost reduction and power saving, but significant loss in coverage, data rates, latency, scheduling flexibility, and coexistence with legacy NR UEs. For example, a 10 MHz bandwidth may be considered because it does not require specification change for initial access. For the low-to-mid end data rate services, no MIMO is needed if 20 MHz is assumed, which is beneficial for devices with small form factors. If a smaller bandwidth is used, e.g. 10 MHz, MIMO or CA might be needed for low-to-mid end data rate services, which can be challenging for certain devices. For example, 20 MHz channel bandwidth may be supported, and smaller bandwidth such as 10 MHz may also be considered at least for use cases not requiring high peak data rate such as low-end wearables.

In FR2, even more than in FR1, UE bandwidth reduction is a key feature to significantly reduce UE complexity and cost. For FR2, the RedCap UE may support 50 MHz and/or 100 MHz maximum UE bandwidth at least for initial access. A supported bandwidth of less than 80-100 MHz may have impacts due to PBCH and coreset selection. A supported bandwidth of 80 MHz may not provide significant UE cost savings and going below 80 MHz may have large specification impacts and legacy network impacts. 50 MHz and 100 MHz bandwidths are already specified for FR2, and may be preferred over the other proposals in order to minimize the impacts on specifications, implementations and deployments. In FR2, even though the maximum SSB bandwidth can be up to 57.6 MHz and CORESET #0 bandwidth can be up to 69.12 MHz, these SSB and CORESET #0 configuration options can still be used in cells supporting 50 MHz RedCap UEs. For example, a UE may need to skip certain SSB or PDCCH subcarriers outside of the UE receive bandwidth. This may result in some coverage loss that should be studied and that can be mitigated through suitable coverage recovery solution should SSB and PDCCH become the coverage limiting channels.

The legacy mobile broadband networks were designed to optimize performance mainly for human type of communications and thus, are not designed or optimized to meet the machine type communications (MTC) related requirements. The primary objective of MTC specific designs is to focus on the lower device cost, enhanced coverage, and reduced power consumption. To further reduce the cost and power consumption, it may be beneficial to further reduce the transmission/reception bandwidth of legacy systems (e.g., LTE or New Radio). The transmission/reception bandwidth for both control and data channels may be reduced (e.g., to 5 MHz or 10 MHz or 20 MHz or 50 MHz or 100 MHz). In general, it is envisioned that a large number of MTC/RedCap devices may be deployed for specific services within one cell in near future. When such a massive number of MTC/RedCap devices attempt to access and communicate with the network, multiple MTC regions/bandwidths (e.g., 20 MHz bandwidths) may be allocated by the base station.

A baseline UE bandwidth capability in FR1 may be 20 MHz. This bandwidth may be assumed during the initial access procedure and/or after the initial access procedure. An FR1 RedCap UE may optionally support a maximum bandwidth larger than 20 MHz after initial access. A baseline UE bandwidth capability in FR2 may be 100 MHz. This bandwidth may be assumed during the initial access procedure and/or after the initial access procedure. A same maximum UE bandwidth capability in a band may apply to radio frequency (RF) and/or baseband. The maximum UE bandwidth capability in a band may apply to data and/or control channels. The maximum UE bandwidth capability in a band may apply to DL and/or UL.

For FR1 FDD bands and FR2 bands where a non-RedCap UE is required to be equipped with a minimum of 2 Rx branches, a minimum number of Rx branches supported by a RedCap UE may be 1. A maximum number of DL MIMO layers may be 1 for a RedCap UE with 1 Rx branch. 2 Rx branches may be supported by a RedCap UE. A maximum number of DL MIMO layers may be 1 or 2 for a RedCap UE with 2 Rx branch. For FR1 TDD bands where a non-RedCap UE is required to be equipped with a minimum of 4 Rx branches, a minimum number of Rx branches supported by a RedCap UE may be one or two. A maximum number of DL MIMO layers may be 1 for a RedCap UE with 1 Rx branch. A maximum number of DL MIMO layers may be 1 or 2 for a RedCap UE with 2 Rx branch. For FR2 bands where a non-RedCap UE is required to be equipped with a minimum of 2 Rx branches, for a RedCap UE with 1 Rx branch, the maximum number of DL MIMO layers may be 1. For a RedCap UE with 2 Rx branches, the maximum number of DL MIMO layers may be 1 or 2.

A maximum mandatory modulation for RedCap may be relaxed, e.g., 64 QAM instead of 256 QAM for FR1 DL, 16 QAM instead of 64 QAM for FR1 UL, 16 QAM instead of 64 QAM for FR2 DL, and 16 QAM instead of 64 QAM for FR2 UL.

MIMO layer for RedCap may be restricted to one or two layers. Transport block size (TBS) may implicitly be restricted due to reduced UE bandwidth and/or reduced number of MIMO layers. Other TBS restrictions may or may not be considered for RedCap UE.

For FR1, under the consideration of potential reduced antenna efficiency due to device size limitations, a loss (e.g., maximum isotropic loss (MIL)) of PUSCH and/or Msg3 may be worse than that of the bottleneck channel for the reference NR UE and coverage recovery may be needed. The amount of coverage recovery may be up to 3 dB. For other UL channels, coverage recovery may not be needed. For FR1 including both FDD and TDD bands and RedCap UE with 2 Rx and reduced antenna efficiency, the losses of all the downlink channels may be better than that of the bottleneck channel for the reference NR UE and coverage recovery may not be needed. For RedCap UE with 1 Rx and reduced antenna efficiency, dependent on frequency bands and the assumption of DL power spectral density (PSD), the need for coverage recovery can be different. For example, for carrier frequency of 4 GHz with DL PSD 24 dBm/MHz, coverage recovery may be needed for the downlink channels of Msg2, Msg4 and PDCCH CSS. For other carrier frequencies or DL PSD other than 24 dBm/MHz, coverage recovery may not be needed for the downlink channels. For FR2, there may be no assumption of reduced antenna efficiency for RedCap UE and the losses of the UL channels may be the same as the reference NR UE and coverage recovery for UL channels may not be needed. For RedCap UE with 100 MHz BW and 1Rx, although there may be performance loss from reducing the number of Rx branches to 1, the losses of the DL channels may be better than that of the bottleneck channel for the reference NR UE and coverage recovery for DL channels may not be needed. For RedCap UE with 50 MHz BW and 1Rx, coverage recovery may be needed for PDSCH, e.g., when the same target data rate as the reference NR UE is assumed, and the amount of coverage recovery to be considered may be approximately [2-3 dB].

Coverage recovery for broadcast PDCCH (e.g., PDCCH monitored in a Type0/0A/1/2/3-PDCCH CSS) may comprise PDCCH repetition, compact DCI, new aggregation level (AL) [e.g., 12, 24 or 32], PDCCH transmission via CORESET or search space bundling, PDCCH-less mechanism for SIB1 and/or SI message. Coverage recovery for PUSCH may comprise cross-slot or cross-repetition channel estimation, lower DM-RS density in time domain, enhancements on PUSCH repetition Type A and/or Type B, frequency hopping or BWP switching across a larger system bandwidth. Coverage recovery for PDSCH may comprise the use of the lower-MCS table, larger aggregation factor for PDSCH reception, cross-slot or cross-repetition channel estimation, increasing the granularity of PRB bundling, frequency hopping or BWP switching across a larger system bandwidth. Coverage recovery for Msg2 PDSCH may comprise TBS scaling and/or Msg2 PDSCH repetition. A mechanism for differentiating enhanced UE (supporting coverage recovery) and legacy UE may be needed. The mechanism may comprise separate PRACH configurations (e.g., separate PRACH occasions and/or preambles). Coverage recovery for Msg3 may comprise repetition for Msg3 PUSCH initial and/or retransmission. Coverage recovery for Msg4 PDSCH may comprise a scaling factor for TBS determination, PDSCH repetition, and/or using a lower-MCS table.

Identification of RedCap UEs may be done during Msg1 (PRACH) transmission. The options may comprise separate initial UL BWP, and/or separate PRACH resources, and/or PRACH preamble partitioning. Identification of RedCap UEs may be done during Msg3 (PUSCH) transmission. The options may comprise using the spare bit in existing Msg3 definition; extending the Msg3 size to carry additional one or more bits, indicating RedCap UE type(s). Identification of RedCap UEs may be done after Msg4 acknowledgement, e.g., during Msg5 (PUCCH) transmission and/or part of UE capability reporting. Identification of RedCap UEs may be done during MsgA (PRACH+PUSCH) transmission, e.g., if 2-step RACH is supported for RedCap UEs.

Early identification of RedCap UE type(s) during transmission of Msg1 may be necessary for: coverage recovery (including link adaptation) for one or more of: Msg2 PDCCH/PDSCH, Msg3 PUSCH and PDCCH scheduling Msg3 reTx, Msg4 PDCCH/PDSCH or PUCCH in response to Msg4, Msg5 PUSCH and associated PDCCH (e.g., if it is determined that coverage recovery for RedCap UEs is necessary for one of more of these channels); identifying UE minimum processing times capabilities for PDSCH processing and PUSCH preparation (e.g., if relaxations to UE min processing times are defined for N1 and N2); identifying UE capability for UL modulation order for Msg3 and Msg5 scheduling (e.g., if relaxations to max UL modulation order (i.e., UL modulation order restricted to lower than 64 QAM) are introduced); identifying UE max bandwidth capability for Msg3 and Msg5 scheduling and PUCCH in response to Msg4. If early identification of RedCap UE type(s) during Msg1 transmission is not supported, identification of RedCap UE type(s) during transmission of Msg3 may be necessary for coverage recovery (including link adaptation) for one or more of: Msg4 PDCCH/PDSCH, Msg5 PUSCH and associated PDCCH.

Identification of RedCap UE type(s) during transmission of Msg1 may enable efficient handling of different UE minimum processing times between RedCap and non-RedCap UEs for: minimum timing between PDSCH carrying RAR and start of Msg3 PUSCH; minimum timing between PDSCH carrying Msg4 and the corresponding HARQ-ACK feedback; minimum timing between PDCCH with the reTx grant and the corresponding Msg3 PUSCH retransmission, if relaxed UE min processing times are introduced for RedCap UEs. Identification of RedCap UE type(s) during transmission of Msg1 may enable coverage recovery, including link adaptation, for any one or more of: broadcast PDCCH, PDSCH associated with Msg2, PDSCH associated with Msg4, and PUSCH associated with Msg3, if coverage recovery is needed for these channels. The option of configuring separate initial UL BWPs, in addition to the above pros, may enable addressing congestion (if congestion may occur) in the initial UL BWP that may otherwise need to be restricted to the mandatory required BW for RedCap UEs in the band/FR.

Identification of RedCap UE type(s) during transmission of Msg1 may result in potential reduction in PRACH user capacity (for the options based on separation of PRACH preambles), impacting both RedCap and non-RedCap UEs respectively, e.g., if the total PRACH resources in the cell is not increased. The exact impact may depend on numbers of device type(s)/sub-types/capabilities to be identified and exact details of PRACH preamble partitioning schemes. Identification of RedCap UE type(s) during transmission of Msg1 may result in potential increase in UL overhead from PRACH (for the options based on separation of PRACH resources), impacting both RedCap and non-RedCap UEs. Identification of RedCap UE type(s) during transmission of Msg1 may result in potential increase in UL overhead and complexity in configuration and maintenance of multiple initial UL BWP for the gNodeB, for the option of configuring separate initial UL BWPs. Identification of RedCap UE type(s) during transmission of Msg1 may result in higher impact to RANI and RAN2 specifications as well as increased SIB signaling overhead compared to other options. The indication mechanisms in this category may be limiting in terms of the number of further sub-types/capabilities within RedCap device type that may be distinguished, if such sub-types/capability indication are introduced.

Identification of RedCap UE type(s) during transmission of Msg3 may enable coverage recovery (if needed) and/or appropriate link adaptation for PDSCH (and associated PDCCH and PUCCH) for Msg4, and scheduling of Msg5. The option of extending Msg3 size may offer good scalability in the number of bits for such UE identification; e.g., if sub-types of RedCap device types (if defined) are to be indicated in Msg3. If only the spare bit in Msg3 is used, it would consume the single spare bit currently available in Msg3 payload, and this may not be desirable. The option of only using the spare bit in Msg3 scales poorly—limiting to a single-bit indication may not be sufficient if intending to distinguish between further sub-types/capabilities within RedCap device type, if RedCap UE sub-types/capabilities are defined in the context of RedCap UE identification. Cannot facilitate additional coverage recovery (including separate link adaptation) for broadcast PDCCH and/or Msg2 PDSCH, and/or Msg3 PUSCH (and associated PDCCH) for RedCap UEs. If extended Msg3 size is introduced, mechanisms to enable detection between use of legacy Msg3 and extended Msg3 definitions necessary. If UE minimum processing times are relaxed, cannot facilitate scheduling with separate minimum timing relationships for RedCap UEs (compared to non-RedCap UEs) between PDSCH carrying RAR and start of Msg3 PUSCH; minimum timing between PDCCH with the reTx grant and the corresponding Msg3 PUSCH retransmission. This could result in increased initial access latency for non-RedCap UEs. Extending Msg3 size may degrade reliability/coverage of Msg3. Extending Msg3 size may not address the issue where Msg3 is scheduled with a bandwidth/hopping range larger than the maximum RedCap UE bandwidth in the UL initial BWP.

Identification of RedCap UE type(s) during transmission of Msg5 or in UE capability report may offer a simple option for indication of RedCap UE type, including possibility of indicating further RedCap sub-types/capabilities if introduced. Identification of RedCap UE type(s) during transmission of Msg5 or in UE capability report may not facilitate additional coverage recovery (if needed) or separate link adaptation for broadcast PDCCH and/or Msg2 and/or Msg4 PDSCH, and/or Msg3 PUSCH for RedCap UEs. Too conservative scheduling and link adaptation for all UEs imply increased system overhead for initial access in the initial DL and UL BWPs. If UE minimum processing times are relaxed, identification of RedCap UE type(s) during transmission of Msg5 or in UE capability report cannot facilitate scheduling with separate minimum timing relationships for RedCap UEs between PDSCH carrying RAR and start of Msg3 PUSCH; minimum timing between PDSCH carrying Msg4 and the corresponding HARQ-ACK feedback; minimum timing between PDCCH with the reTx grant and the corresponding Msg3 PUSCH retransmission. This could result in increased initial access latency for non-RedCap UEs. Identification of RedCap UE type(s) during transmission of Msg5 or in UE capability report cannot address the issue where Msg3 or PUCCH in response to Msg4 or Msg5 is scheduled with a bandwidth/hopping range larger than the maximum RedCap UE bandwidth in the UL initial BWP.

One or more RedCap UE type/category/definition may be considered/defined. At least for RedCap UE identification, explicit definition of RedCap UE type(s) may be needed. One or more reduced capabilities may be recommended for RedCap from the followings: Reduced number of UE Rx branches; UE bandwidth reduction; Half-duplex FDD operation; Relaxed UE processing time; Relaxed maximum number of MIMO layers; and Relaxed maximum modulation order.

The definition of the RedCap UE types may be based on one of the followings: (1) All the reduced capabilities recommended for RedCap; (2) a subset of reduced capabilities recommended for RedCap, e.g., only the reduced capabilities that the network needs to know during initial access, if any; (3) All the recommended reduced capabilities as well as recommended power saving features; and (4) The corresponding minimum set of the reduced capabilities that one RedCap UE type shall mandatorily support.

If early identification during initial access is supported, at least maximum supported UE bandwidth during initial access (e.g., 20 MHz for FR1 and 100 MHz for FR2) is included in the set of capabilities of the device type for RedCap early identification. This may not preclude the case where the early indication only indicates whether it is a RedCap UE or which type of the RedCap UEs if multiple UE types are defined.

As a baseline, the existing UE capabilities framework may be used to indicate the capabilities of RedCap UEs. For example, the UE may report its radio access capabilities at least when the network requests the UE to do so.

The network may control whether RedCap UEs can access the cell and differentiate them from other, non-RedCap UEs. The number of different UE types should be minimized to reduce market fragmentation, and UE types may be introduced only where essential to control UE accesses and differentiate them from other non-RedCap UEs.

The UE capabilities can be categorized as: (1) Minimum mandatory capabilities that all RedCap UEs support, if identified; and (2) Optional capabilities, to be signaled explicitly.

For capability signaling of RedCap UEs, the following scenarios may be possible, however feasibility, applicability of the cases and the final division to categories may depend on the exact RedCap capabilities. For the features that are mandatory for non-Redcap UEs: (1) The Redcap UE mandatorily supports the feature with the same value; (2) The Redcap UE mandatorily supports the feature, but with different value (e.g. bandwidth value); (3) The Redcap UE optionally supports the feature; and (4) The Redcap UE does not support the feature at all. For the features that are optional for non-Redcap UEs: (1) The Redcap UE does not support the feature at all; (2) The Redcap UE supports the feature with a different value; (3) The Redcap UE supports the feature with the same value; and (4) The Redcap UE mandatorily supports the feature.

Based on the above categorization and possible scenarios, the following capability design principal alternatives may be considered. In an example, the UE capability requirements for a RedCap device type, that are different from those for non-RedCap UEs, may be listed in the specifications, comprising mandatory features for non-RedCap UEs that are not applicable for RedCap UEs; mandatory features for non-RedCap UEs that are optional for RedCap UEs; mandatory features for non-RedCap UEs that are supported for RedCap UEs but with different value; optional features for non-RedCap UE that are not applicable for RedCap UE; and optional features for non-RedCap UE that are mandatorily supported for RedCap UE. For a RedCap device type, new signaling fields may be defined in UE capability signaling for the features that are mandatory without capability signaling for non-RedCap UEs but are optional for Redcap UEs, or mandatory with capability signaling for non-RedCap UEs but with different value for RedCap UEs. Such new signaling may be only applicable for RedCap UEs. In an example, the UE capabilities required for RedCap devices may be directly defined, including mandatory features for RedCap UEs (e.g., defined in specification); and optional features for Redcap UEs (e.g., signaling fields in an independent container may be defined specifically for Redcap UE).

A set of mandatory features/capabilities may be defined for RedCap devices (e.g., baseline capabilities such as handover). The network may know if a UE is RedCap or not, e.g., in order correctly identify the set of mandatory features.

The network should know whether the UE is a RedCap UE or not in order to handle UE capabilities properly. The following options, which do not need to be mutually exclusive, may be considered: (1) RedCap device type is indicated as part of the capability signaling; (2) a new IE is defined specifically for RedCap UEs containing RedCap-specific capabilities. The IE may be included in the signaling only by Redcap UEs; (3) The network identifies RedCap UEs based on identification solution, e.g. during Msg1, Msg3, MsgA, etc. The identification is forwarded to target gNB during handover; and (4) The network identifies RedCap UE based on the reported capabilities, assuming the identification can be done through RedCap-specific capabilities not used by non-RedCap UEs.

RedCap UEs and non-RedCap UEs may share the same SSB (SS/PBCH Block) and/or CORESET #0. For example, a RedCap UE and a non-RedCap UE may detect and/or receive the cell-defining SSB of the cell on the synchronization raster. For example, the bandwidth of the SSB and CORESET #0 may not be wider than the RedCap UE bandwidth capability. The SSB may comprise PBCH. The PBCH may comprise MIB. The MIB may comprise configuration parameters of CORESET #0 and/or information for receiving SIB1 via CORESET #0. The RedCap UE and the non-RedCap UE may receive the SIB1 via CORESET #0. SIB1 may comprise configuration information of the cell and/or BWPs of the cell comprising initial BWP(s).

In an example, SIB1 may configure an initial UL BWP and an initial DL BWP (BWP #0). In an example, SIB1 may not configure an initial DL BWP. For example, a UE may not be provided initialDownlinkBWP. The UE may determine the initial DL BWP based on MIB. For example, an initial DL BWP may be defined/indicated by a location and bandwidth of CORESET #0 indicated by MIB. For example, the initial DL BWP may be indicated by the location and a number of contiguous physical resource blocks (PRBs), starting from a PRB with a lowest index and ending at a PRB with a highest index among PRBs of a CORESET for TypeO-PDCCH CSS set (e.g., CORESET #0). The initial DL BWP may be defined by a SCS and a cyclic prefix for PDCCH reception in the CORESET for Type0-PDCCH CSS set.

In an example, the bandwidth of the initial DL BWP may not be wider than the RedCap UE bandwidth capability. The initial DL BWP may be indicated by MIB and/or SIB1. The RedCap UE and the non-RedCap UE may share the initial DL BWP, e.g., when the bandwidth is not wider than RedCap UE bandwidth capability (e.g., maximum RedCap UE bandwidth). The RedCap UE and/or the non-RedCap UE may use the initial DL BWP indicated/configured by MIB, at least during the initial access. In an example, the RedCap UE and/or the non-RedCap UE may use a second initial DL BWP configured/indicated by SIB1. The second initial DL BWP may have a bandwidth wider than the RedCap UE bandwidth capability. The RedCap UE may not use the second initial DL BWP. The RedCap UE may use the MIB-configured initial DL BWP, whose bandwidth is not wider than RedCap UE bandwidth capability.

In an example, SIB1 may configure an initial UL BWP. The bandwidth of the initial UL BWP may not be wider than the RedCap UE bandwidth capability. The RedCap UE and the non-RedCap UE may share the initial UL BWP, e.g., when the bandwidth is not wider than RedCap UE bandwidth capability. The RedCap UE and/or the non-RedCap UE may use the initial UL BWP indicated/configured by SIB1, at least during the initial access.

In an example, a RedCap UE may operate with an initial DL BWP and/or initial UL BWP with a bandwidth wider than the RedCap UE bandwidth capability, e.g., at least during initial access (RRC_IDLE and/or RRC_INACTIVE state) and/or after initial access (RRC_CONNECTED state).

In an example, during initial access, the bandwidth of the initial DL BWP for RedCap UEs may not be expected to exceed the maximum RedCap UE bandwidth. The bandwidth and location of the initial DL BWP for RedCap UEs may be the same as the bandwidth and location of the MIB-configured initial DL BWP for non-RedCap UEs. The network may configure a SIB-configured initial DL BWP for non-RedCap UEs with a wider bandwidth than the maximum RedCap UE bandwidth. The network may configure a separate/additional bandwidth and location for initial DL BWP for RedCap UEs.

A RedCap UE may not be configured with a non-initial (DL and/or UL) BWP (i.e., a BWP with a non-zero index) wider than the maximum bandwidth of the RedCap UE. In an example, at least for FR1, FG 6-1 (Basic BWP operation with restriction) may be used for the RedCap UE type capability. This may not preclude support of FG 6-1a (BWP operation without restriction on BW of BWP(s)) as a UE capability for RedCap UEs.

In an example, during and/or after initial access, the initial UL BWP for non-RedCap UEs may be configured to be wider than the maximum RedCap UE bandwidth. A separate initial UL BWP no wider than the RedCap UE maximum bandwidth may be configured/defined for RedCap UEs, e.g., during and/or after initial access, e.g., for the scenario where the initial UL BWP for non-RedCap UEs is configured to be wider than the RedCap UE bandwidth. A separate initial UL BWP may optionally be configured/defined for RedCap UEs even for the scenario where the initial UL BWP for non-RedCap UEs is not configured to be wider than the RedCap UE bandwidth, e.g., during and/or after initial access. RACH resources (e.g., RACH occasions) may be shared between RedCap UEs and non-RedCap UEs. For example, the RACH occasions in RedCap (separate) initial UL BWP may overlap with RACH occasions in the non-RedCap initial UL BWP. In an example, separate/dedicated RACH occasions for RedCap may be configured.

In an example TDD system/cell operating in an unpaired spectrum, the center frequency may be the same for the initial DL BWP and initial UL BWP. In an example TDD system/operation/cell, the center frequency may not be the same for the initial DL BWP and initial UL BWP. In an example TDD operation/system/cell, the center frequency is assumed to be the same for the separate initial DL BWP and the separate initial UL BWP, e.g., if a separate initial DL BWP is configured. In an example TDD operation/system/cell, the center frequency is assumed to be the same for the MIB-configured initial DL BWP and the separate initial UL BWP, e.g., if a separate initial DL BWP is not configured.

At least for TDD, an initial DL BWP for RedCap UEs (which is not expected to exceed the maximum RedCap UE bandwidth) may be optionally configured/defined separately from the initial DL BWP for non-RedCap UEs, e.g., at least after initial access. The configuration for a separately configured initial DL BWP for RedCap UEs may be signaled in SIB (e.g., SIB1). The separate initial DL BWP for RedCap UEs may include a configuration of CORESET and CSS(s). The separate initial DL BWP for RedCap UEs may include CORESET and CSS(s) at least for RACH and paging (e.g., TypeOA-PDCCH CSS set configured by searchSpaceOtherSystemInformation and/or Type2-PDCCH CSS set configured by pagingSearchSpace and/or Type1-PDCCH CSS set configured by ra-SearchSpace). In an example, part of the configuration may be defined instead of signaled. If a separate initial DL BWP for RedCap UEs is configured/defined, this separate initial DL BWP for RedCap UEs may be used at least after initial access (i.e., at least after RRC Setup, RRC Resume, or RRC Reestablishment). In an example, the separate initial DL BWP for RedCap UEs may be used during initial access. A separately configured initial DL BWP for RedCap UEs may or may not contain the entire CORESET #0. Additional SSB may or may not be transmitted in the separately configured initial DL BWP for RedCap UEs (e.g., cell-defining SSB or non-cell defining SSB).

In an example, for idle/inactive/connected mode in separate initial DL BWP for RedCap in FR1 and/or FR2, If CSS for Paging is configured in the separate initial DL BWP, then SSB may be transmitted in the separate initial DL BWP (e.g., non-cell defining SSB). In an example, if (only) CSS for random access is configured in the separate initial DL BWP, then SSB transmission in the separate initial DL BWP may be configurable by the network. In an example, if the separate initial DL BWP is only configured for random access but not for paging, then the UE may not expect SSB transmission in the separate initial DL BWP. The network may or may not configure SSB in this case. In an example, for connected mode in non-initial DL BWP for a RedCap UE, SSB may be transmitted if required by the UE capabilities. In an example, if the separate initial DL BWP is configured for paging, then the UE may expect SSB transmission in the separate initial DL BWP. In an example, if a separate initial DL BWP for RedCap UEs is configured, then the UE may not expect it to contain MIB-configured CORESET #0 and/or SIB1. The network may or may not configure MIB-configured CORESET #0 and/or SIB1 to be within the separate initial DL BWP. In an example, if an RRC-configured DL BWP is configured, then the UE may not expect it to contain MIB-configured CORESET #0 and/r SIB1. The network may or may not configure MIB-configured CORESET #0 and/or SIB1 to be within the RRC-configured DL BWP. In connected mode, the UE may not be required to monitor CORESET #0 periodically for SI updates.

For a RedCap UE in connected mode in an RRC-configured active DL BWP, the UE may expect SSB transmission in the RRC-configured active DL BWP, e.g., depending on its UE capabilities (whether it supports FG 6-1a or only FG 6-1). A UE not supporting operation without SSB transmission in the RRC-configured active DL BWP may expect SSB transmission in the RRC-configured active DL BWP. This may be mandatory RedCap UE feature. A UE optionally supporting operation without SSB transmission in the RRC-configured active DL BWP may not expect SSB transmission in the RRC-configured active DL BWP. This may be optional RedCap UE feature.

In TDD when a separate initial UL BWP is configured for RedCap, the PUSCH resource fragmentation for non-RedCap UEs may be minimized by considering one of the following options for RedCap: (1) Different center frequencies for initial UL/DL BWPs and/or the initial DL BWP containing the entire CORESET #0; (2) Same center frequency for initial UL/DL BWPs and the initial DL BWP not necessarily containing CORESET #0.

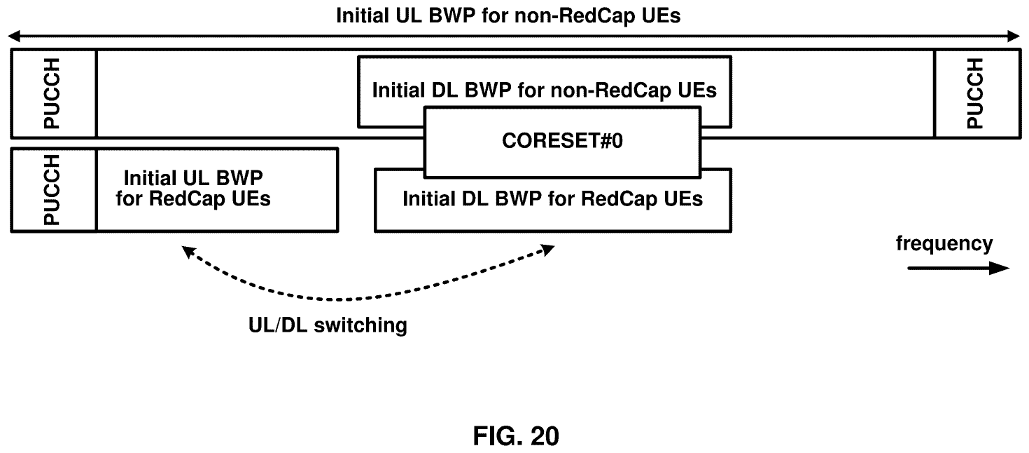

FIG. 20 shows an example scenario for RedCap initial BWP configuration/deployment in a TDD system/cell, according to some embodiments. As shown in the example of FIG. 20, the network may configure an initial DL BWP for non-RedCap UEs that is defined/indicated by MIB based on location and bandwidth of CORESET #0. The network may configure a shared/same initial DL BWP for RedCap UEs. For example, the RedCap UEs may determine the initial DL BWP based on location and bandwidth of CORESET #0. The bandwidth of the RedCap initial DL BWP may not be wider than the RedCap bandwidth capability. The bandwidth of the RedCap initial DL BWP may comprise CORESET #0 and/or SSBs.

As shown in the example of FIG. 20, the network may configure an initial UL BWP for non-RedCap UEs, e.g., by SIB/SIB1. The center frequency of the initial UL BWP and initial DL BWP for non-RedCap UEs may be the same in this TDD operation. The bandwidth of the initial UL BWP may be wider than the RedCap bandwidth capability. The network may configure PUCCH resources for the non-RedCap UEs with frequency hopping across the initial UL BWP. The network may configure a separate initial UL BWP for RedCap UEs. The bandwidth of the RedCap initial UL BWP may not be wider than the RedCap bandwidth capability. The network may configure the RedCap initial UL BWP at the edge of the carrier and/or without frequency hopping for PUCCH, such that a fragmentation of uplink resources (e.g., PUSCH resources) for non-RedCap UEs may be minimized/avoided.

As shown in FIG. 20, the center frequency of the initial UL BWP for RedCap UEs and the center frequency of the initial DL BWP for RedCap UEs may be different in this TDD operation. Throughout this disclosure, the deployment/configuration scenario shown in FIG. 20 may be referred to as “Scenario-1”, for simplicity. Throughout this disclosure, in Scenario-1, the center frequency of the initial DL BWP for RedCap and the initial UL BWP for RedCap may be different in TDD system. Throughout this disclosure, in Scenario-1, the initial DL BWP for RedCap may comprise/contain SSB(s) and/or CORESET #0.

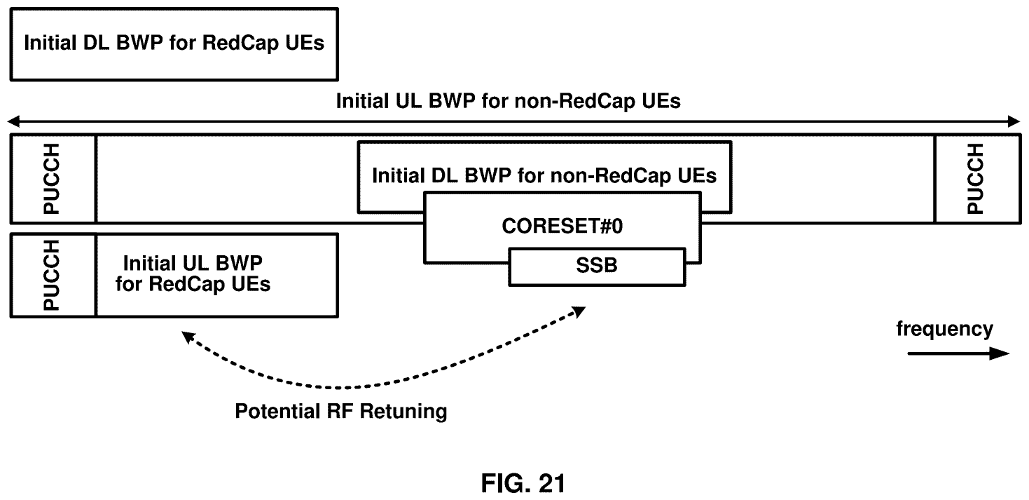

FIG. 21 shows an example scenario for RedCap initial BWP configuration/deployment in a TDD system/cell. As shown in the example of FIG. 21, the network may configure an initial DL BWP for non-RedCap UEs that is defined/indicated by MIB based on location and bandwidth of CORESET #0. The network may configure a separate initial DL BWP for RedCap UEs. For example, the RedCap UEs may determine the initial DL BWP based on configuration information received by SIB/SIB1/RRC message. The bandwidth of the RedCap initial DL BWP may not be wider than the RedCap bandwidth capability. The bandwidth of the RedCap initial DL BWP may or may not comprise CORESET #0 and/or SSBs.

As shown in the example of FIG. 21, the network may configure an initial UL BWP for non-RedCap UEs, e.g., by SIB/SIB1. The center frequency of the initial UL BWP and initial DL BWP for non-RedCap UEs may be the same in this TDD operation. The bandwidth of the initial UL BWP may be wider than the RedCap bandwidth capability. The network may configure PUCCH resources for the non-RedCap UEs with frequency hopping across the initial UL BWP. The network may configure a separate initial UL BWP for RedCap UEs. The bandwidth of the RedCap initial UL BWP may not be wider than the RedCap bandwidth capability. The network may configure the RedCap initial UL BWP at the edge of the carrier and/or without frequency hopping for PUCCH, such that a fragmentation of uplink resources (e.g., PUCCH resources) for non-RedCap UEs may be minimized/avoided.

As shown in FIG. 21, the center frequency of the initial UL BWP for RedCap UEs and the center frequency of the initial DL BWP for RedCap UEs may be the same in this TDD operation. Throughout this disclosure, the deployment/configuration scenario shown in FIG. 21 may be referred to as “Scenario-2”, for simplicity. Throughout this disclosure, in Scenario-2, the center frequency of the initial DL BWP for RedCap and the initial UL BWP for RedCap may be the same in TDD system. Throughout this disclosure, in Scenario-2, the initial DL BWP for RedCap may not comprise SSB(s) and/or CORESET #0.

Scenario-1 and Scenario-2 may have some performance tradeoffs for the RedCap and/or non-RedCap UEs, and/or for the network operation.

In Scenario-1, for TDD with different center frequencies for initial UL/DL BWPs, due to the relaxed timing between UL and DL transmissions during initial access, there may be ample time to perform the RF switching required between reception in the initial DL BWP and transmission in the initial UL BWP. For example, with existing configuration parameters in NR, the DL receptions in the initial DL BWP related to system information reception, RAR, Msg4, and/or Msg3 retransmission requests may be configured to be separated in time from the UL transmissions related to PRACH, Msg3, and/or Msg4 acknowledgement. Additional constraints applicable for RedCap UEs may be introduced in the standard such that the BWP switching may be accommodated within the switching delay requirements applicable for a RedCap UE. However, due to overlap with non-RedCap initial DL BWP, the initial DL BWP may be congested.

As an example, the following delays can be configured between the different transmissions during Random Access for legacy UEs using 30 kHz SCS according to Rel-15: The RAR window can be configured up to 80 slots, but constrained to maximum 10 ms (=20 slots for 30 kHZ SCS); The Msg3 transmission can be transmitted up to 6 slots after RAR reception by default, but up to 32 slots if an RRC configured time domain resource allocation table is used for PUSCH; The contention resolution window, i.e. the time for monitoring Msg4, can be configured up to 64 subframes, i.e., 128 slots for 30 kHz SCS; The Msg4 HARQ acknowledgement can be configured to be transmitted up to 15 slots after Msg4 PDSCH reception. Based on the above, there may be enough time for potential frequency retuning needed between UL and DL bandwidth parts when they have different center frequencies. In an example, there may be constraints defined for RedCap UEs on acceptable ranges of values for existing configuration parameters in order to guarantee sufficient switching times. If, despite the above, this is not considered enough in some cases, and/or if separate times should apply for legacy/non-RedCap and RedCap UEs, it would also be possible to introduce some modified configuration parameters applicable for RedCap devices only. Alternatively, some additional delays applicable for RedCap UEs can be introduced in the standard.

In Scenario-2, for TDD with same/common center frequencies for initial (and/or non-initial) UL/DL BWPs, it may be advantageous to configure the UL/DL BWPs for RedCap UEs to be located at the edge of the system bandwidth for avoiding or minimizing PUSCH resource fragmentation. The RedCap UE may then occasionally need to retune to the frequency of the initial DL BWP for non-RedCap UEs, for example to monitor CORESET #0 in order to reacquire SIB1. It is possible to introduce constraints or relaxations on DL reception and/or UL transmissions for a RedCap UE in connection with CORESET #0 monitoring, such that any switching can be accommodated within the switching delay requirements applicable for a RedCap UE. Such constraints or relaxations may be applicable also in FDD when the active DL BWP does not contain CORESET #0.

The RedCap UE may need to frequently switch between DL frequency and UL frequency, e.g., in Scenario-1 as shown in FIG. 20, because of the unaligned center frequencies of initial UL BWP (e.g., for RedCap UE) and initial DL BWP (e.g., for RedCap UE), e.g., between uplink transmission and downlink receptions. The RedCap UE may need to frequently perform RF retuning (e.g., adjusting the operating frequency of RF hardware and filters), e.g., in Scenario-2 as shown in FIG. 21, in order to be able to monitor the SSBs for measurement purposes outside the active DL BWP (e.g., for RedCap UE) (when the initial DL BWP (e.g., for RedCap UE) is active). The measurements may comprise measurement(s) (e.g., RSRP and/or RSRQ) of pathloss reference signal(s) and/or measurement(s) for RRM and/or RLM.

Legacy/non-RedCap UEs may be capable of supporting a wide bandwidth and/or may not require frequent RF retuning frequently. RedCap devices may frequently perform the RF returning (e.g., retune between the UL and DL frequencies) due to the limited bandwidth capability of the RedCap devices. RF retuning is a power consuming operation, and/or may not be efficient for RedCap devices with various constraints (e.g., limited bandwidth capability) if the RF returning is frequently repeated.

One reason that may require a RedCap UE to retune between the UL and DL frequencies, may be the semi-static TDD configuration/pattern (e.g., TDD-UL-DL-ConfigCommon and/or TDD-UL-DL-ConfigDedicated). The semi-static TDD configuration may be a cell-specific/common configuration that indicates the slot format to a plurality of UEs in the TDD cell (e.g., all UEs in the coverage area of the TDD cell). The slot format may indicate a format (e.g., communication direction (e.g., uplink or downlink or flexible)) of each symbol in a slot. A broadcast message (e.g., SIB, and/or SIB1) may comprise the semi-static TDD configuration. For example, the semi-static TDD configuration may indicate that a symbol is UL symbol (e.g., as a format of the symbol), so that the UEs may perform uplink transmissions during a duration of the symbol and/or may not monitor for downlink reception during the duration of the symbol. Transmissions and receptions in the cell may be compatible with the format (e.g., communication direction) indicated by this semi-static TDD configuration/pattern. For example, downlink signals/channels may be received only during ‘D’ (DL symbols) and/or ‘F’ (flexible symbols), and/or uplink signals/channels may only be transmitted during ‘U’ (UL symbols) and/or ‘F’ symbols.

A cell may be in operation supporting a plurality of types of wireless devices. For example, the plurality of types of wireless devices may comprise a non-RedCap UE. For example, the plurality of types of wireless devices may comprise a RedCap UE. For example, the plurality of types of wireless devices may comprise an IoT (Internet of Thing) device. For example, the plurality of types of wireless devices may comprise a sidelink UE. Each type of wireless device may have different capability and/or limitation for transmissions and/or receptions. A single or common semi-static TDD configuration for the plurality of types of wireless devices may not fulfill the performance requirements of each type of wireless devices. In a cell that supports both RedCap and non-RedCap UEs, the uplink transmission(s) and/or downlink reception(s) may be separately configured and/or scheduled for RedCap UEs. For example, due to the RedCap device constraints, relaxed timing may be considered/used by the network towards scheduling transmissions/receptions for RedCap UEs compared to non-RedCap UEs. In an example, different procedures and/or parameters may be configured/employed for RedCap UEs, such as longer time offsets and/or relaxed processing times, e.g., longer RAR window. This may result in a parallel/in-band operation of RedCap devices and non-RedCap devices in a same cell/frequency region but with independent and potentially different time management. For example, at a cell level, resources for uplink transmissions and downlink receptions of RedCap devices and non-RedCap devices may not be aligned in a time domain. Therefore, using a common semi-static TDD configuration for RedCap and non-RedCap UEs may not be efficient.

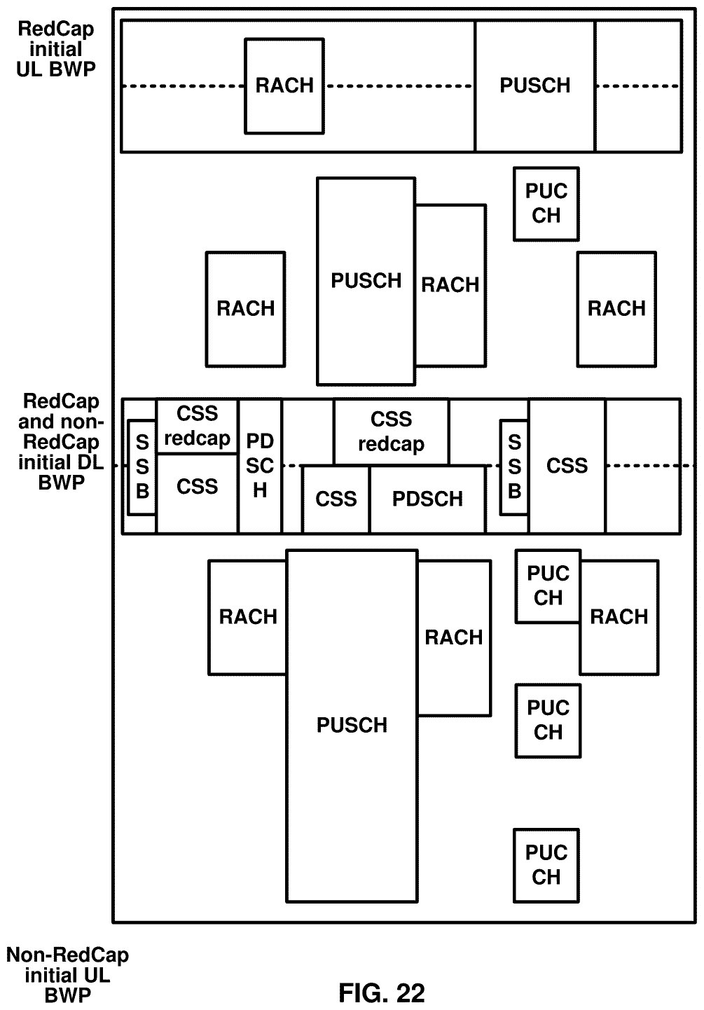

FIG. 22 shows an example of RedCap and non-RedCap operation in a TDD cell, based on Scenario-1, where separate initial UL BWP is configured for RedCap, and a center frequency of the initial UL BWP and initial DL BWP for RedCap is different. As shown in FIG. 22, uplink and downlink scheduling/configuration for RedCap and non-RedCap may not be aligned in the time domain, e.g., during and/or after initial access. For example, the downlink signals/channels (e.g., SSB, CSS, PDSCH, etc.) and uplink signals/channels (RACH, PUSCH, PUCCH, etc.) for non-RedCap UEs may be configured/scheduled in a relatively packed way to reduce latency as much as possible, while for RedCap UEs, the uplink and downlink signals/channels may be configured/scheduled separately and/or in a relatively relaxed way to accommodate for RedCap limitations and reduced processing capabilities.

In example of FIG. 22 and/or in Scenario-1 shown in FIG. 20 and/or Scenario-2 shown in FIG. 21, if the legacy semi-static TDD configuration is used for RedCap UEs and if they apply the same TDD-UL-DL pattern as non-RedCap UEs, then the RedCap UEs may undergo excessive power consumption due to frequent UL/DL switching which involves RF retuning. For example, based on the existing technology, e.g., in Scenario-1, in response to the TDD configuration/pattern indicating a ‘D’ symbol, the RedCap UE may camp on the center frequency of the initial DL BWP during a duration of the ‘D’ symbol. For example, based on the existing technology, e.g., in Scenario-1, in response to the TDD configuration/pattern indicating a ‘U’ symbol, the UE may switch to the center frequency of the initial UL BWP, e.g., camp on the center frequency of the initial UL BWP during a duration of the ‘U’ symbol. There may not be any uplink transmissions scheduled/configured for the RedCap UE during the duration of the ‘U’ symbol. In an example, the network may determine/configure the semi-static TDD configuration/pattern conservatively such that the RedCap timing constraints are considered (e.g., they may be guaranteed) and/or e.g., by reducing the UL/DL switching points. However, this may reduce the network scheduling flexibility, and also may enforce limitations and inefficiencies for non-RedCap UEs operation. For example, the timing of uplink transmissions for non-RedCap may not be aligned with RedCap, and it may result in a latency for non-RedCap uplink transmissions. This may be seriously undesired for an efficient coexistence with the legacy non-RedCap UEs, and we may strive to avoid any disturbance.

In a TDD cell supporting RedCap and non-RedCap UEs, there may be a need to reduce a rate of UL/DL switching and RF retuning as well as to enable a relaxed scheduling of transmissions and receptions for RedCap UEs compared to non-RedCap UEs, while avoiding an increased latency and inefficiency in scheduling UL transmissions and DL receptions of non-RedCap UEs of the cell. Additionally, it may be desired to incorporate a switching/retuning gap for the RedCap UEs between UL and DL which may not be compatible with non-RedCap semi-static UL/DL pattern.

In the existing TDD technology, a single common semi-static TDD UL-DL pattern (e.g., TDD-UL-DL-ConfigurationCommon) is configured, e.g., for all the UEs, in the cell. Each UE applies the common semi-static TDD UL-DL pattern to its active UL/DL BWP. For example, a UE may map the TDD pattern to its active BWP based on a converting a reference numerology of the TDD pattern and the numerology of the active BWP. However, the same common TDD configuration may not be compatible with requirements/constraints of both RedCap and non-RedCap UEs in the same cell.

The RedCap UE operating based on frequency RF retuning, e.g., as in Sceanrio-1 and/or Scenario-2, may be similar to a Half-Duplex FDD operation in a paired spectrum, wherein UL frequency and DL frequency are different, and/or the UE is not capable of simultaneous transmissions and receptions. In the existing technology, for FDD operation including Half-Duplex FDD operation, no semi-static UL-DL pattern (similar to TDD-UL-DL-Configuration) is defined/configured. Although the behavior of RedCap UE with limited bandwidth capability in a TDD system (as in Sceanrio-1 and/or Scenario-2) may be similar to Half-Duplex FDD UEs, however, the determination of slot format of Half-Duplex FDD UEs may not be applicable to RedCap UEs because the cell is TDD and may be configured with a semi-static TDD pattern, e.g., for non-RedCap UEs. So, there is a gap in the technology to define the behavior of RedCap UEs operating in a TDD system, e.g., based on Scenario-1 and/or Scenario-2, such that RedCap UEs timing constraints are met and impacts such as delay to non-RedCap UEs are avoided.

Embodiments of the present disclosure may provide one or more mechanisms for enhanced configuration of semi-static TDD pattern and/or uplink and downlink slot formats for a TDD cell with RedCap and non-RedCap devices. Embodiments may enable configuration of additional and/or separate semi-static TDD pattern for RedCap UEs, e.g., independent of non-RedCap UEs. Embodiment of the present disclosure may prevent frequent RF retuning (e.g., frequent UL-DL frequency switching) and may reduce power consumption for RedCap devices, while avoiding restrictions for UL and DL operation of non-RedCap devices. Embodiments may enable efficient coexistence of RedCap UEs and non-RedCap UEs in a TDD cell. Embodiments may increase a signaling overhead for the network, however, the overhead may be paid off by the ease of systematic and independent semi-static TDD configuration and resource management for the network supporting RedCap and non-RedCap UEs.

Based on an embodiment, the network may configure a separate/second semi-static common TDD UL-DL pattern (e.g., TDD-UL-DL-ConfigurationCommon-RedCap) for RedCap UEs.

Based on an embodiment, the RedCap UEs may determine the slot format of an active UL BWP (e.g., initial UL BWP and/or non-initial UL BWP) and/or active DL BWP (e.g., initial DL BWP and/or non-initial DL BWP) based on the RedCap-specific semi-static common TDD UL-DL pattern. For example, the RedCap UEs may ignore/discard the legacy semi-static common TDD UL-DL pattern (e.g., TDD-UL-DL-ConfigurationCommon) configured for non-RedCap UEs.

Based on an embodiment, the RedCap UEs may determine the slot format of the initial UL BWP and/or initial DL BWP (e.g., when activated) based on the RedCap-specific semi-static common TDD UL-DL pattern. Based on an embodiment, the RedCap UE may determine the slot format of the initial UL BWP and/or initial DL BWP (e.g., when activated) based on the RedCap-specific semi-static common TDD UL-DL pattern during initial access (e.g., when in RRC_IDLE and/or RRC_INACTIVE state). Based on an embodiment, the RedCap UE may determine the slot format of the initial UL BWP and/or initial DL BWP (e.g., when activated) based on the legacy semi-static common TDD UL-DL pattern after initial access (e.g., when in RRC_CONNECTED state). Based on an embodiment, the RedCap UE may determine the slot format of the initial UL BWP and/or initial DL BWP (e.g., when activated) based on the legacy semi-static common TDD UL-DL pattern during initial access (e.g., when in RRC_IDLE and/or RRC_INACTIVE state). Based on an embodiment, the RedCap UE may determine the slot format of the initial UL BWP and/or initial DL BWP (e.g., when activated) based on the RedCap-specific semi-static common TDD UL-DL pattern after initial access (e.g., when in RRC_CONNECTED state). For example, the RedCap UE may be configured with both legacy and RedCap-specific semi-static common TDD pattern (e.g., TDD-UL-DL-ConfigurationCommon and e.g., TDD-UL-DL-ConfigurationCommon-RedCap).

Based on an embodiment, the RedCap UE may determine the slot format of a non-initial UL BWP and/or a non-initial DL BWP (e.g., when activated) based on the legacy or non-RedCap semi-static common TDD pattern (e.g., TDD-UL-DL-ConfigurationCommon). Embodiments may define one or more conditions/criteria for the RedCap UEs to select one of the legacy semi-static common TDD pattern or the RedCap-specific semi-static common TDD pattern, and to determine the slot format based on the selected TDD pattern. The conditions/criteria may be based on the RedCap UE RRC state; and/or configuration of the active DL and/or UL BWP(s); and/or the center frequency of the active UL/DL BWP(s); and/or whether the active DL BWP comprises a reference signal (e.g., SSB) and/or CORESET (e.g., CORESET #0) and/or CSS set (e.g., paging and/or RACH CSS set); etc.

Based on an embodiment, the network may configure an additional/intermediate semi-static common TDD UL-DL pattern (e.g., TDD-UL-DL-ConfigurationCommon-RedCap) for RedCap UEs. In this embodiment, the RedCap UE may be configured with both legacy and additional semi-static common TDD patterns (e.g., TDD-UL-DL-ConfigurationCommon and TDD-UL-DL-ConfigurationCommon-RedCap). The RedCap UE may determine the slot format of an active UL/DL BWP based on both TDD UL/DL patterns. For example, the RedCap UE may determine the slot format by applying the RedCap-Specific/additional semi-static common TDD pattern on top of the legacy semi-static common TDD pattern. For example, the RedCap-Specific/additional semi-static common TDD pattern may override the legacy semi-static common TDD pattern. For example, the RedCap-Specific/additional semi-static common TDD pattern may indicate a ‘D’ or ‘U’ or ‘F’ symbol for a symbol indicated as ‘F’ by the legacy semi-static common TDD pattern.

In all embodiments the RedCap UE may be additionally configured with a third semi-static TDD pattern that is dedicated to the UE (e.g., TDD-UL-DL-ConfigurationDedicated). The RedCap UE may apply the third (dedicated) semi-static TDD pattern on top of the first (legacy) and/or second (RedCap-specific) semi-static common TDD pattern(s). the RedCap UE may determine the slot formats based on the first and/or second and/or third TDD pattern(s). The third/dedicated TDD pattern may override the ‘F’ symbols indicated by the first and/or second TDD patterns as ‘U’ or ‘D’ or ‘F’ symbols.

According to the present disclosure, the RedCap UE may receive, from a cell, a message (e.g., broadcast message, multicast message, and/or RedCap UE specific RRC message) comprising the additional semi-static common TDD patterns (e.g., TDD-UL-DL-ConfigurationCommon-RedCap) The message may comprise a MIB. The message may comprise a SIB. The message may comprise a SIB1. The message may comprise an RMSI. The message may comprise a semi-static TDD configuration (e.g., TDD-UL-DL-ConfigurationCommon) indicating a semi-static TDD pattern for non-RedCap UE. The message may not comprise/indicate a semi-static TDD pattern for other type of UE (e.g., sidelink UE). For example, a second message may comprise/indicate the semi-static TDD pattern for other type of UE (e.g., sidelink UE). For example, the second message may comprise a system information block other than SIB1. For example, the second message may comprise an on-demand SI. The cell may send (e.g., broadcast, multicast, and/or unicast) the second message comprising the semi-static TDD pattern for other type of UE (e.g., sidelink UE) to reduce a size of the message.

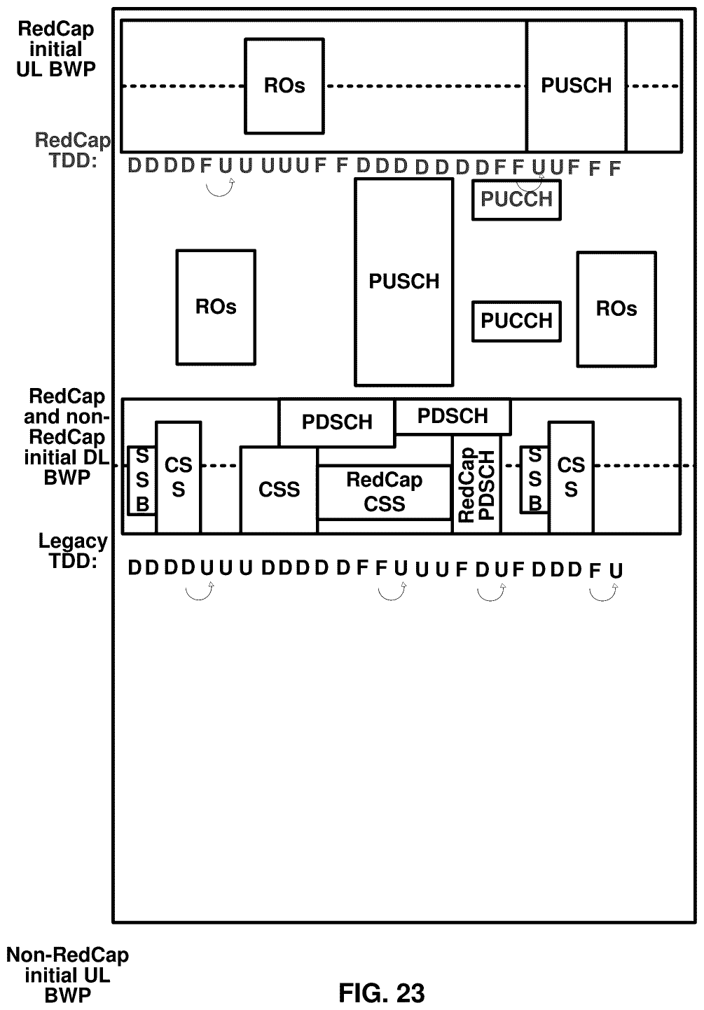

FIG. 23 shows an example of RedCap and non-RedCap operation in a TDD cell, based on Scenario-1, where initial UL BWP and initial DL BWP have different center frequencies. As shown in FIG. 23, the legacy TDD pattern may result in four UL-DL switching points for non-RedCap UEs. Embodiments may enable reducing the number of UL-DL switching points to two for RedCap UEs, as shown in the example of FIG. 23. Embodiments may enable the network to accommodate the RF retuning gaps by configuring ‘F’ symbols in between UL-DL switching points.

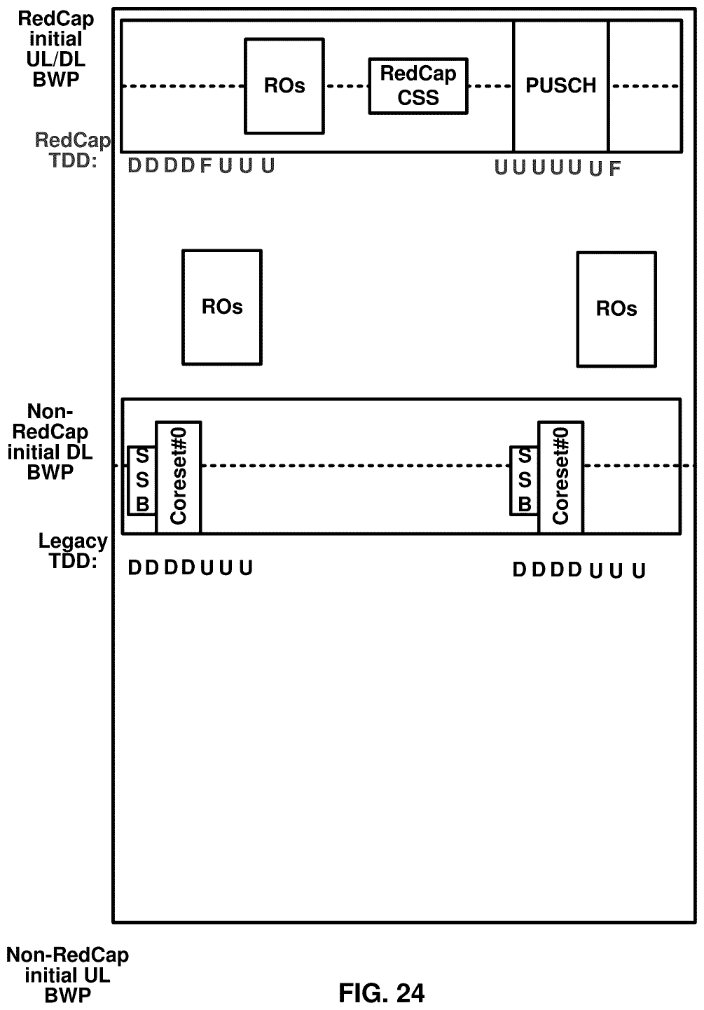

FIG. 24 shows an example of RedCap and non-RedCap operation in a TDD cell, based on Scenario-2, where initial UL BWP and initial DL BWP have same center frequencies, but the initial DL BWP does not comprise SSB and/or CORESET #0. As shown in FIG. 24, the embodiments may enable overriding/modifying symbols allocated to SSB/CORESET #0 such that the RedCap UE may not need to frequently perform RF retuning for monitoring the SSB/CORESET #0. As a result, the RedCap UE may be able to receive an uplink signal/channel (e.g., DG PUSCH and/or CG-PUSCH and/or Msg3 PUSCH) overlapped with SSB/CORESET #0.

A wireless device may receive one or more SSBs of a cell. The wireless device may receive one or more messages, e.g., from a base station, via the cell. The one or more messages may comprise a system information, e.g., broadcast message and/or SIB and/or SIB1. The one or more messages may comprise a dedicated RRC message. The wireless device may be a RedCap device. The system information may be specific to RedCap devices in the coverage area of the cell. The system information may be for all devices in the coverage area of the cell. The cell may be a TDD cell/system. The cell may be configured in an unpaired spectrum. The cell may be an FDD cell. The call may be configured in a paired spectrum.

The wireless device may receive configuration parameters of the cell. For example, the one or more messages may comprise the configuration parameters of the cell. The configuration parameters may comprise a cell-specific TDD UL/DL configuration (e.g., TDD-UL-DL-ConfigurationCommon). The cell-specific TDD UL/DL configuration may indicate a reference SCS and/or one or more TDD UL/DL patterns. A TDD UL/DL pattern may comprise/indicate a periodicity of the TDD UL/DL pattern, and/or a first number of consecutive DL slots and/or symbols (e.g., at the beginning of each TDD UL/DL pattern, and/or a second number of consecutive UL slots and/or symbols (e.g., at the end of each TDD UL/DL pattern). The TDD UL/DL pattern may indicate that one or more slots and/or symbols in between the DL slots/symbols and UL slots/symbols are flexible symbols.

The TDD UL/DL pattern may indicate a first slot format for symbols of one or more slots of the cell. A slot format may comprise a downlink symbol ‘D’, uplink symbol ‘U’, or flexible symbol ‘F’. A UE may determine the slot format of a symbol at least partially based on the TDD UL/DL pattern.

The UE may be operating in/via a first active BWP of the cell. The configuration parameters may configure/indicate one or more BWPs for the UE to operate in the cell. For example, the first BWP (the first UL BWP and/or the first DL BWP) may be activated. A first UL BWP and a first DL BWP may be paired (e.g., have a same BWP index), e.g., in a TDD cell (or unpaired spectrum operation). The first BWP (UL BWP and/or DL BWP) may be configured with a first SCS. The UE may determine a slot format of one or more slots/symbols of the first BWP (which may be the active BWP of the cell) based on the TDD UL/DL pattern. For example, the UE may determine the slot format based on the SCS of the first BWP and the reference SCS of the TDD UL/DL pattern indicated by the TDD UL/DL configuration. For example, the UE may map each reference symbol (based on the reference SCS) to one or more symbols in the active/first BWP (based on the SCS of the first BWP).

The UE may monitor downlink control channels and/or receive downlink signals/channels during the DL slots/symbols. The UE may transmit uplink signals/channels during the UL slots/symbols. The UE may determine a DL or UL format for a symbol indicated as Flexible based on at least one of the followings: a second TDD UL/DL pattern (e.g., a UE-specific semi-static TDD UL/DL pattern indicated by the SIB/SIB1 and/or RRC message); a slot format indication (SFI) indicated by a DCI format that the UE may receive; and/or one or more UL grant or DL assignments that the UE may receive that are configured/scheduled during the symbol.

Based on some of the embodiments, the UE (e.g., a RedCap UE) may receive a second TDD UL/DL configuration. For example, the UE may receive a system information (e.g., SIB/SIB1 and/or a separate/second SIB for RedCap UEs) and/or an RRC message comprising second configuration parameters of the cell. The second configuration parameters may comprise/indicate a second TDD UL/UL configuration (e.g., a second semi-static TDD UL/DL configuration). The second TDD UL/DL configuration may be cell-specific. The second TDD UL/DL configuration may be intended for/applied by RedCap UEs. For example, legacy/non-RedCap UEs may not receive and/or decode the second TDD UL/DL configuration. For example, a non-RedCap UE may ignore/discard the second TDD UL/DL configuration.

In an embodiment, the network/base station (BS) may determine a first TDD UL/DL configuration/pattern for first UEs of the cell (e.g., non-RedCap UEs), and a second TDD UL/DL configuration/pattern for second UEs of the cell (e.g., RedCap UEs). The cell may support the first UEs and the second UEs. For example, the BS may transmit the first TDD UL/DL configuration via a first message (e.g., SIB/SIB1/RRC message) and the second TDD UL/DL configuration via a second message (e.g., SIB/SIB1/a second SIB1/RRC message). For example, the BS may transmit the first TDD UL/DL configuration and the second TDD UL/DL configuration via a same message (broadcast and/or multicast and/or unicast).

For example, the network/BS may determine separate TDD UL/DL configuration/pattern for first UEs and second UEs of the cell based on one or more criteria. The one or more criteria may comprise the cell supporting second UEs (e.g., RedCap UEs). The one or more criteria may comprise the cell being configured in a paired spectrum. The one or more criteria may comprise the cell being configured in an unpaired spectrum. The one or more criteria may comprise the cell being a TDD cell. The one or more criteria may comprise configuring a separate/additional initial DL BWP and/or separate initial UL BWP, e.g., for the second/RedCap UEs. The one or more criteria may comprise the initial DL BWP (e.g., of the RedCap UEs) and the initial UL BWP (e.g., of the RedCap UEs) having a same center frequency. The one or more criteria may comprise the initial DL BWP (e.g., of the RedCap UEs) and the initial UL BWP (e.g., of the RedCap UEs) having different center frequencies.

In an example, the BS may transmit the first (e.g., legacy) TDD UL/DL configuration via the broadcast message (e.g., SIB/SIB1). The first TDD UL/DL configuration may be used by one or more UEs during initial access and/or after initial access (e.g., in RRC_CONNECTED state). In an example, the BS may transmit the second (e.g., RedCap-specific) TDD UL/DL configuration via the broadcast message (e.g., SIB/SIB1). The second TDD UL/DL configuration may be used by one or more second UEs during initial access and/or after initial access (e.g., in RRC_CONNECTED state). In an example, the BS may transmit the second (e.g., RedCap-specific) TDD UL/DL configuration via the multi-cast/unicast message (e.g., RRC message). The second TDD UL/DL configuration may be used by the one or more second UEs after initial access (e.g., in RRC_CONNECTED state).

In an embodiment, a UE (e.g., a RedCap UE) may receive a message comprising the second TDD UL/DL configuration. The message may be a broadcast message (e.g., SIB or SIB1 or a second SIB1 or a SIBx, x=2, 3, . . . ). The message may be a multi-cast message (e.g., a second SIB1 or SIBx only sent to a group of UEs, e.g., RedCap UEs). The message may be a unicast message (e.g., a dedicated RRC message).

The message may comprise configuration parameters of the cell. The configuration parameters may indicate one or more BWPs of the cell for the UE operation. The UE may receive configuration parameters of the one or more BWPs via a second message (e.g., SIB or SIB1 or SIBx or RRC message). The one or more BWPs may comprise an initial BWP of the cell. The one or more BWPs may comprise a non-initial BWP of the cell. The UE may receive at least one message indicating one or more initial BWPs of the cell. The UE may receive configuration parameters of an initial BWP (e.g., initial DL BWP and/or initial UL BWP). The initial BWP may be specific to a group of UEs, e.g., RedCap UEs. The UE may be configured with the initial BWP in response to being a RedCap UE. The initial BWP may be different than a second initial BWP configured for a second group of UEs, e.g., non-RedCap UEs.

In an example, the UE may use/communicate via the (first, e.g., RedCap-specific) initial BWP during the initial access. In an example, the UE may use/communicate via the second (e.g., cell-specific) initial BWP after the initial access (e.g., in RRC_CONNECTED state). In an example, the UE may use/communicate via the second (e.g., cell-specific) initial BWP during the initial access. In an example, the UE may use/communicate via the (first, e.g., RedCap-specific) initial BWP after the initial access (e.g., in RRC_CONNECTED state).

In an embodiment, the UE may receive a message comprising configuration parameters of the cell. The configuration parameters may indicate/comprise a second/separate TDD UL/DL configuration. For example, the second/separate TDD UL/DL configuration may be for a group of UEs, e.g., RedCap UEs.

In an embodiment, the UE may determine a TDD UL/DL pattern based on a first TDD UL/DL configuration (e.g., cell-specific/common TDD UL/DL configuration, e.g., TDD-UL-DL-ConfigurationCommon). In an example, the UE may determine the TDD UL/DL pattern based on a first TDD UL/DL configuration for the initial UL BWP and/or initial DL BWP (e.g., when the initial UL/DL BWP is active). In an example, the UE may determine the TDD UL/DL pattern based on the first TDD UL/DL configuration for the non-initial UL BWP(s) and/or non-initial DL BWP(s) (e.g., when the non-initial UL/DL BWP is active). For example, the UE may determine the TDD UL/DL pattern based on the first TDD UL/DL configuration based on one or more criteria.

The one or more criteria may comprise the cell supporting second type of UEs (e.g., RedCap UEs). The one or more criteria may comprise the cell being configured in a paired spectrum. The one or more criteria may comprise the cell being configured in an unpaired spectrum. The one or more criteria may comprise the cell being a TDD cell. The one or more criteria may comprise a separate/additional initial DL BWP and/or separate/additional initial UL BWP being configured in the cell, e.g., for the second/RedCap UEs. The one or more criteria may comprise the initial DL BWP (e.g., of the RedCap UEs) and the initial UL BWP (e.g., of the RedCap UEs) having a same center frequency. The one or more criteria may comprise the initial DL BWP (e.g., of the RedCap UEs) and the initial UL BWP (e.g., of the RedCap UEs) having different center frequencies. The one or more criteria may comprise being in an RRC_IDLE and/or RRC_INACTIVE state. The one or more criteria may comprise being in an RRC_CONNECTED.

In an embodiment, the UE may determine a TDD UL/DL pattern based on a second TDD UL/DL configuration (e.g., RedCap-specific/RedCap-Common TDD UL/DL configuration, e.g., TDD-UL-DL-ConfigurationCommon-RedCap). In an example, the UE may determine the TDD UL/DL pattern based on the second TDD UL/DL configuration for the initial UL BWP and/or initial DL BWP (e.g., when the initial UL/DL BWP is active). In an example, the UE may determine the TDD UL/DL pattern based on the second TDD UL/DL configuration for the non-initial UL BWP(s) and/or non-initial DL BWP(s) (e.g., when the non-initial UL/DL BWP is active). For example, the UE may determine the TDD UL/DL pattern based on the second TDD UL/DL configuration based on one or more criteria.

The one or more criteria may comprise the cell supporting second type of UEs (e.g., RedCap UEs). The one or more criteria may comprise the cell being configured in a paired spectrum. The one or more criteria may comprise the cell being configured in an unpaired spectrum. The one or more criteria may comprise the cell being a TDD cell. The one or more criteria may comprise a separate/additional initial DL BWP and/or separate/additional initial UL BWP being configured in the cell, e.g., for the second/RedCap UEs. The one or more criteria may comprise the initial DL BWP (e.g., of the RedCap UEs) and the initial UL BWP (e.g., of the RedCap UEs) having a same center frequency. The one or more criteria may comprise the initial DL BWP (e.g., of the RedCap UEs) and the initial UL BWP (e.g., of the RedCap UEs) having different center frequencies. The one or more criteria may comprise being in an RRC_IDLE and/or RRC_INACTIVE state. The one or more criteria may comprise being in an RRC_CONNECTED. The one or more criteria may comprise a bandwidth of the active BWP being wider than a RedCap bandwidth capability. The one or more criteria may comprise a bandwidth of the active BWP not being wider than a RedCap bandwidth capability.

The UE may determine a slot format/communication direction (e.g., D or U or F) of a symbol based on a TDD UL/DL pattern. The symbol may be associated with a BWP of the cell. The BWP may be an active DL BWP of the cell. The BWP may be an active UL BWP of the cell. The UE may monitor and/or receive a downlink signal/channel via the active BWP DL during the symbol, e.g., in response to the slot format indicating a ‘D’ or ‘F’ format/direction for the symbol. The UE may transmit an uplink signal/channel via the active UL BWP during the symbol, e.g., in response to the slot format indicating a ‘U’ or ‘F’ format/direction for the symbol. The UE may or may not transmit/receive via the active UL/DL BWP during the symbol, e.g., in response to the slot format indicating a ‘F’ format/direction for the symbol.

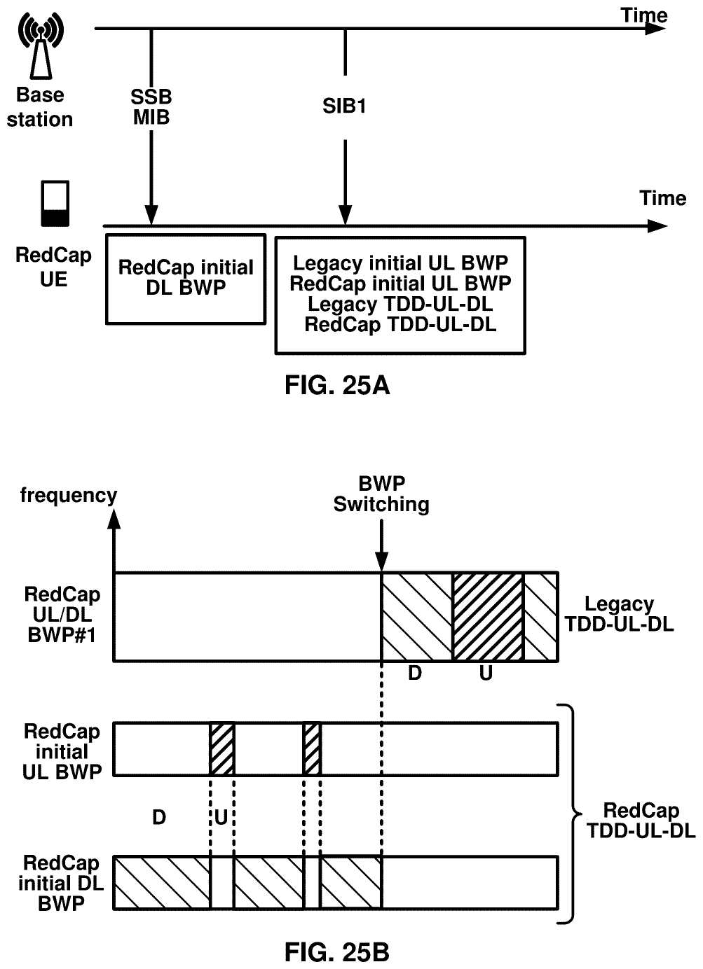

FIG. 25A and FIG. 25B show an example of TDD UL/DL configuration, according to some embodiments. As shown in FIG. 25A, the UE may receive an SSB and/or MIB from the base station. The UE may determine a location and bandwidth of an initial DL BWP based on the MIB (e.g., based on bandwidth and location of CORESET #0). The UE may receive a system information block (e.g., SIB1) and/or an RRC message.

The SIB/RRC message may configure one or more initial UL BWP. For example, the SIB/RRC message may indicate a first bandwidth and location for a first initial UL BWP (e.g., for legacy/non-RedCap UEs). For example, the SIB/RRC message may indicate a second bandwidth and location for a second initial UL BWP (e.g., for RedCap UEs). The second initial UL BWP may be different from the first initial UL BWP. The bandwidth of the second initial UL BWP may not be wider than the RedCap bandwidth capability. The UE may determine a location and bandwidth of the initial UL BWP based on the second initial UL BWP, at least in response to being a RedCap UE. For example, the UE may determine the location and bandwidth of the initial UL BWP based on the second initial UL BWP, after the initial access (in RRC_CONNECTED state). For example, the UE may determine the location and bandwidth of the initial UL BWP based on the second initial UL BWP, during the initial access (in RRC_IDLE and/or RRC_INACTIVE state).

In an example, the SIB/RRC message may indicate a second initial DL BWP (e.g., for RedCap UEs). The second initial DL BWP may be different from the first initial DL BWP (e.g., the MIB-configured initial DL BWP). The bandwidth of the second initial DL BWP may not be wider than the RedCap bandwidth capability. The UE may determine a location and bandwidth of the initial DL BWP of the cell based on the second initial DL BWP, at least in response to being a RedCap UE. For example, the UE may determine the location and bandwidth of the initial DL BWP based on the second initial DL BWP, after the initial access (in RRC_CONNECTED state). For example, the UE may determine the location and bandwidth of the initial DL BWP based on the second initial DL BWP, during the initial access (in RRC_IDLE and/or RRC_INACTIVE state).

As shown in FIG. 25A, the SIB (e.g., SIB1), or in an example an RRC message, may comprise configuration parameters indicating two or more TDD UL/DL configurations. For example, the SIB/RRC message may comprise a first TDD UL/DL configuration indicating a first TDD UL/DL pattern. The first TDD UL/DL pattern may be for legacy/non-RedCap UEs in the cell. For example, the SIB/RRC message may comprise a second TDD UL/DL configuration indicating a second TDD UL/DL pattern. The second TDD UL/DL pattern may be for RedCap UEs in the cell.

FIG. 25B shows an example based on Scenario-1 where the center frequency of initial UL BWP and initial DL BWP is different. In this example, the UE may determine slot format of symbols in the initial UL BWP and initial DL BWP (e.g., when initial UL and DL BWPs are active), based on the second TDD UL/DL pattern (e.g., the RedCap-specific TDD UL/DL pattern). For example, the second TDD UL/DL pattern may be designed/configured such that a number/rate of UL/DL switching points between the UL frequency and the DL frequency is reduced compared to the first TDD UL/DL pattern. As a result, RF retuning and power consumption of the RedCap UE may be reduced. For example, the second TDD UL/DL pattern may be designed/configured such that at least one ‘F’ symbol is configured between consecutive ‘U’ and ‘D’ symbols, e.g., to accommodate a gap for RF retuning.

Based on an embodiment, the UE may use/select the second (e.g., RedCap-specific) TDD UL/DL configuration/pattern when operating in the initial UL/DL BWP (e.g., when the initial UL/DL BWP is active). Based on an embodiment, the UE may use/select the second (e.g., RedCap-specific) TDD UL/DL configuration/pattern when operating in the initial UL/DL BWP and/or when the center frequency of initial UL BWP and initial DL BWP are different. Based on an embodiment, the UE may use/select the second (e.g., RedCap-specific) TDD UL/DL configuration/pattern when operating in the initial UL/DL BWP and/or during initial access. Based on an embodiment, the UE may use/select the second (e.g., RedCap-specific) TDD UL/DL configuration/pattern when operating in the initial UL/DL BWP and/or after initial access.

Based on an embodiment, the UE may use/select a first (e.g., legacy/non-RedCap-specific) TDD UL/DL configuration/pattern when operating in a non-initial UL/DL BWP (e.g., UL/DL BWP #1, when the non-initial UL/DL BWP is active). Based on an embodiment, the UE may use/select the first (e.g., legacy/non-RedCap-specific) TDD UL/DL configuration/pattern when operating in the non-initial UL/DL BWP and/or when the center frequency of non-initial UL BWP and the non-initial DL BWP are the same. Based on an embodiment, the UE may use/select the first (e.g., legacy/non-RedCap-specific) TDD UL/DL configuration/pattern when operating in the non-initial UL/DL BWP and/or when the center frequency of non-initial UL BWP and the non-initial DL BWP are different.

As shown in example of FIG. 25B, the UE may switch from the initial BWPs to a (pair of) non-initial BWP(s). For example, the initial UL BWP and initial DL BWP may not have same center frequency in a deployment scenario. The center frequency of pairs of non-initial UL BWP and DL BWPs may be the same in a deployment scenario. For example, UL BWP #1 and DL BWP #1 (a pair of non-initial BWPs) may have the same center frequency. In an embodiment, the UE may determine slot format of symbols in a non-initial UL and/or DL BWP (e.g., when the non-initial UL and DL BWPs are active) based on the first TDD UL/DL pattern. For example, due to the same center frequency of UL and DL, additional constraints in UL and DL switching may not be considered for RedCap UEs (no RF retuning may be needed).

In an embodiment, the UE may use/select the first (e.g., legacy/non-RedCap-specific) TDD UL/DL configuration/pattern when operating in the initial UL/DL BWP (e.g., when the initial UL/DL BWP is active). Based on an embodiment, the UE may use/select the first (e.g., legacy/non-RedCap-specific) UL/DL configuration/pattern when operating in the initial UL/DL BWP and/or when the center frequency of initial UL BWP and initial DL BWP are different. Based on an embodiment, the UE may use/select the first (e.g., legacy/non-RedCap-specific) TDD UL/DL configuration/pattern when operating in the initial UL/DL BWP and/or when the center frequency of initial UL BWP and initial DL BWP are the same. Based on an embodiment, the UE may use/select the first (e.g., legacy/non-RedCap-specific) TDD UL/DL configuration/pattern when operating in the initial UL/DL BWP and/or during initial access. Based on an embodiment, the UE may use/select the first (e.g., legacy/non-RedCap-specific) TDD UL/DL configuration/pattern when operating in the initial UL/DL BWP and/or after initial access.

Based on an embodiment, the UE may use/select the second (e.g., RedCap-specific) TDD UL/DL configuration/pattern when operating in a non-initial UL/DL BWP (e.g., when the non-initial UL/DL BWP is active). Based on an embodiment, the UE may use/select the second (e.g., RedCap-specific) TDD UL/DL configuration/pattern when operating in the non-initial UL/DL BWP and/or when the center frequency of non-initial UL BWP and the non-initial DL BWP are the same. Based on an embodiment, the UE may use/select the second (e.g., RedCap-specific) TDD UL/DL configuration/pattern when operating in the non-initial UL/DL BWP and/or when the center frequency of non-initial UL BWP and the non-initial DL BWP are different.

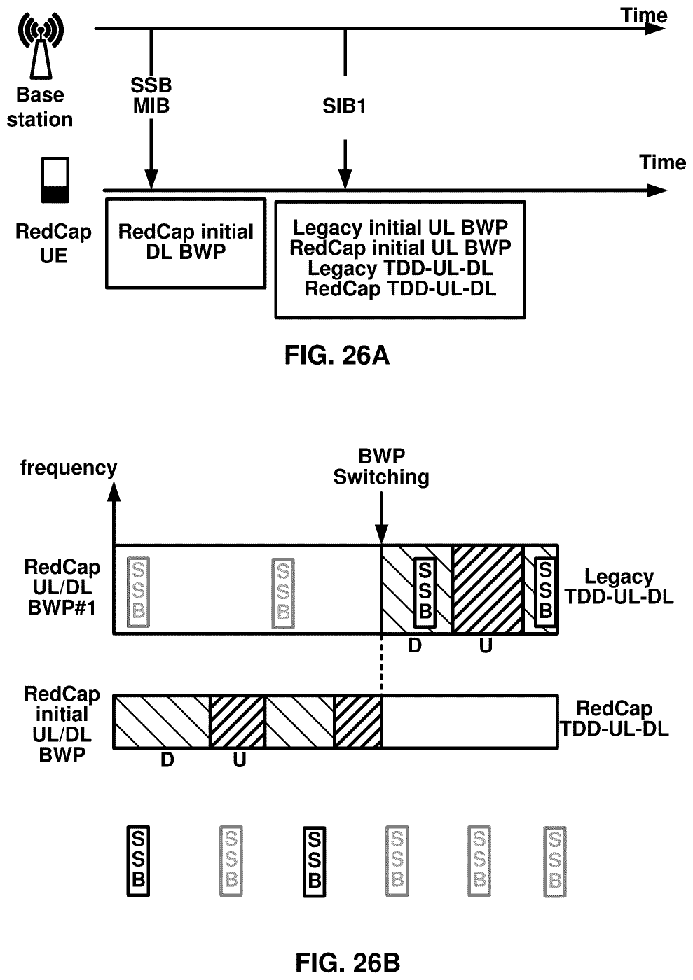

FIG. 26A and FIG. 26B show an example of TDD UL/DL configuration, according to some embodiments. As shown in FIG. 26A, the UE may receive an SSB and/or MIB from the base station. The UE may determine a location and bandwidth of an initial DL BWP based on the MIB (e.g., based on bandwidth and location of CORESET #0). The UE may receive a system information block (e.g., SIB1) and/or an RRC message configuring an initial UL BWP for the UE. The SIB/RRC message may configure an initial DL BWP for the RedCap UE (e.g., different than the MIB-configured initial DL BWP). For example, the bandwidth of the initial UL BWP and/or the initial DL BWP may not be wider than a bandwidth capability of the RedCap UEs.

FIG. 26B shows an example BWP configuration based on Scenario-2. For example, as shown in FIG. 26B, the initial UL BWP and the initial DL may have the same center frequency. For example, the initial DL BWP (e.g., the RedCap-specific initial DL BWP) may not comprise a reference signal (e.g., SSB). For example, no SSB may be transmitted via the radio resources of the initial DL BWP. For example, transmitting additional SSB via the separate (RedCap-specific initial DL BWP) may increase an overhead of the system and waste common radio resources of the cell. In this example, the UE may determine slot format of symbols in the initial UL BWP and initial DL BWP (e.g., when initial UL and DL BWPs are active), based on the second TDD UL/DL pattern (e.g., the RedCap-specific TDD UL/DL pattern). For example, the second TDD UL/DL pattern may be designed/configured such that a number/rate of RF retuning for receiving/measuring SSBs and/or monitoring CORESET #0 for RedCap is reduced, e.g., when SSB and/or CORESET #0 are not within a bandwidth of the active DL BWP (e.g., the initial DL BWP when activated). For example, the second TDD UL/DL pattern may override/indicate a ‘U’ or ‘F’ slot format for symbol(s) allocated to an SSB.

As shown in FIG. 26A, the SIB (e.g., SIB1), or in an example an RRC message, may comprise configuration parameters indicating two or more TDD UL/DL configurations. For example, the SIB/RRC message may comprise a first TDD UL/DL configuration indicating a first TDD UL/DL pattern. The first TDD UL/DL pattern may be for legacy/non-RedCap UEs in the cell. For example, the SIB/RRC message may comprise a second TDD UL/DL configuration indicating a second TDD UL/DL pattern. The second TDD UL/DL pattern may be for RedCap UEs in the cell.

Based on an embodiment, the UE may use/select the second (e.g., RedCap-specific) TDD UL/DL configuration/pattern when operating in the initial UL/DL BWP (e.g., when the initial UL/DL BWP is active). Based on an embodiment, the UE may use/select the second (e.g., RedCap-specific) TDD UL/DL configuration/pattern when operating in the initial UL/DL BWP and/or when the center frequency of initial UL BWP and initial DL BWP are the same. Based on an embodiment, the UE may use/select the second (e.g., RedCap-specific) TDD UL/DL configuration/pattern when operating in the initial UL/DL BWP and/or during initial access. Based on an embodiment, the UE may use/select the second (e.g., RedCap-specific) TDD UL/DL configuration/pattern when operating in the initial UL/DL BWP and/or after initial access.

Based on an embodiment, the UE may use/select the first (e.g., legacy/non-RedCap-specific) TDD UL/DL configuration/pattern when operating in a non-initial UL/DL BWP (e.g., UL/DL BWP #1, when the non-initial UL/DL BWP is active). Based on an embodiment, the UE may use/select the first (e.g., legacy/non-RedCap-specific) TDD UL/DL configuration/pattern when operating in the non-initial UL/DL BWP and/or when the center frequency of non-initial UL BWP and the non-initial DL BWP are the same. Based on an embodiment, the UE may use/select the first (e.g., legacy/non-RedCap-specific) TDD UL/DL configuration/pattern when operating in the non-initial UL/DL BWP and/or when the center frequency of non-initial UL BWP and the non-initial DL BWP are different.

As shown in example of FIG. 26B, the UE may switch from the initial BWPs to a (pair of) non-initial BWP(s). For example, the initial DL BWP may not comprise a reference signal configuration/SSB. The non-initial DL BWPs may comprise a reference signal configuration/SSB. In an embodiment, the UE may determine slot format of symbols in a non-initial UL and/or DL BWP (e.g., when the non-initial UL and DL BWPs are active) based on the first TDD UL/DL pattern. For example, additional constraints in UL and DL switching may not be considered for RedCap UEs (no RF retuning may be needed).

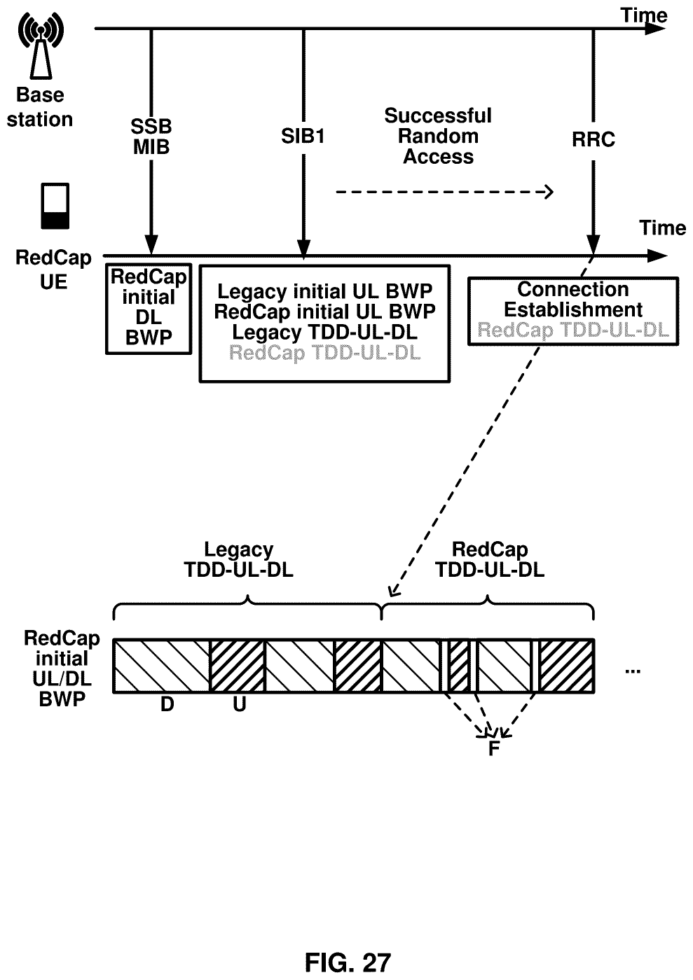

FIG. 27 shows an example of TDD UL/DL configuration based on Scenario-2, where initial UL BWP and initial DL BWP have same center frequencies, according to some embodiments. Based on an embodiment shown in FIG. 27, the UE may use/select a first (e.g., legacy/non-RedCap-specific) TDD UL/DL configuration/pattern when operating in the initial UL/DL BWP (e.g., when the initial UL/DL BWP is active) and/or during initial access (e.g., before RRC connection is set up/resumed/established, e.g., in RRC_IDLE and/or RRC_INACTIVE state). Based on an embodiment, the UE may use/select a second (e.g., RedCap-specific) TDD UL/DL configuration/pattern when operating in the initial UL/DL BWP and/or after initial access (e.g., when RRC connection is set up/resumed/established, e.g., in RRC_CONNECED state). For example, the second (e.g., RedCap-specific) TDD UL/DL pattern may configure ‘F’ symbols between UL and DL symbols to accommodate RF switching gaps for RedCap UEs, e.g., to measure SSBs/monitor CORESET #0 outside the active BWP.

For example, the BS may reconfigure the RedCap with RedCap-specific TDD UL/DL pattern (e.g., TDD-UL-DL-ConfigCommon-RedCap) for connected state (e.g., via dedicated RRC message). For example, the UE may be configured to use a separate initial DL/UL BWP after initial access. The UE may determine the slot format based on the second/RedCap-specific TDD UL/DL pattern after initial access.

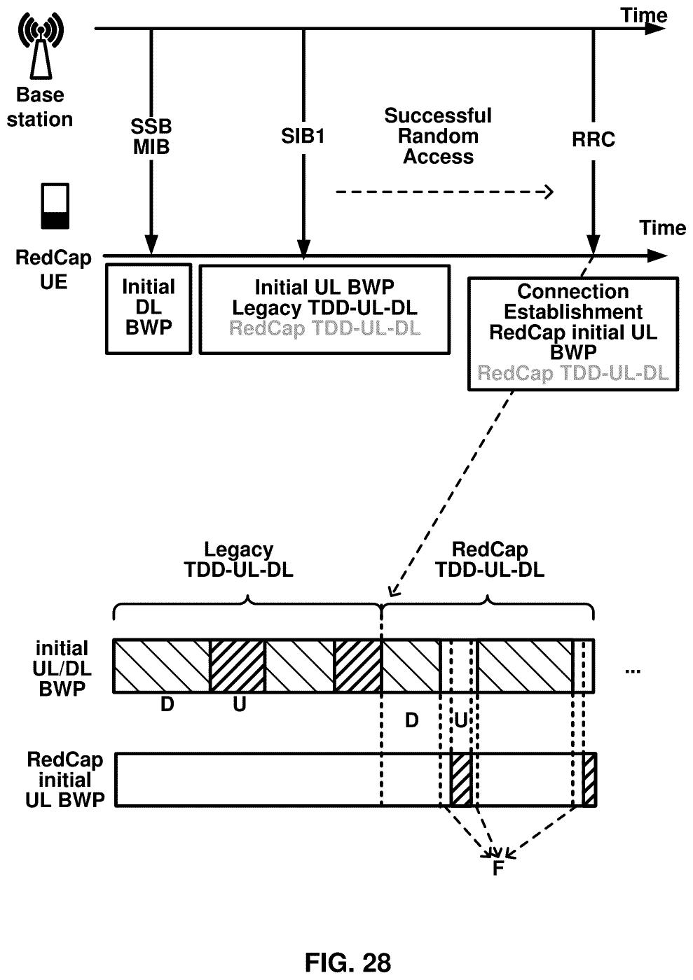

FIG. 28 shows an example of TDD UL/DL configuration based on Scenario-1, where initial UL BWP and initial DL BWP have different center frequencies. Based on an embodiment shown in FIG. 28, the UE may use/select a first (e.g., legacy/non-RedCap-specific) TDD UL/DL configuration/pattern when operating in the initial UL/DL BWP (e.g., when the initial UL/DL BWP is active) and/or during initial access (e.g., before RRC connection is set up/resumed/established, e.g., in RRC_IDLE and/or RRC_INACTIVE state). Based on an embodiment, the UE may use/select a second (e.g., RedCap-specific) TDD UL/DL configuration/pattern when operating in the initial UL/DL BWP and/or after initial access (e.g., when RRC connection is set up/resumed/established, e.g., in RRC_CONNECED state). For example, during initial access, the UE may use/operate in the cell-specific initial UL/DL BWP. For example, the UE may be configured with a separate initial UL BWP after initial access. For example, the UE may be configured with a separate initial DL BWP after initial access. For example, the second (e.g., RedCap-specific) TDD UL/DL pattern may configure ‘F’ symbols between UL and DL symbols to accommodate RF switching gaps for RedCap UEs.

Based on an embodiment, the UE may not expect to receive a TDD UL/DL configuration indicating a TDD UL/DL pattern, where UL symbols ‘U’ are followed by DL symbols ‘D’. Based on an embodiment, the UE may not expect to receive a TDD UL/DL configuration indicating a TDD UL/DL pattern, where DL symbols ‘D’ are followed by UL symbols U. For example, the UE (e.g., a RedCap UE) may expect at least one flexible symbol ‘F’ between any ‘D’ and ‘U’ symbols. For example, the UE (e.g., a RedCap UE) may expect at least one flexible symbol ‘F’ between any ‘U’ and ‘D’ symbols.

In an embodiment, the UE (e.g., RedCap UE) may determine slot format of symbols of one or more BWPs based on the second (e.g., RedCap-specific) TDD UL/DL pattern. For example, the UE may determine that a first BWP is active. The first BWP may be an initial UL/DL BWP. The first BWP may be a non-initial UL/DL BWP. The UE may determine the slot format of a symbol when operating on the first BWP based on the second TDD UL/DL pattern. For example, the UE may determine the slot format of a symbol when operating on the first BWP and/or when in RRC-CONNECTED state, based on the second TDD UL/DL pattern. For example, the UE may use the first (e.g., the legacy/non-RedCap-specific) TDD UL/DL pattern during initial access. For example, the UE may discard the first TDD UL/DL pattern/configuration after (a successful) initial access. In an embodiment, the UE may not use the first TDD UL/DL pattern/configuration. For example, the UE may ignore/discard the first TDD UL/DL configuration/configuration parameters, if received. For example, the UE (e.g., RedCap UE) may determine slot formats of symbols in any active BWP based on the second (e.g., RedCap-specific) TDD UL/DL pattern, e.g., during and/or after initial access.

In an embodiment, the BS may transmit a first TDD UL/DL configuration and a second TDD UL/DL configuration to one or more UEs in a cell. For example, the first TDD UL/DL configuration may be cell-specific (e.g., TDD-UL-DL-ConfigurationCommon). For example, the second TDD UL/DL configuration may be group/RedCap-specific (e.g., TDD-UL-DL-ConfigurationCommon-RedCap). The BS may communicate with a first UE (e.g., legacy/non-RedCap UE) based on the first TDD UL/DL pattern. The BS may communicate with a second UE (e.g., RedCap UE) based on the second TDD UL/DL pattern.

In an example, a first periodicity (P) of a first TDD UL/DL pattern, indicated by the first TDD UL/DL configuration, may be the same as a second periodicity (P_RedCap) of a second TDD UL/DL pattern, indicated by the second TDD UL/DL configuration. In an example, a first periodicity (P) of a first TDD UL/DL pattern, indicated by the first TDD UL/DL configuration, may be a multiplier/an integer number of a second periodicity (P_RedCap) of a second TDD UL/DL pattern, indicated by the second TDD UL/DL configuration. In an example, a second periodicity (P_RedCap) of a second TDD UL/DL pattern, indicated by the second TDD UL/DL configuration, may be a multiplier/an integer number of a first periodicity (P_RedCap) of a first TDD UL/DL pattern, indicated by the first TDD UL/DL configuration (e.g., P_RedCapan integer number*P).

In an example, a first reference SCS of a first TDD UL/DL pattern, indicated by the first TDD UL/DL configuration, may be the same as a second reference SCS of a second TDD UL/DL pattern, indicated by the second TDD UL/DL configuration.

In an example, the first UE and the second UE may apply the first TDD UL/DL pattern and the second TDD UL/DL pattern, respectively, to 2^{(μ-μ}^{_{ref}}⁾ consecutive slots in the active DL BWP or the active UL BWP. For example, the first slot starts at a same time as a first slot for the reference SCS configuration μ_{ref} and each downlink or flexible or uplink symbol for the reference SCS configuration μ_{ref} corresponds to 2^{(μ-μ}^{_{ref}}⁾ consecutive downlink or flexible or uplink symbols for the SCS configuration μ of the active UL/DL BWP. As a result, there may be a high level consistency/alignment in common resources of the cell associated with time blocks of the TDD patterns.

In an example, the first TDD UL/DL pattern and the second TDD UL/DL pattern may be the same. For example, a periodicity and/or a reference SCS of the first TDD UL/DL pattern/configuration and the second TDD UL/DL pattern/configuration may be different. For example, the first UE and the second UE may map same TDD UL/DL pattern based on different numerology and/or periodicity. In an example, reference SCS for RedCap may be defined based on SCS of separate RedCap BWP.

In an example, the network may transmit a third TDD UL/DL configuration indicating a third TDD UL/DL pattern. The third TDD UL/DL pattern may be UE-specific. The third TDD UL/DL pattern may override the flexible symbols indicated by the first TDD UL/DL pattern and/or the second TDD UL/DL pattern.

In an embodiment, the UE may determine a TDD UL/DL pattern based on a first TDD UL/DL configuration (e.g., non-RedCap-specific/Common TDD UL/DL configuration, e.g., TDD-UL-DL-ConfigurationCommon) and a second TDD UL/DL configuration (e.g., RedCap-specific/RedCap-Common TDD UL/DL configuration, e.g., TDD-UL-DL-ConfigurationCommon-RedCap).

For example, the UE (e.g., RedCap UE) may receive one or more messages comprising SIB1 and/or RRC message. The one or more messages may comprise the first TDD UL/DL configuration and the second TDD UL/DL configuration. For example, SIB1 may comprise the first TDD UL/DL configuration. For example, the UE may receive a dedicated RRC message that comprises the second TDD UL/DL configuration.

The first TDD UL/DL configuration may indicate a first TDD UL/DL pattern. The second TDD UL/DL configuration may indicate a second TDD UL/DL pattern. For example, the first TDD UL/DL pattern may be cell-specific (e.g., legacy common configuration for all UEs in the cell including RedCap UEs). For example, the second TDD UL/DL pattern may be for a group of UEs in the cell (e.g., RedCap UEs).

Based on an embodiment, a UE (e.g., a RedCap UE) may determine a slot format of a symbol based on the first TDD UL/DL pattern and the second TDD UL/DL pattern. For example, the UE may apply the first TDD UL/DL pattern on the slots/symbols, and additionally apply the second TDD UL/DL pattern on the slots/symbols to determine the slot format/direction of the slots/symbols. For example, the second TDD UL/DL pattern may override the first TDD UL/DL pattern. The network/BS may use the second TDD UL/DL pattern to modify/configure/change slot format of one or more slots/symbols for RedCap UEs, e.g., such that the slot format is compatible with the scheduling constraints of RedCap UEs.

For example, a first symbol may be indicated as ‘F’ by the first TDD UL/DL pattern. Based on an embodiment, the second TDD UL/DL pattern may indicate the symbol as ‘U’ or ‘D’ or ‘F’ symbol. For example, a first symbol may be indicated as ‘D’ by the first TDD UL/DL pattern. Based on an embodiment, the second TDD UL/DL pattern may indicate the symbol as ‘U’ or ‘D’ or ‘F’ symbol. For example, a first symbol may be indicated as ‘U’ by the first TDD UL/DL pattern. Based on an embodiment, the second TDD UL/DL pattern may indicate the symbol as ‘U’ or ‘D’ or ‘F’ symbol.

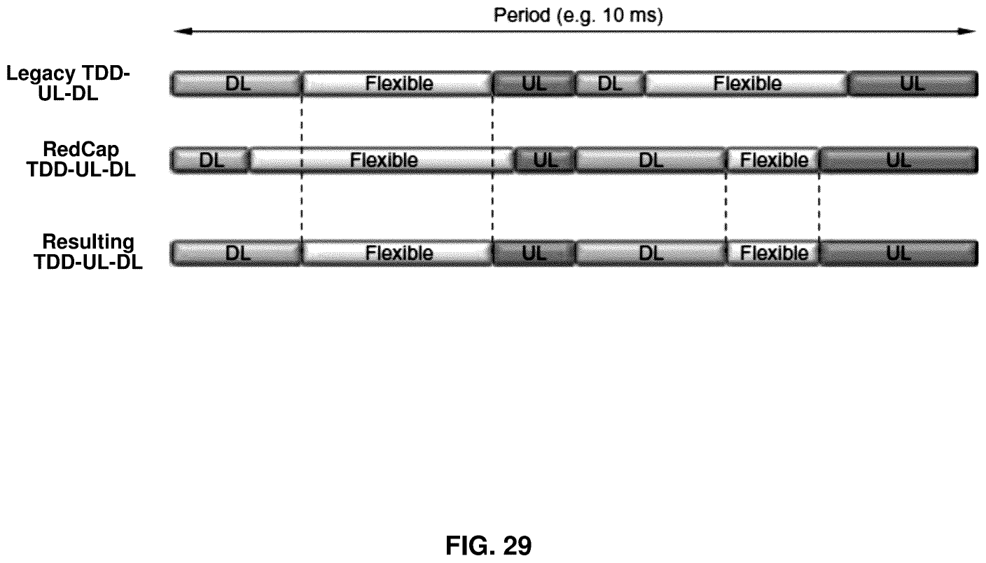

FIG. 29 shows an example of slot format determination for a UE configured with two semi-static TDD UL/DL patterns: a first cell-specific pattern and a second group-specific (e.g., RedCap-specific) pattern, according to some embodiments. As shown in FIG. 29, the RedCap TDD UL/DL pattern may override some symbols (e.g., flexible symbols) of the legacy TDD UL/DL pattern as downlink symbols or uplink symbols.

In an example, the UE may not expect that a symbol indicated as ‘U’ by the first TDD UL/DL pattern to be indicated as ‘D’ or ‘F’ by the second TDD UL/DL pattern. In an example, the UE may not expect that a symbol indicated as ‘D’ by the first TDD UL/DL pattern to be indicated as ‘U’ or ‘F’ by the second TDD UL/DL pattern.

In an example, the UE may determine a symbol is ‘D’ if the first TDD UL/DL pattern and/or the second TDD UL/DL pattern indicate it as ‘D’. In an example, the UE may determine a symbol is ‘U’ if the first TDD UL/DL pattern and/or the second TDD UL/DL pattern indicate it as U. In an example, the UE may determine a symbol is ‘D’ only if the first TDD UL/DL pattern and the second TDD UL/DL pattern indicate it as ‘D’. In an example, the UE may determine a symbol is ‘U’ only if the first TDD UL/DL pattern and the second TDD UL/DL pattern indicate it as ‘U’.

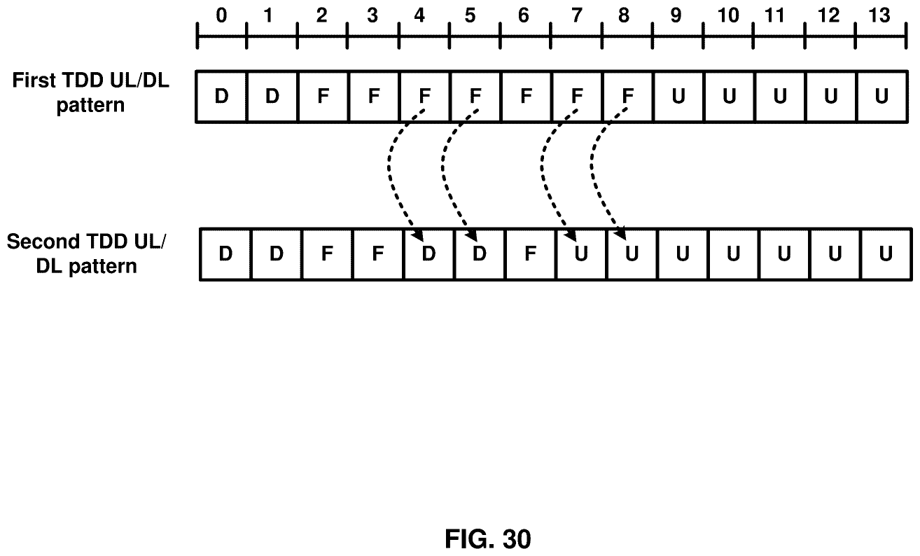

FIG. 30 shows an example of the second TDD UL/DL pattern overriding the first TDD UL/DL pattern, according to some embodiments. In some embodiments, a UE (e.g., a RedCap UE) may determine a slot format of a symbol based on the first TDD UL/DL pattern and the second TDD UL/DL pattern. For example, the UE may apply the second TDD UL/DL pattern on the slots/symbols, and additionally apply the first TDD UL/DL pattern on the slots/symbols to determine the slot format/direction of the slots/symbols. For example, the first TDD UL/DL pattern may override the second TDD UL/DL pattern.

In an example, the UE may determine the slot format of a symbol based on the first TDD UL/DL pattern and the second TDD UL/DL pattern when the active BWP is an initial UL/DL BWP of the cell. For example, the UE may determine the slot format only based on the first TDD UL/DL pattern when the active BWP is a non-initial BWP. For example, the UE may determine the slot format only based on the second TDD UL/DL pattern when the active BWP is a non-initial BWP. For example, the UE may determine the slot format only based on the first TDD UL/DL pattern or second TDD UL/DL pattern during the initial access. For example, the UE may determine the slot format only based on the first TDD UL/DL pattern or second TDD UL/DL pattern after the initial access. For example, the UE may determine the slot format based on the first TDD UL/DL pattern and/or second TDD UL/DL pattern during and/or after the initial access. For example, the UE may determine the slot format based on the first TDD UL/DL pattern and/or second TDD UL/DL pattern when the active BWP is an initial UL/DL BWP of the cell. For example, the UE may determine the slot format based on the first TDD UL/DL pattern and/or second TDD UL/DL pattern when the active BWP is a non-initial UL/DL BWP of the cell. For example, the UE may determine the slot format based on the first TDD UL/DL pattern and/or second TDD UL/DL pattern when the active BWP is an initial UL/DL BWP of the cell. For example, the UE may determine the slot format based on the first TDD UL/DL pattern and/or second TDD UL/DL pattern when a center frequency of the active UL BWP and the active DL BWP are different. For example, the UE may determine the slot format based on the first TDD UL/DL pattern and/or second TDD UL/DL pattern when a center frequency of the active UL BWP and the active DL BWP are the same.

In an embodiment, the UE (e.g., the RedCap UE) may determine the slot format of one or more symbols/slots to be flexible ‘F’. For example, the UE may discard/ignore the first (e.g., legacy/cell-specific) TDD UL/DL configuration. For example, the UE may not receive a second (e.g., RedCap-specific) TDD UL/DL configuration. For example, the UE may not receive the first TDD UL/DL configuration.

In an embodiment, the UE (e.g., the RedCap UE) may determine the slot format of one or more symbols/slots to be downlink ‘D’. In an embodiment, the UE (e.g., the RedCap UE) may determine the slot format of one or more symbols/slots to be uplink ‘U’. As a result, the UE may camp on UL or DL frequency and only switch between UL and DL frequency when necessary (e.g., based on received UL grants and/or DL assignments). Thus, RF retuning and power consumption may be reduced.

For example, the UE may determine the slot format of one or more symbols/slots to be flexible ‘F’ under one or more criteria. The one or more criteria may comprise the cell supporting second type of UEs (e.g., RedCap UEs). The one or more criteria may comprise the cell being configured in a paired spectrum. The one or more criteria may comprise the cell being configured in an unpaired spectrum. The one or more criteria may comprise the cell being a TDD cell. The one or more criteria may comprise a separate/additional initial DL BWP and/or separate/additional initial UL BWP being configured in the cell, e.g., for the second/RedCap UEs. The one or more criteria may comprise the initial DL BWP (e.g., of the RedCap UEs) and the initial UL BWP (e.g., of the RedCap UEs) having a same center frequency. The one or more criteria may comprise the initial DL BWP (e.g., of the RedCap UEs) and the initial UL BWP (e.g., of the RedCap UEs) having different center frequencies. The one or more criteria may comprise being in an RRC_IDLE and/or RRC_INACTIVE state. The one or more criteria may comprise being in an RRC_CONNECTED. The one or more criteria may comprise a bandwidth of the active BWP being wider than a RedCap bandwidth capability. The one or more criteria may comprise a bandwidth of the active BWP not being wider than a RedCap bandwidth capability.

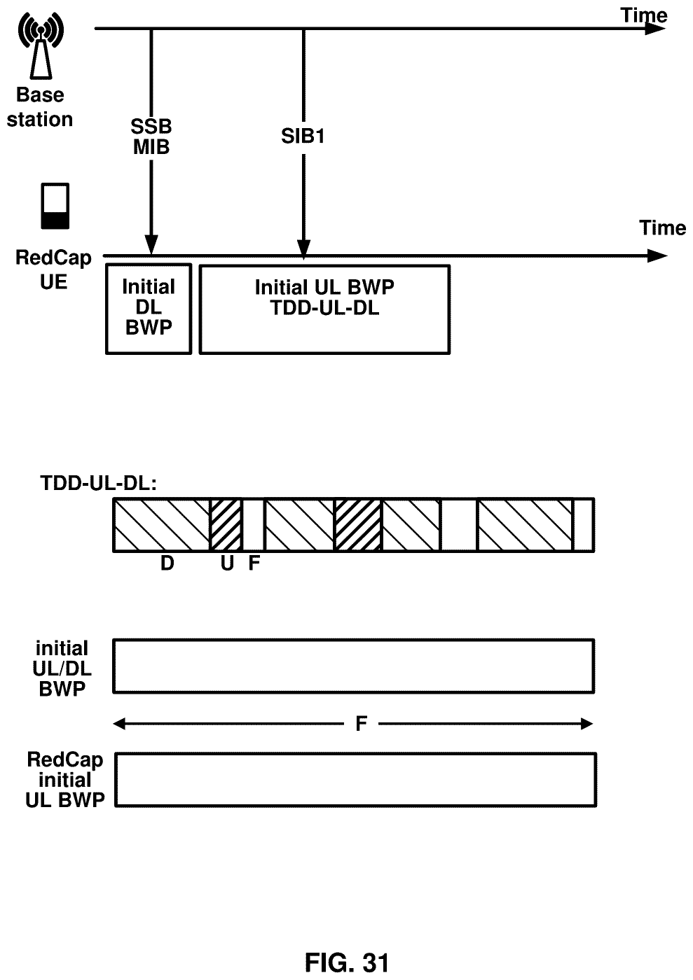

FIG. 31 shows an example of TDD UL/DL configuration, where the UE may consider/assume/determine slot format of one or more slots/symbols to be flexible F. As shown in FIG. 31, if a TDD UL/DL configuration is received, the UE may ignore/discard it.

In one or more of the embodiments, the UE (e.g., RedCap UE) may be additionally configured with a third semi-static TDD pattern that is dedicated to the UE (e.g., TDD-UL-DL-ConfigurationDedicated). The RedCap UE may apply the third (dedicated) semi-static TDD pattern on top of the first (legacy) and/or second (RedCap-specific) semi-static common TDD pattern(s), if configured. the RedCap UE may determine the slot formats based on the first and/or second and/or third TDD pattern(s). The third/dedicated TDD pattern may override the ‘F’ symbols indicated by the first and/or second TDD patterns as ‘U’ or ‘D’ or ‘F’ symbols.

Throughout the disclosure, “TDD pattern” or “TDD UL/DL pattern/configuration” in the English may correspond to parameter/information element TDD-UL-DL-ConfigCommon.

Throughout the disclosure, “communication/communicating” may refer to uplink transmission of a signal or channel (e.g., PRACH, PUSCH, or PUCCH) via radio resource of an active UL BWP, or monitoring a downlink control channel or signal or receiving downlink signals or channel (e.g., PBCH, PDSCH, or PDCCH) via radio resources of an active DL BWP.

In some embodiments, a wireless device may receive one or more messages comprising configuration parameters of a cell. The configuration parameters may indicate: a first bandwidth part (BWP) of the cell for wireless devices having reduced capabilities (e.g., RedCap UEs); and/or a first time-division duplex (TDD) pattern for the first BWP; and/or a second TDD pattern applicable to BWPs of the cell (e.g., by all or non-RedCap UEs). The wireless device may select, based on the wireless device having the reduced capabilities and based on the first BWP being an active BWP of the cell, the first TDD pattern from the first TDD pattern and the second TDD pattern. The wireless device may determine, based on the first TDD pattern, a format of a symbol being one of a downlink symbol, uplink symbol, or flexible symbol. The wireless device may communicate via the first BWP and during the symbol, based on the format.

A direction of the communication may be based on the format. The direction may comprise an uplink from the wireless device to a base station; and/or a downlink from the base station to the wireless device.

Communicating may comprise transmitting, based on the format being an uplink symbol or a flexible symbol, an uplink signal via the first BWP and during the symbol; and/or receiving, based on the format being a downlink symbol or a flexible symbol, a downlink signal via the first BWP and during the symbol.

The first BWP may comprise an initial downlink BWP of the cell. The first BWP may comprise an initial uplink BWP of the cell. A first center frequency of the initial downlink BWP may or may not be the same as a second center frequency of the initial uplink BWP for the wireless devices having the reduced capabilities. A bandwidth of the initial downlink BWP may not comprise a reference signal. A reference signal may be a synchronization signal block (SSB).

The wireless device may switch from the first BWP to a second BWP, of the BWPs, as the active BWP of the cell. The wireless device may select, based on the second BWP being an active BWP of the cell and based on the second BWP not being associated with the wireless devices having the reduced capabilities, the second TDD pattern from the first TDD pattern and the second TDD pattern. the wireless device may determine, for the second BWP, a second format of a second symbol based on the second TDD pattern. The first BWP may be an initial BWP and the second BWP may be a non-initial BWP of the cell. The second BWP may be a second downlink BWP with a third center frequency that is same as a fourth center frequency of a second uplink BWP. The first BWP may be a non-initial BWP and the second BWP is an initial BWP of the cell.

In some embodiments, the one or more messages may comprise a master information block indicating the first BWP, and the first BWP may be an initial downlink BWP of the cell. The wireless device may be in a radio resource control (RRC) inactive state or RRC idle state. The one or more messages may comprise a system information block indicating at least the first BWP, and the first BWP may be an initial BWP of the cell. The one or more messages may comprise a radio resource control (RRC) message indicating at least the first TDD pattern.

In some embodiments, the first TDD pattern may be for the wireless devices having the reduced capabilities. A TDD pattern may indicate a format for symbols in one or more slots. A slot format may comprise downlink symbol, uplink symbol, or flexible symbol. The first TDD pattern may indicate, as an uplink/downlink configuration of a frame structure in a TDD operation, a format of each symbol during a time period applicable to a BWP dedicated to the wireless devices, wherein the format may comprise one of an uplink symbol, downlink symbol, and flexible symbol.

In some embodiments, the second TDD pattern may indicate, as an uplink/downlink configuration of a frame structure of TDD operation, a format of each symbol during a time period applicable to a BWP. The BWP may be dedicated to a wireless device not having the reduced capabilities, or may be shared between the wireless device not having the reduced capabilities and the wireless devices having the reduced capabilities. The format may comprise one of an uplink symbol, downlink symbol, and flexible symbol.

In some embodiments, the one or more messages may comprise a system information block (SIB). The one or more messages may comprise a SIB 1 comprising scheduling information of other system information blocks, and/or radio resource configuration information that is common for all wireless devices in the cell, and/or barring information applied to a unified access control.

In some embodiments, the cell may be configured in a frequency band of an unpaired spectrum assigned for a TDD operation. The cell may be configured in a paired spectrum where the wireless device switches paired downlink BWP and uplink BWP together.

In some embodiments, a wireless device may receive one or more messages comprising configuration parameters of a cell, the configuration parameters indicating: an initial bandwidth part (BWP) for wireless devices having reduced capabilities and a first BWP of the cell; and/or a first time-division duplex (TDD) pattern for the initial BWP; and/or a second TDD pattern applicable to BWPs of the cell. The wireless device may determine, based on the initial BWP being an active BWP of the cell and the wireless device having the reduced capabilities, a first format of a first symbol based on the first TDD pattern. The wireless device may switch from the initial BWP to the first BWP as the active BWP of the cell. The wireless device may determine, for the second BWP, a second format of a second symbol based on the second TDD pattern.

In some embodiments, a wireless device may receive one or more messages comprising configuration parameters of a cell, indicating: a first time-division duplex (TDD) pattern for the cell; and/or a second TDD pattern, overriding the first TDD pattern, for wireless devices having a reduced capability in the cell. The wireless device may determine, based on the first TDD pattern, a first format of a symbol as flexible. The wireless device may determine, based on the second TDD pattern and based on the wireless device having the reduced capability, a second format of the symbol as downlink. The wireless device may monitor a downlink channel of the cell during the symbol. In some embodiments, the one or more messages may further indicate a third TDD pattern for the wireless device.

In some embodiments, a wireless device may receive a system information of a cell operating in an unpaired spectrum, wherein the system information indicates: a first time-division duplex (TDD) pattern for one or more wireless devices; and/or a second TDD pattern for a wireless device having a reduced capability among the one or more wireless devices. Based on the wireless device having the reduced capability, the wireless device may determine a format of a symbol, indicated as flexible by the first TDD pattern, as an uplink sym bol or a downlink symbol using the second TDD pattern. The wireless device may communicate during the symbol, based on the determined format.

What is claimed is:

1. A wireless device comprising:
one or more processors; and
memory storing instructions that, when executed by the one or more processors cause the wireless device to perform:
receiving configuration parameters indicating:
a first time-division duplex (TDD) pattern for a first bandwidth part (BWP) of a cell; and
a second TDD pattern applicable to BWPs of the cell;
selecting, based on the first BWP being an active BWP of the cell, the first TDD pattern from the first TDD pattern and the second TDD pattern; and
communicating via the first BWP, based on the first TDD pattern.

2. The wireless device of claim 1, wherein the second TDD pattern is applicable to a plurality of BWPs of the cell, comprising a second BWP.

3. The wireless device of claim 1, wherein the first BWP is for wireless devices having reduced capabilities.

4. The method of claim 1, wherein the selecting the first TDD pattern is further based on the wireless device having the reduced capabilities.

5. The wireless device of claim 1, wherein the communicating comprises transmitting, based on the format being an uplink symbol or a flexible symbol, an uplink signal via the first BWP and during the symbol.

6. The wireless device of claim 1, wherein the communicating comprises receiving, based on the format being a downlink symbol or a flexible symbol, a downlink signal via the first BWP and during the symbol.

7. The wireless device of claim 1, wherein the first BWP comprises an initial downlink BWP of the cell.

8. The wireless device of claim 1, wherein the first BWP comprises an initial uplink BWP of the cell.

9. The wireless device of claim 1, further comprising:
switching from the first BWP to a second BWP, of the BWPs, as the active BWP of the cell; and
selecting, based on the second BWP being an active BWP of the cell and based on the second BWP not being associated with the wireless devices having the reduced capabilities, the second TDD pattern from the first TDD pattern and the second TDD pattern; determining, for the second BWP, a second format of a second symbol based on the second TDD pattern.

10. The wireless device of claim 1, wherein the one or more messages comprise a master information block indicating the first BWP, and the first BWP is an initial downlink BWP of the cell.

11. A base station comprising:
one or more processors; and
memory storing instructions that, when executed by the one or more processors cause the wireless device to perform:
transmitting, to a wireless device, configuration parameters indicating:
a first time-division duplex (TDD) pattern for a first bandwidth part (BWP) of a cell; and
a second TDD pattern applicable to BWPs of the cell,
wherein the wireless device is configured to select, based on the first BWP being an active BWP of the cell, the first TDD pattern from the first TDD pattern and the second TDD pattern and to communicate with the base station via the first BWP, based on the first TDD pattern.

12. The base station of claim 11, wherein the second TDD pattern is applicable to a plurality of BWPs of the cell, comprising a second BWP.

13. The base station of claim 11, wherein the first BWP is for wireless devices having reduced capabilities.

14. The base station of claim 11, wherein the selecting the first TDD pattern is further based on the wireless device having the reduced capabilities.

15. The base station of claim 11, further comprising: receiving, based on the format being an uplink symbol or a flexible symbol, an uplink signal via the first BWP and during the symbol.

16. The base station of claim 11, further comprising: transmitting, based on the format being a downlink symbol or a flexible symbol, a downlink signal via the first BWP and during the symbol.

17. The base station of claim 11, wherein the first BWP comprises an initial downlink BWP of the cell.

18. The base station of claim 11, wherein the first BWP comprises an initial uplink BWP of the cell.

19. The base station of claim 11, wherein the one or more messages comprise a master information block indicating the first BWP, and the first BWP is an initial downlink BWP of the cell.

20. A non-transitory computer-readable medium comprising instructions that, when executed by one or more processors, cause the one or more processors to perform:
receiving configuration parameters indicating:
a first time-division duplex (TDD) pattern for a first bandwidth part (BWP) of a cell; and
a second TDD pattern applicable to BWPs of the cell;
selecting, based on the first BWP being an active BWP of the cell, the first TDD pattern from the first TDD pattern and the second TDD pattern; and
communicating via the first BWP, based on the first TDD pattern.
